SEQUENCE LISTING (141 sequences)

SEQ ID NO: 1 - protein, 355 aa, Homo sapiens
METPNTTEDYDTTTEFDYGDATPCQKVNERAFGAQLLPPLYSLVFVIGLVGNILVVLVLVQYKRLKNMTSIYLLNLAISDLLFLFTLPFWIDYKLKDDWVFGDAMCKILSGFYYTGLYSEIFFIILLTIDRYLAIVHAVFALRARTVTFGVITSIIIWALAILASMPGLYFSKTQWEFTHHTCSLHFPHESLREWKLFQALKLNLFGLVLPLLVMIICYTGIIKILLRRPNEKKSKAVRLIFVIMIIFFLFWTPYNLTILISVFQDFLFTHECEQSRHLDLAVQVTEVIAYTHCCVNPVIYAFVGERFRKYLRQLFHRRVAVHLVKWLPFLSVDRLERVSSTSPSTGEHELSAGF

SEQ ID NO: 2 - protein, 352 aa, Felis catus
MDYQATSPYYDIEYELSEPCQKTDVRQIAARLLPPLYSLVFLSGFVGNLLVILILINCKKLRGMTDVYLLNLAISDLLFLFTLPFWAHYAANGWVFGDGMCKTVTGLYHVGYFGGNFFIILLTVDRYLAIVHAVFAVKARTVTFGAVTSAVTWAAAVVASLPGCIFSRSQKEGSRFTCSPHFPSNQYHFWKNFQTLKMTILGLVLPLLVMIVCYSAILRTLFRCRNEKKKHRAVKLIFVIMIGYFLFWAPNNIVLLLSTFPESFGLNNCSSSNRLDQAMQVTETLGMTHCCINPIIYAFVGEKFRSYLLVFFQKHIARRFCKRCPVFQGKALDRASSVYTRSTGEQEISTGL

SEQ ID NO: 3 - protein, 374 aa, Homo sapiens
MLSTSRSRFIRNTNESGEEVTTFFDYDYGAPCHKFDVKQIGAQLLPPLYSLVFIFGFVGNMLVVLILINCKKLKCLTDIYLLNLAISDLLFLITLPLWAHSAANEWVFGNAMCKLFTGLYHIGYFGGIFFIILLTIDRYLAIVHAVFALKARTVTFGVVTSVITWLVAVFASVPGIIFTKCQKEDSVYVCGPYFPRGWNNFHTIMRNILGLVLPLLIMVICYSGILKTLLRCRNEKKRHRAVRVIFTIMIVYFLFWTPYNIVILLNTFQEFFGLSNCESTSQLDQATQVTETLGMTHCCINPIIYAFVGEKFRSLFHIALGCRIAPLQKPVCGGPGVRPGKNVKVTTQGLLDGRGKGKSIGRAPEASLQDKEGA

SEQ ID NO: 4 - protein, 288 aa, Gallus gallus
MTDIYLLNLAISDLLFIFSLPFWAYYAAHDWIFGDALCRILSGVYLLGFYSGIFFIILLTVDRYLAIVHAVFALKARTVTYGILTSIVTWAVALFASVPGIVFHKTQQEHTRYTCSAHYPQEQRDEWKQFLALKMNILGLVIPMIIMICSYTQIIKTLLQCRNEKKNKAVRLIFIIMIVYFFFWAPYNICILLRDFQDSFSITSCEISGQLQKATQVTETISMIHCCINPVIYAFAGEKFRKYLRSFFRKQIASHFSKYCPVFYADTVERASSTYTQSTGEQEVSAAL

SEQ ID NO: 5 - protein, 354 aa, Equus caballus
MDYQTTSPFYDIDYSTSEPCQKTDVRQIAARLLPPLYSLVFICGSLGNMLVILVLIKYVKLKRVADIYLLNLAISDLLFVLTLPLWAHYAAHSWVFGNRMCQLSIGLYFIGFFSGIFFIILLTIDRYLAIVHRVIPLKVSTVAFGVVSSGVTWLVAVFASLPGIIFTKSQKEDFLESEKESVYSCGPYFPPQWRNFHIIMITILSLVLPLLVMIICYSAILKTLLQCLPRKKHKAVRLIFVIMIVYFLFWAPYNIVLLLSTFQEIFGLSDFETSSRLDQDMQVTETLGMTHCCINPIIYAFVGEKFRRYLSMFFRKHIAKHLCKPRCPVFCGKTVERVSSRNTPSAGEQELSIA

SEQ ID NO: 6 - protein, 383 aa, Equid herpesvirus 2
MATTSATSTVNTSSLATTMTTNFTSLLTSVVTTIASLVPSTNSSEDYYDDLDDVDYEESAPCYKSDTTRLAAQVVPALYLLVFLFGLLGNILVVIIVIRYMKIKNLTNMLLLNLAISDLLFLLTLPFWMHYIGMYHDWTFGISLCKLLRGVCYMSLYSQVFCIILLTVDRYLAVVYAVTALRFRTVTCGIVTCVCTWFLAGLLSLPEFFFHGHQDDNGRVQCDPYYPEMSTNVWRRAHVAKVIMLSLILPLLIMAVCYYVIIRRLLRRPSKKKYKAIRLIFVIMVAYFVFWTPYNIVLLLSTFHATLLNLQCALSSNLDMALLITKTVAYTHCCINPVIYAFVGEKFRRHLYHFFHTYVAIYLCKYIPFLSGDGEGKEGPTRI

SEQ ID NO: 7 - protein, 372 aa, Equus caballus
MGDNGTFSQVSHNMLSTSHSLFTTNIQGSDEPTTIYDYDYSAPCQKSSVRQVAAGLLPPLYSLVFIFGFVGNMLVVLILINCKKLKSMTDIYLLNLAISDLLFLLTIPFWAHYAANGWLLGEVMCKSFTGLYHIGYFGGTFFIILLTIDRYLAIVHAVFALKARTVTFGVVTSGVTWMVAVFASLPRIIFTTVQIEDSFSSCSPQFQQAWKNFHTIMRSVLGLVLPLLVMVICYSAILKTLLRCRNEKKRHKAVKLIFVIMIVYFLFWAPNNIVLLLSTFQESFNVSNCKSTSQLDQIMQVTETLGMTHCCVNPIIYAFVGEKFRRYLSLFFRRHIAKHLCKQCPVFYGETADRVSSTYTPSTGEQEVWVGL

SEQ ID NO: 8 - protein, 7 aa, Artificial Sequence
  Description of Artificial Sequence Synthetic consensus peptide
PPLYSLV

SEQ ID NO: 9 - protein, 10 aa, Artificial Sequence
  Description of Artificial Sequence Synthetic consensus peptide
LLNLAISDLL

SEQ ID NO: 10 - protein, 11 aa, Artificial Sequence
  Description of Artificial Sequence Synthetic consensus peptide
IILLTIDRYLA

SEQ ID NO: 11 - protein, 6 aa, Artificial Sequence
  Description of Artificial Sequence Synthetic consensus peptide
ASLPGI

SEQ ID NO: 12 - protein, 7 aa, Artificial Sequence
  Description of Artificial Sequence Synthetic consensus peptide
RLIFVIM

SEQ ID NO: 13 - protein, 11 aa, Artificial Sequence
  Description of Artificial Sequence Synthetic consensus peptide
HCCINPIIYAF

SEQ ID NO: 14 - DNA, 1065 bp, Artificial Sequence
  Description of Artificial Sequence Synthetic polynucleotide
atggaaactccaaatactactgaagattatgatactactactgaattcgattatggtgatgctactccatgtcaaaaagttaatgaaagagctttcggtgctcaattgttgccaccattgtattctttggttttcgttattggtttggttggtaatattttggttgttttggttttggttcaatataaaagattgaaaaatatgacttctatttatttgttgaatttggctatttctgatttgttgttcttgttcactttgccattctggattgattataaattgaaagatgattgggttttcggtgatgctatgtgtaaaattttgtctggtttctattatactggtttgtattctgaaattttcttcattattttgttgactattgatagatatttggctattgttcatgctgttttcgctttgagagctagaactgttactttcggtgttattacttctattattatttgggctttggctattttggcttctatgccaggtttgtatttctctaaaactcaatgggaattcactcatcatacttgttctttgcatttcccacatgaatctttgagagaatggaaattgttccaagctttgaaattgaatttgttcggtttggttttgccattgttggttatgattatttgttatactggtattattaaaattttgttgagaagaccaaatgaaaaaaaatctaaagctgttagattgattttcgttattatgattattttcttcttgttctggactccatataatttgactattttgatttctgttttccaagatttcttgttcactcatgaatgtgaacaatctagacatttggatttggctgttcaagttactgaagttattgcttatactcattgttgtgttaatccagttatttatgctttcgttggtgaaagattcagaaaatatttgagacaattgttccatagaagagttgctgttcatttggttaaatggttgccattcttgtctgttgatagattggaaagagtttcttctacttctccatctactggtgaacatgaattgtctgctggtttc

SEQ ID NO: 15 - DNA, 1056 bp, Artificial Sequence
  Description of Artificial Sequence Synthetic polynucleotide
atggattatcaagctacttctccatattatgatattgaatatgaattgtctgaaccatgtcaaaaaactgatgttagacaaattgctgctagattgttgccaccattgtattctttggttttcttgtctggtttcgttggtaatttgttggttattttgattttgattaattgtaaaaaattgagaggtatgactgatgtttatttgttgaatttggctatttctgatttgttgttcttgttcactttgccattctgggctcattatgctgctaatggttgggttttcggtgatggtatgtgtaaaactgttactggtttgtatcatgttggttatttcggtggtaatttcttcattattttgttgactgttgatagatatttggctattgttcatgctgttttcgctgttaaagctagaactgttactttcggtgctgttacttctgctgttacttgggctgctgctgttgttgcttctttgccaggttgtattttctctagatctcaaaaagaaggttctagattcacttgttctccacatttcccatctaatcaatatcatttctggaaaaatttccaaactttgaaaatgactattttgggtttggttttgccattgttggttatgattgtttgttattctgctattttgagaactttgttcagatgtagaaatgaaaaaaaaaaacatagagctgttaaattgattttcgttattatgattggttatttcttgttctgggctccaaataatattgttttgttgttgtctactttcccagaatctttcggtttgaataattgttcttcttctaatagattggatcaagctatgcaagttactgaaactttgggtatgactcattgttgtattaatccaattatttatgctttcgttggtgaaaaattcagatcttatttgttggttttcttccaaaaacatattgctagaagattctgtaaaagatgtccagttttccaaggtaaagctttggatagagcttcttctgtttatactagatctactggtgaacaagaaatttctactggtttg

SEQ ID NO: 16 - DNA, 1122 bp, Artificial Sequence
  Description of Artificial Sequence Synthetic polynucleotide
atgttgtctacttctagatctagattcattagaaatactaatgaatctggtgaagaagttactactttcttcgattatgattatggtgctccatgtcataaattcgatgttaaacaaattggtgctcaattgttgccaccattgtattctttggttttcattttcggtttcgttggtaatatgttggttgttttgattttgattaattgtaaaaaattgaaatgtttgactgatatttatttgttgaatttggctatttctgatttgttgttcttgattactttgccattgtgggctcattctgctgctaatgaatgggttttcggtaatgctatgtgtaaattgttcactggtttgtatcatattggttatttcggtggtattttcttcattattttgttgactattgatagatatttggctattgttcatgctgttttcgctttgaaagctagaactgttactttcggtgttgttacttctgttattacttggttggttgctgttttcgcttctgttccaggtattattttcactaaatgtcaaaaagaagattctgtttatgtttgtggtccatatttcccaagaggttggaataatttccatactattatgagaaatattttgggtttggttttgccattgttgattatggttatttgttattctggtattttgaaaactttgttgagatgtagaaatgaaaaaaaaagacatagagctgttagagttattttcactattatgattgtttatttcttgttctggactccatataatattgttattttgttgaatactttccaagaattcttcggtttgtctaattgtgaatctacttctcaattggatcaagctactcaagttactgaaactttgggtatgactcattgttgtattaatccaattatttatgctttcgttggtgaaaaattcagatctttgttccatattgctttgggttgtagaattgctccattgcaaaaaccagtttgtggtggtccaggtgttagaccaggtaaaaatgttaaagttactactcaaggtttgttggatggtagaggtaaaggtaaatctattggtagagctccagaagcttctttgcaagataaagaaggtgct

SEQ ID NO: 17 - DNA, 864 bp, Artificial Sequence
  Description of Artificial Sequence Synthetic polynucleotide
atgactgatatttatttgttgaatttggctatttctgatttgttgttcattttctctttgccattctgggcttattatgctgctcatgattggattttcggtgatgctttgtgtagaattttgtctggtgtttatttgttgggtttctattctggtattttcttcattattttgttgactgttgatagatatttggctattgttcatgctgttttcgctttgaaagctagaactgttacttatggtattttgacttctattgttacttgggctgttgctttgttcgcttctgttccaggtattgttttccataaaactcaacaagaacatactagatatacttgttctgctcattatccacaagaacaaagagatgaatggaaacaattcttggctttgaaaatgaatattttgggtttggttattccaatgattattatgatttgttcttatactcaaattattaaaactttgttgcaatgtagaaatgaaaaaaaaaataaagctgttagattgattttcattattatgattgtttatttcttcttctgggctccatataatatttgtattttgttgagagatttccaagattctttctctattacttcttgtgaaatttctggtcaattgcaaaaagctactcaagttactgaaactatttctatgattcattgttgtattaatccagttatttatgctttcgctggtgaaaaattcagaaaatatttgagatctttcttcagaaaacaaattgcttctcatttctctaaatattgtccagttttctatgctgatactgttgaaagagcttcttctacttatactcaatctactggtgaacaagaagtttctgctgctttg

SEQ ID NO: 18 - DNA, 1062 bp, Artificial Sequence
  Description of Artificial Sequence Synthetic polynucleotide
atggattatcaaactacttctccattctatgatattgattattctacttctgaaccatgtcaaaaaactgatgttagacaaattgctgctagattgttgccaccattgtattctttggttttcatttgtggttctttgggtaatatgttggttattttggttttgattaaatatgttaaattgaaaagagttgctgatatttatttgttgaatttggctatttctgatttgttgttcgttttgactttgccattgtgggctcattatgctgctcattcttgggttttcggtaatagaatgtgtcaattgtctattggtttgtatttcattggtttcttctctggtattttcttcattattttgttgactattgatagatatttggctattgttcatagagttattccattgaaagtttctactgttgctttcggtgttgtttcttctggtgttacttggttggttgctgttttcgcttctttgccaggtattattttcactaaatctcaaaaagaagatttcttggaatctgaaaaagaatctgtttattcttgtggtccatatttcccaccacaatggagaaatttccatattattatgattactattttgtctttggttttgccattgttggttatgattatttgttattctgctattttgaaaactttgttgcaatgtttgccaagaaaaaaacataaagctgttagattgattttcgttattatgattgtttatttcttgttctgggctccatataatattgttttgttgttgtctactttccaagaaattttcggtttgtctgatttcgaaacttcttctagattggatcaagatatgcaagttactgaaactttgggtatgactcattgttgtattaatccaattatttatgctttcgttggtgaaaaattcagaagatatttgtctatgttcttcagaaaacatattgctaaacatttgtgtaaaccaagatgtccagttttctgtggtaaaactgttgaaagagtttcttctagaaatactccatctgctggtgaacaagaattgtctattgct

SEQ ID NO: 19 - DNA, 1149 bp, Artificial Sequence
  Description of Artificial Sequence Synthetic polynucleotide
atggctactacttctgctacttctactgttaatacttcttctttggctactactatgactactaatttcacttctttgttgacttctgttgttactactattgcttctttggttccatctactaattcttctgaagattattatgatgatttggatgatgttgattatgaagaatctgctccatgttataaatctgatactactagattggctgctcaagttgttccagctttgtatttgttggttttcttgttcggtttgttgggtaatattttggttgttattattgttattagatatatgaaaattaaaaatttgactaatatgttgttgttgaatttggctatttctgatttgttgttcttgttgactttgccattctggatgcattatattggtatgtatcatgattggactttcggtatttctttgtgtaaattgttgagaggtgtttgttatatgtctttgtattctcaagttttctgtattattttgttgactgttgatagatatttggctgttgtttatgctgttactgctttgagattcagaactgttacttgtggtattgttacttgtgtttgtacttggttcttggctggtttgttgtctttgccagaattcttcttccatggtcatcaagatgataatggtagagttcaatgtgatccatattatccagaaatgtctactaatgtttggagaagagctcatgttgctaaagttattatgttgtctttgattttgccattgttgattatggctgtttgttattatgttattattagaagattgttgagaagaccatctaaaaaaaaatataaagctattagattgattttcgttattatggttgcttatttcgttttctggactccatataatattgttttgttgttgtctactttccatgctactttgttgaatttgcaatgtgctttgtcttctaatttggatatggctttgttgattactaaaactgttgcttatactcattgttgtattaatccagttatttatgctttcgttggtgaaaaattcagaagacatttgtatcatttcttccatacttatgttgctatttatttgtgtaaatatattccattcttgtctggtgatggtgaaggtaaagaaggtccaactagaatt

SEQ ID NO: 20 - DNA, 1116 bp, Artificial Sequence
  Description of Artificial Sequence Synthetic polynucleotide
atgggtgataatggtactttctctcaagtttctcataatatgttgtctacttctcattctttgttcactactaatattcaaggttctgatgaaccaactactatttatgattatgattattctgctccatgtcaaaaatcttctgttagacaagttgctgctggtttgttgccaccattgtattctttggttttcattttcggtttcgttggtaatatgttggttgttttgattttgattaattgtaaaaaattgaaatctatgactgatatttatttgttgaatttggctatttctgatttgttgttcttgttgactattccattctgggctcattatgctgctaatggttggttgttgggtgaagttatgtgtaaatctttcactggtttgtatcatattggttatttcggtggtactttcttcattattttgttgactattgatagatatttggctattgttcatgctgttttcgctttgaaagctagaactgttactttcggtgttgttacttctggtgttacttggatggttgctgttttcgcttctttgccaagaattattttcactactgttcaaattgaagattctttctcttcttgttctccacaattccaacaagcttggaaaaatttccatactattatgagatctgttttgggtttggttttgccattgttggttatggttatttgttattctgctattttgaaaactttgttgagatgtagaaatgaaaaaaaaagacataaagctgttaaattgattttcgttattatgattgtttatttcttgttctgggctccaaataatattgttttgttgttgtctactttccaagaatctttcaatgtttctaattgtaaatctacttctcaattggatcaaattatgcaagttactgaaactttgggtatgactcattgttgtgttaatccaattatttatgctttcgttggtgaaaaattcagaagatatttgtctttgttcttcagaagacatattgctaaacatttgtgtaaacaatgtccagttttctatggtgaaactgctgatagagtttcttctacttatactccatctactggtgaacaagaagtttgggttggtttg

SEQ ID NO: 21 - DNA, 1102 bp, Artificial Sequence
  Description of Artificial Sequence Synthetic polynucleotide
gacaaggatgatctcgagaaaagaatggattatcaagctacttctccatattatgatattgaatatgaattgtctgaaccatgtcaaaaaactgatgttagacaaattgctgctagattgttgccaccattgtattctttggttttcttgtctggtttcgttggtaatttgttggttattttgattttgattaattgtaaaaaattgagaggtatgactgatgtttatttgttgaatttggctatttctgatttgttgttcttgttcactttgccattctgggctcattatgctgctaatggttgggttttcggtgatggtatgtgtaaaactgttactggtttgtatcatgttggttatttcggtggtaatttcttcattattttgttgactattgatagatatttggctattgttcatgctgttttcgctgttaaagctagaactgttactttcggtgctgttacttctgctgttacttgggctgctgctgttgttgcatctttgccaggtattattttctctagatctcaaaaagaaggttctagattcacttgttctccacatttcccatctaatcaatatcatttctggaaaaatttccaaactttgaaaatgactattttgggtttggttttgccattgttggttatgattgtttgttattctgctattttgagaactttgttcagatgtagaaatgaaaaaaaaaaacatagagctgttagattgattttcgttattatgattggttatttcttgttctgggctccaaataatattgttttgttgttgtctactttcccagaatctttcggtttgaataattgttcttcttctaatagattggatcaagctatgcaagttactgaaactttgggtatgactcattgttgtattaatccaattatttatgctttcgttggtgaaaaattcagatcttatttgttggttttcttccaaaaacatattgctagaagattctgtaaaagatgtccagttttccaaggtaaagctttggatagagcttcttctgtttatactagatctactggtgaacaagaaatttctactggtttgtaataagcggccgcttaattaa

SEQ ID NO: 22 - DNA, 1108 bp, Artificial Sequence
  Description of Artificial Sequence Synthetic polynucleotide
gacaaggatgatctcgagaaaagaatggattatcaaactacttctccattctatgatattgattattctacttctgaaccatgtcaaaaaactgatgttagacaaattgctgctagattgttgccaccattgtattctttggttttcatttgtggttctttgggtaatatgttggttattttggttttgattaaatatgttaaattgaaaagagttgctgatatttatttgttgaatttggctatttctgatttgttgttcgttttgactttgccattgtgggctcattatgctgctcattcttgggttttcggtaatagaatgtgtcaattgtctattggtttgtatttcattggtttcttctctggtattttcttcattattttgttgactattgatagatatttggctattgttcatagagttattccattgaaagtttctactgttgctttcggtgttgtttcttctggtgttacttggttggttgctgttttcgcatctttgccaggtattattttcactaaatctcaaaaagaagatttcttggaatctgaaaaagaatctgtttattcttgtggtccatatttcccaccacaatggagaaatttccatattattatgattactattttgtctttggttttgccattgttggttatgattatttgttattctgctattttgaaaactttgttgcaatgtttgccaagaaaaaaacataaagctgttagattgattttcgttattatgattgtttatttcttgttctgggctccatataatattgttttgttgttgtctactttccaagaaattttcggtttgtctgatttcgaaacttcttctagattggatcaagatatgcaagttactgaaactttgggtatgactcattgttgtattaatccaattatttatgctttcgttggtgaaaaattcagaagatatttgtctatgttcttcagaaaacatattgctaaacatttgtgtaaaccaagatgtccagttttctgtggtaaaactgttgaaagagtttcttctagaaatactccatctgctggtgaacaagaattgtctattgcttaataagcggccgcttaattaa

SEQ ID NO: 23 - DNA, 1162 bp, Artificial Sequence
  Description of Artificial Sequence Synthetic polynucleotide
gacaaggatgatctcgagaaaagaatgggtgataatggtactttctctcaagtttctcataatatgttgtctacttctcattctttgttcactactaatattcaaggttctgatgaaccaactactatttatgattatgattattctgctccatgtcaaaaatcttctgttagacaagttgctgctggtttgttgccaccattgtattctttggttttcattttcggtttcgttggtaatatgttggttgttttgattttgattaattgtaaaaaattgaaatctatgactgatatttatttgttgaatttggctatttctgatttgttgttcttgttgactattccattctgggctcattatgctgctaatggttggttgttgggtgaagttatgtgtaaatctttcactggtttgtatcatattggttatttcggtggtactttcttcattattttgttgactattgatagatatttggctattgttcatgctgttttcgctttgaaagctagaactgttactttcggtgttgttacttctggtgttacttggatggttgctgttttcgcatctttgccaggtattattttcactactgttcaaattgaagattctttctcttcttgttctccacaattccaacaagcttggaaaaatttccatactattatgagatctgttttgggtttggttttgccattgttggttatggttatttgttattctgctattttgaaaactttgttgagatgtagaaatgaaaaaaaaagacataaagctgttagattgattttcgttattatgattgtttatttcttgttctgggctccaaataatattgttttgttgttgtctactttccaagaatctttcaatgtttctaattgtaaatctacttctcaattggatcaaattatgcaagttactgaaactttgggtatgactcattgttgtattaatccaattatttatgctttcgttggtgaaaaattcagaagatatttgtctttgttcttcagaagacatattgctaaacatttgtgtaaacaatgtccagttttctatggtgaaactgctgatagagtttcttctacttatactccatctactggtgaacaagaagtttgggttggtttgtaataagcggccgcttaattaa

SEQ ID NO: 24 - DNA, 1168 bp, Artificial Sequence
  Description of Artificial Sequence Synthetic polynucleotide
gacaaggatgatctcgagaaaagaatgttgtctacttctagatctagattcattagaaatactaatgaatctggtgaagaagttactactttcttcgattatgattatggtgctccatgtcataaattcgatgttaaacaaattggtgctcaattgttgccaccattgtattctttggttttcattttcggtttcgttggtaatatgttggttgttttgattttgattaattgtaaaaaattgaaatgtttgactgatatttatttgttgaatttggctatttctgatttgttgttcttgattactttgccattgtgggctcattctgctgctaatgaatgggttttcggtaatgctatgtgtaaattgttcactggtttgtatcatattggttatttcggtggtattttcttcattattttgttgactattgatagatatttggctattgttcatgctgttttcgctttgaaagctagaactgttactttcggtgttgttacttctgttattacttggttggttgctgttttcgcatctttgccaggtattattttcactaaatgtcaaaaagaagattctgtttatgtttgtggtccatatttcccaagaggttggaataatttccatactattatgagaaatattttgggtttggttttgccattgttgattatggttatttgttattctggtattttgaaaactttgttgagatgtagaaatgaaaaaaaaagacatagagctgttagattgattttcgttattatgattgtttatttcttgttctggactccatataatattgttattttgttgaatactttccaagaattcttcggtttgtctaattgtgaatctacttctcaattggatcaagctactcaagttactgaaactttgggtatgactcattgttgtattaatccaattatttatgctttcgttggtgaaaaattcagatctttgttccatattgctttgggttgtagaattgctccattgcaaaaaccagtttgtggtggtccaggtgttagaccaggtaaaaatgttaaagttactactcaaggtttgttggatggtagaggtaaaggtaaatctattggtagagctccagaagcttctttgcaagataaagaaggtgcttaataagcggccgcttaattaa

SEQ ID NO: 25 - DNA, 910 bp, Artificial Sequence
  Description of Artificial Sequence Synthetic polynucleotide
gacaaggatgatctcgagaaaagaatgactgatatttatttgttgaatttggctatttctgatttgttgttcattttctctttgccattctgggcttattatgctgctcatgattggattttcggtgatgctttgtgtagaattttgtctggtgtttatttgttgggtttctattctggtattttcttcattattttgttgactattgatagatatttggctattgttcatgctgttttcgctttgaaagctagaactgttacttatggtattttgacttctattgttacttgggctgttgctttgttcgcatctttgccaggtattgttttccataaaactcaacaagaacatactagatatacttgttctgctcattatccacaagaacaaagagatgaatggaaacaattcttggctttgaaaatgaatattttgggtttggttattccaatgattattatgatttgttcttatactcaaattattaaaactttgttgcaatgtagaaatgaaaaaaaaaataaagctgttagattgattttcgttattatgattgtttatttcttcttctgggctccatataatatttgtattttgttgagagatttccaagattctttctctattacttcttgtgaaatttctggtcaattgcaaaaagctactcaagttactgaaactatttctatgattcattgttgtattaatccaattatttatgctttcgctggtgaaaaattcagaaaatatttgagatctttcttcagaaaacaaattgcttctcatttctctaaatattgtccagttttctatgctgatactgttgaaagagcttcttctacttatactcaatctactggtgaacaagaagtttctgctgctttgtaataagcggccgcttaattaa

SEQ ID NO: 26 - DNA, 1111 bp, Artificial Sequence
  Description of Artificial Sequence Synthetic polynucleotide
gacaaggatgatctcgagaaaagaatggaaactccaaatactactgaagattatgatactactactgaattcgattatggtgatgctactccatgtcaaaaagttaatgaaagagctttcggtgctcaattgttgccaccattgtattctttggttttcgttattggtttggttggtaatattttggttgttttggttttggttcaatataaaagattgaaaaatatgacttctatttatttgttgaatttggctatttctgatttgttgttcttgttcactttgccattctggattgattataaattgaaagatgattgggttttcggtgatgctatgtgtaaaattttgtctggtttctattatactggtttgtattctgaaattttcttcattattttgttgactattgatagatatttggctattgttcatgctgttttcgctttgagagctagaactgttactttcggtgttattacttctattattatttgggctttggctattttggcatctttgccaggtatttatttctctaaaactcaatgggaattcactcatcatacttgttctttgcatttcccacatgaatctttgagagaatggaaattgttccaagctttgaaattgaatttgttcggtttggttttgccattgttggttatgattatttgttatactggtattattaaaattttgttgagaagaccaaatgaaaaaaaatctaaagctgttagattgattttcgttattatgattattttcttcttgttctggactccatataatttgactattttgatttctgttttccaagatttcttgttcactcatgaatgtgaacaatctagacatttggatttggctgttcaagttactgaagttattgcttatactcattgttgtattaatccaattatttatgctttcgttggtgaaagattcagaaaatatttgagacaattgttccatagaagagttgctgttcatttggttaaatggttgccattcttgtctgttgatagattggaaagagtttcttctacttctccatctactggtgaacatgaattgtctgctggtttctaataagcggccgcttaattaa

SEQ ID NO: 27 - DNA, 1195 bp, Artificial Sequence
  Description of Artificial Sequence Synthetic polynucleotide
gacaaggatgatctcgagaaaagaatggctactacttctgctacttctactgttaatacttcttctttggctactactatgactactaatttcacttctttgttgacttctgttgttactactattgcttctttggttccatctactaattcttctgaagattattatgatgatttggatgatgttgattatgaagaatctgctccatgttataaatctgatactactagattggctgctcaagttgttccaccattgtattcgttggttttcttgttcggtttgttgggtaatattttggttgttattattgttattagatatatgaaaattaaaaatttgactaatatgttgttgttgaatttggctatttctgatttgttgttcttgttgactttgccattctggatgcattatattggtatgtatcatgattggactttcggtatttctttgtgtaaattgttgagaggtgtttgttatatgtctttgtattctcaagttttctgtattattttgttgactattgatagatatttggctgttgtttatgctgttactgctttgagattcagaactgttacttgtggtattgttacttgtgtttgtacttggttcttggctggtttggcatctttgccaggtattttcttccatggtcatcaagatgataatggtagagttcaatgtgatccatattatccagaaatgtctactaatgtttggagaagagctcatgttgctaaagttattatgttgtctttgattttgccattgttgattatggctgtttgttattatgttattattagaagattgttgagaagaccatctaaaaaaaaatataaagctattagattgattttcgttattatggttgcttatttcgttttctggactccatataatattgttttgttgttgtctactttccatgctactttgttgaatttgcaatgtgctttgtcttctaatttggatatggctttgttgattactaaaactgttgcttatactcattgttgtattaatccaattatttatgctttcgttggtgaaaaattcagaagacatttgtatcatttcttccatacttatgttgctatttatttgtgtaaatatattccattcttgtctggtgatggtgaaggtaaagaaggtccaactagaatttaataagcggccgcttaattaa

SEQ ID NO: 28 - DNA, 24 bp, Artificial Sequence
  Description of Artificial Sequence Synthetic primer
gacaaggatgatctcgagaaaaga

SEQ ID NO: 29 - DNA, 22 bp, Artificial Sequence
  Description of Artificial Sequence Synthetic primer
ttaattaagcggccgcttatta

SEQ ID NO: 30 - DNA, 21 bp, Artificial Sequence
  Description of Artificial Sequence Synthetic consensus oligonucleotide
ccaccattgtattctttggtt

SEQ ID NO: 31 - DNA, 19 bp, Artificial Sequence
  Description of Combined DNA/RNA Molecule Synthetic primer
accautgtattcuttggut

SEQ ID NO: 32 - RNA, 20 nt, Artificial Sequence
  Description of Artificial Sequence Synthetic primer
accaaagaauacaauggugg

SEQ ID NO: 33 - DNA, 30 bp, Artificial Sequence
  Description of Artificial Sequence Synthetic consensus oligonucleotide
ttgttgaatttggctatttctgatttgttg

SEQ ID NO: 34 - DNA, 24 bp, Artificial Sequence
  Description of Combined DNA/RNA Molecule Synthetic primer
aatttggcuatttcugatttgtug

SEQ ID NO: 35 - DNA, 29 bp, Artificial Sequence
  Description of Combined DNA/RNA Molecule Synthetic primer
aacaaaucagaaauagccaaatucaacaa

SEQ ID NO: 36 - DNA, 33 bp, Artificial Sequence
  Description of Artificial Sequence Synthetic consensus oligonucleotide
attattttgttgactattgatagatatttggct

SEQ ID NO: 37 - DNA, 30 bp, Artificial Sequence
  Description of Combined DNA/RNA Molecule Synthetic primer
attttgutgactattgauagatattuggct

SEQ ID NO: 38 - DNA, 29 bp, Artificial Sequence
  Description of Combined DNA/RNA Molecule Synthetic primer
aaatatcuatcaatagucaacaaaauaat

SEQ ID NO: 39 - DNA, 18 bp, Artificial Sequence
  Description of Artificial Sequence Synthetic consensus oligonucleotide
gcatctttgccaggtatt

SEQ ID NO: 40 - DNA, 16 bp, Artificial Sequence
  Description of Combined DNA/RNA Molecule Synthetic primer
atcttugccaggtaut

SEQ ID NO: 41 - DNA, 17 bp, Artificial Sequence
  Description of Combined DNA/RNA Molecule Synthetic primer
ataccuggcaaagaugc

SEQ ID NO: 42 - DNA, 21 bp, Artificial Sequence
  Description of Artificial Sequence Synthetic consensus oligonucleotide
agattgattttcgttattatg

SEQ ID NO: 43 - DNA, 19 bp, Artificial Sequence
  Description of Combined DNA/RNA Molecule Synthetic primer
attgautttcgutattaug

SEQ ID NO: 44 - DNA, 20 bp, Artificial Sequence
  Description of Combined DNA/RNA Molecule Synthetic primer
ataauaacgaaaaucaauct

SEQ ID NO: 45 - DNA, 33 bp, Artificial Sequence
  Description of Artificial Sequence Synthetic consensus oligonucleotide
cattgttgtattaatccaattatttatgctttc

SEQ ID NO: 46 - DNA, 32 bp, Artificial Sequence
  Description of Combined DNA/RNA Molecule Synthetic primer
attgttgtautaatccaattauttatgcttuc

SEQ ID NO: 47 - DNA, 32 bp, Artificial Sequence
  Description of Combined DNA/RNA Molecule Synthetic primer
aaagcataaauaattggattaauacaacaaug

SEQ ID NO: 48 - protein, 523 aa, Solanum lycopensicum
MAGGGFTTSGNGGTHFEAKITPIVIISCIMAATGGLMFGYDVGVSGGVTSMDPFLKKFFPTVYKRTKEPGLDSNYCKYDNQGLQLFTSSLYLAGLTATFFASYTTRKLGRRLTMLIAGCFFIIGVVLNAAAQDLAMLIIGRILLGCGVGFANQAVPLFLSEIAPTRIRGGLNILFQLNVTIGILFANLVNYGTAKISGGWGWRLSLGLAGFPAVLLTLGALFVVETPNSLIERGYLEEGKEVLRKIRGTDNIEPEFLELVEASRVAKQVKHPFRNLLQRKNRPQLIISVALQIFQQFTGINAIMFYAPVLFSTLGFGNSAALYSAVITGAVNVLSTVVSVYSVDKLGRRVLLLEAGVQMLLSQIIIAIILGIKVTDHSDNLSHGWGIFVVVLICTYVSAFAWSWGPLGWLIPSETFPLETRSAGQSVTVCVNLLFTFVMAQAFLSMLCHFKYGIFLFFSGWIFVMSLFVFFLLPETKNVPIEEMTERVWKQHWLWKRFMVDEDDVDMIKKNGHANGYDPTSRL

SEQ ID NO: 49 - protein, 526 aa, Vitis vinifera
MEVGDGSFAPVGVSKQRADQYKGRLTTYVVVACLVAAVGGAIFGYDIGVSGGVTSMDTFLEKFFHTVYLKKRRAEEDHYCKYNDQGLAAFTSSLYLAGLVASIVASPITRKYGRRASIVCGGISFLIGAALNAAAVNLAMLLSGRIMLGIGIGFGDQAVPLYLSEMAPAHLRGALNMMFQLATTTGIFTANMINYGTAKLPSWGWRLSLGLAALPAILMTVGGLFLPETPNSLIERGSREKGRRVLERIRGTNEVDAEFEDIVDASELANSIKHPFRNILERRNRPQLVMAICMPAFQILNGINSILFYAPVLFQTMGFGNATLYSSALTGAVLVLSTVVSIGLVDRLGRRVLLISGGIQMVLCQVTVAIILGVKFGSNDGLSKGYSVLVVIVICLFVIAFGWSWGPLGWTVPSEIFPLETRSAGQSITVVVNLLFTFIIAQCFLSMLCSFKHGIFLFFAGWIVIMTLFVYFFLPETKGVPIEEMIFVWKKHWFWKRMVPGTPDVDDIDGLGSHSMESGGKTKLGS

SEQ ID NO: 50 - protein, 511 aa, Glycine max
MAGGGLTNGGPGKRAHLYEHKFTAYFAFTCVVGALGGSLFGYDLGVSGGVPSMDDFLKEFFPKVYRRKQMHLHETDYCKYDDQVLTLFTSSLYFSALVMTFFASFLTRKKGRKAIIIVGALSFLAGAILNAAAKNIAMLIIGRVLLGGGIGFGNQAVPLYLSEMAPAKNRGAVNQLFQFTTCAGILIANLVNYFTEKIHPYGWRISLGLAGLPAFAMLVGGICCAETPNSLVEQGRLDKAKQVLQRIRGTENVEAEFEDLKEASEEAQAVKSPFRTLLKRKYRPQLIIGALGIPAFQQLTGNNSILFYAPVIFQSLGFGANASLFSSFITNGALLVATVISMFLVDKYGRRKFFLEAGFEMICCMIITGAVLAVNFGHGKEIGKGVSAFLVVVIFLFVLAYGRSWGPLGWLVPSELFPLEIRSSAQSIVVCVNMIFTALVAQLFLMSLCHLKFGIFLLFASLIIFMSFFVFFLLPETKKVPIEEIYLLFENHWFWRRFVTDQDPETSKGTA

SEQ ID NO: 51 - protein, 512 aa, Triticum aestivum
MAAGSVVGVSESNDGGGGGRVTMFVVLSCITAGMGGAIFGYDIGIAGGVLSMEPFLRKFFPDVYRRMKGDSHVSNYCKFDSQLLTAFTSSLYVAGLLTTFLASGVTARRGRRPSMLLGGAAFLAGAAVGGASLNVYMAILGRVLLGVGLGFANQAVPLYLSEMAPPRHRGAFSNGFQFSVGVGALAANVINFGTEKIKGGWGWRVSLSLAAVPAGLLLVGAVFLPETPNSLVQQGKDRREVAVLLRKIRGTDDVDRELDGIVAAADSGAVAGSSGLRMLLTQRRYRPQLVMAVAIPFFQQVTGINAIAFYAPVLLRTIGMGESASLLSAVVTGVVGAASTLLSMFLVDRFGRRTLFLAGGAQMLASQLLIGAIMAAKLGDDGGVSKTWAAALILLIAVYVAGFGWSWGPLGWLVPSEIFPLEVRSAGQGVTVATSFVFTVFVAQTFLAMLCRMRAGIFFFFAAWLAAMTVFVYLLLPETRGVPIEQVDRVWREHWFWRRVVGSEEAPASGKL

SEQ ID NO: 52 - protein, 525 aa, Aegilops tauschii
MAIGGFVEAPAGADYGGRVTSFVVLSCIVAGSGGILFGYDLGISGGVTSMESFLRKFFPDVYHQMKGDKDVSNYCRFDSELLTVFTSSLYIAGLVATLFASSVTRRFGRRTSILIGGTVFVIGSVFGGAAVNVYMLLLNRILLGVGLGFTNQSIPLYLSEMAPPQYRGAINNGFELCISIGILIANLINYGVEKIAGGWGWRISLSLAAVPAAFLTVGAIYLPETPSFIIQRRGGSNNVDEARLLLQRLRGTTRVQKELDDLVSATRTTTTGRPFRTILRRKYRPQLVIALLVPFFNQVTGINVINFYAPVMFRTIGLKESASLMSAVVTRVCATAANVVAMVVVDRFGRRKLFLVGGVQMILSQAMVGAVLAAKFQEHGGMEKEYAYLVLVIMCVFVAGFAWSWGPLTYLVPTEICPLEIRSAGQSVVIAVIFFVTFLIGQTFLAMLCHLKFGTFFLFGGWVCVMTLFVYFFLPETKQLPMEQMEQVWRTHWFWKRIVDEDAAGEQPREEAAGTIALSSTSTTT

SEQ ID NO: 53 - protein, 11 aa, Artificial Sequence
  Description of Artificial Sequence Synthetic consensus peptide
FGYDVGVSGGV

SEQ ID NO: 54 - protein, 11 aa, Artificial Sequence
  Description of Artificial Sequence Synthetic consensus peptide
FGYDIGVSGGV

SEQ ID NO: 55 - protein, 6 aa, Artificial Sequence
  Description of Artificial Sequence Synthetic consensus peptide
FTSSLY

SEQ ID NO: 56 - protein, 12 aa, Artificial Sequence
  Description of Artificial Sequence Synthetic consensus peptide
QAVPLFLSEIAP

SEQ ID NO: 57 - protein, 12 aa, Artificial Sequence
  Description of Artificial Sequence Synthetic consensus peptide
QAVPLYLSEMAP

SEQ ID NO: 58 - protein, 4 aa, Artificial Sequence
  Description of Artificial Sequence Synthetic consensus peptide
RPQL

SEQ ID NO: 59 - protein, 5 aa, Artificial Sequence
  Description of Artificial Sequence Synthetic consensus peptide
SWGPL

SEQ ID NO: 60 - protein, 7 aa, Artificial Sequence
  Description of Artificial Sequence Synthetic consensus peptide
PLETRSA

SEQ ID NO: 61 - protein, 4 aa, Artificial Sequence
  Description of Artificial Sequence Synthetic consensus peptide
LPET

SEQ ID NO: 62 - DNA, 1617 bp, Artificial Sequence
  Description of Artificial Sequence Synthetic polynucleotide
cacgggggactctagaggatccccgggatggctggaggaggatttactacttctggaaacggaggaactcattttgaggctaagattactccaattgttattatttcttgtattatggctgctactggaggacttatgtttggatatgatgttggagtttctggaggagttacttctatggatccatttcttaagaagttttttccaactgtttataagagaactaaggagccaggacttgattctaactattgtaagtatgataaccaaggacttcaactttttacttcttctctttatcttgctggacttactgctactttttttgcttcttatactactagaaagcttggaagaagacttactatgcttattgctggatgtttttttattattggagttgttcttaacgctgctgctcaagatcttgctatgcttattattggaagaattcttcttggatgtggagttggatttgctaaccaagctgttccactttttctttctgagattgctccaactagaattagaggaggacttaacattctttttcaacttaacgttactattggaattctttttgctaaccttgttaactatggaactgctaagatttctggaggatggggatggagactttctcttggacttgctggatttccagctgttcttcttactcttggagcactttttgttgttgagactccaaactctcttattgagagaggatatcttgaggagggaaaggaggttcttagaaagattagaggaactgataacattgagccagagtttcttgagcttgttgaggcttctagagttgctaagcaagttaagcatccatttagaaaccttcttcaaagaaagaacagaccacaacttattatttctgttgctcttcaaatttttcaacaatttactggaattaacgctattatgttttatgctccagttcttttttctactcttggatttggaaactctgctgctctttattctgctgttattactggagctgttaacgttctttctactgttgtttctgtttattctgttgataagcttggaagaagagttcttcttcttgaggctggagttcaaatgcttctttctcaaattattattgctattattcttggaattaaggttactgatcattctgataacctttctcatggatggggaatttttgttgttgttcttatttgtacttatgtttctgcttttgcttggtcttggggaccacttggatggcttattccatctgagacttttccacttgagactagatctgctggacaatctgttactgtttgtgttaaccttctttttacttttgttatggctcaagcttttctttctatgctttgtcattttaagtatggaatttttctttttttttctggatggatttttgttatgtctctttttgttttttttcttcttccagagactaagaacgttccaattgaggagatgactgagagagtttggaagcaacattggctttggaagagatttatggttgatgaggatgatgttgatatgattaagaagaacggacatgctaacggatatgatccaacttctagactttaataagagctcgaatttccc

SEQ ID NO: 63 - DNA, 1626 bp, Artificial Sequence
  Description of Artificial Sequence Synthetic polynucleotide
cacgggggactctagaggatccccgggatggaggttggagatggatcttttgctccagttggagtttctaagcaaagagctgatcaatataagggaagacttactacttatgttgttgttgcttgtcttgttgctgctgttggaggagctatttttggatatgatattggagtttctggaggagttacttctatggatacttttcttgagaagttttttcatactgtttatcttaagaagagaagagctgaggaggatcattattgtaagtataacgatcaaggacttgctgcttttacttcttctctttatcttgctggacttgttgcttctattgttgcttctccaattactagaaagtatggaagaagagcttctattgtttgtggaggaatttcttttcttattggagctgctcttaacgctgctgctgttaaccttgctatgcttctttctggaagaattatgcttggaattggaattggatttggagatcaagctgttccactttatctttctgagatggctccagctcatcttagaggagcacttaacatgatgtttcaacttgctactactactggaatttttactgctaacatgattaactatggaactgctaagcttccatcttggggatggagactttctcttggacttgctgctcttccagctattcttatgactgttggaggactttttcttccagagactccaaactctcttattgagagaggatctagagagaagggaagaagagttcttgagagaattagaggaactaacgaggttgatgctgagtttgaggatattgttgatgcttctgagcttgctaactctattaagcatccatttagaaacattcttgagagaagaaacagaccacaacttgttatggctatttgtatgccagcttttcaaattcttaacggaattaactctattcttttttatgctccagttctttttcaaactatgggatttggaaacgctactctttattcttctgctcttactggagctgttcttgttctttctactgttgtttctattggacttgttgatagacttggaagaagagttcttcttatttctggaggaattcaaatggttctttgtcaagttactgttgctattattcttggagttaagtttggatctaacgatggactttctaagggatattctgttcttgttgttattgttatttgtctttttgttattgcttttggatggtcttggggaccacttggatggactgttccatctgagatttttccacttgagactagatctgctggacaatctattactgttgttgttaaccttctttttacttttattattgctcaatgttttctttctatgctttgttcttttaagcatggaatttttcttttttttgctggatggattgttattatgactctttttgtttatttttttcttccagagactaagggagttccaattgaggagatgatttttgtttggaagaagcattggttttggaagagaatggttccaggaactccagatgttgatgatattgatggacttggatctcattctatggagtctggaggaaagactaagcttggatcttaataagagctcgaatttccc

SEQ ID NO: 64 - DNA, 1581 bp, Artificial Sequence
  Description of Artificial Sequence Synthetic polynucleotide
cacgggggactctagaggatccccgggatggctggaggaggacttactaacggaggaccaggaaagagagcacatctttatgagcataagtttactgcttattttgcttttacttgtgttgttggagcacttggaggatctctttttggatatgatcttggagtttctggaggagttccatctatggatgattttcttaaggagttttttccaaaggtttatagaagaaagcaaatgcatcttcatgagactgattattgtaagtatgatgatcaagttcttactctttttacttcttctctttatttttctgctcttgttatgactttttttgcttcttttcttactagaaagaagggaagaaaggctattattattgttggagcactttcttttcttgctggagctattcttaacgctgctgctaagaacattgctatgcttattattggaagagttcttcttggaggaggaattggatttggaaaccaagctgttccactttatctttctgagatggctccagctaagaacagaggagctgttaaccaactttttcaatttactacttgtgctggaattcttattgctaaccttgttaactattttactgagaagattcatccatatggatggagaatttctcttggacttgctggacttccagcttttgctatgcttgttggaggaatttgttgtgctgagactccaaactctcttgttgagcaaggaagacttgataaggctaagcaagttcttcaaagaattagaggaactgagaacgttgaggctgagtttgaggatcttaaggaggcttctgaggaggctcaagctgttaagtctccatttagaactcttcttaagagaaagtatagaccacaacttattattggagctcttggaattccagcttttcaacaacttactggaaacaactctattcttttttatgctccagttatttttcaatctcttggatttggagctaacgcttctcttttttcttcttttattactaacggagcacttcttgttgctactgttatttctatgtttcttgttgataagtatggaagaagaaagttttttcttgaggctggatttgagatgatttgttgtatgattattactggagctgttcttgctgttaactttggacatggaaaggagattggaaagggagtttctgcttttcttgttgttgttatttttctttttgttcttgcttatggaagatcttggggaccacttggatggcttgttccatctgagctttttccacttgagattagatcttctgctcaatctattgttgtttgtgttaacatgatttttactgctcttgttgctcaactttttcttatgtctctttgtcatcttaagtttggaatttttcttctttttgcttctcttattatttttatgtctttttttgttttttttcttcttccagagactaagaaggttccaattgaggagatttatcttctttttgagaaccattggttttggagaagatttgttactgatcaagatccagagacttctaagggaactgcttaataagagctcgaatttccc

SEQ ID NO: 65 - DNA, 1584 bp, Artificial Sequence
  Description of Artificial Sequence Synthetic polynucleotide
cacgggggactctagaggatccccgggatggctgctggatctgttgttggagtttctgagtctaacgatggaggaggaggaggaagagttactatgtttgttgttctttcttgtattactgctggaatgggaggagctatttttggatatgatattggaattgctggaggagttctttctatggagccatttcttagaaagttttttccagatgtttatagaagaatgaagggagattctcatgtttctaactattgtaagtttgattctcaacttcttactgcttttacttcttctctttatgttgctggacttcttactacttttcttgcttctggagttactgctagaagaggaagaagaccatctatgcttcttggaggagctgcttttcttgctggagctgctgttggaggagcttctcttaacgtttatatggctattcttggaagagttcttcttggagttggacttggatttgctaaccaagctgttccactttatctttctgagatggctccaccaagacatagaggagctttttctaacggatttcaattttctgttggagttggagcacttgctgctaacgttattaactttggaactgagaagattaagggaggatggggatggagagtttctctttctcttgctgctgttccagctggacttcttcttgttggagctgtttttcttccagagactccaaactctcttgttcaacaaggaaaggatagaagagaggttgctgttcttcttagaaagattagaggaactgatgatgttgatagagagcttgatggaattgttgctgctgctgattctggagctgttgctggatcttctggacttagaatgcttcttactcaaagaagatatagaccacaacttgttatggctgttgctattccattttttcaacaagttactggaattaacgctattgctttttatgctccagttcttcttagaactattggaatgggagagtctgcttctcttctttctgctgttgttactggagttgttggagctgcttctactcttctttctatgtttcttgttgatagatttggaagaagaactctttttcttgctggaggagcacaaatgcttgcttctcaacttcttattggagctattatggctgctaagcttggagatgatggaggagtttctaagacttgggctgctgctcttattcttcttattgctgtttatgttgctggatttggatggtcttggggaccacttggatggcttgttccatctgagatttttccacttgaggttagatctgctggacaaggagttactgttgctacttcttttgtttttactgtttttgttgctcaaacttttcttgctatgctttgtagaatgagagctggaattttttttttttttgctgcttggcttgctgctatgactgtttttgtttatcttcttcttccagagactagaggagttccaattgagcaagttgatagagtttggagagagcattggttttggagaagagttgttggatctgaggaggctccagcttctggaaagctttaataagagctcgaatttccc

SEQ ID NO: 66 - DNA, 1566 bp, Artificial Sequence
  Description of Artificial Sequence Synthetic polynucleotide
cacgggggactctagaggatccccgggatggctattggaggatttgttgaggctccagctggagctgattatattctttttggatatgatcttggaatttctggaggagttacttctatggagtcttttcttagaaagttttttccagatgtttatcatcaaatgaagggagataaggatgtttctaactattgtagatttgattctgagcttcttactgtttttacttcttctctttatattgctggacttgttgctactctttttgcttcttctgttactagaagatttggaagaagaacttctattcttattggaggaactgtttttgttattggatctgtttttggaggagctgctgttaacgtttatatgcttcttcttaacagaattcttcttggagttggacttggatttactaaccaatctattccactttatctttctgagatggctccaccacaatatagaggagctattaacaacggatttgagctttgtatttctattggaattcttattgctaaccttattaactatggagttgagaagattgctggaggatggggatggagaatttctctttctcttgctgctgttccagctgcttttcttactgttggagctatttatcttccagagactccatcttttattattcaaagaagaggaggatctaacaacgttgatgaggctagacttcttcttcaaagacttagaggaactactagagttcaaaaggagcttgatgatcttgtttctgctactagaactactactactggaagaccatttagaactattcttagaagaaagtatagaccacaacttgttattgctcttcttgttccattttttaaccaagttactggaattaacgttattaacttttatgctccagttatgtttagaactattggacttaaggagtctgcttctcttatgtctgctgttgttactagagtttgtgctactgctgctaacgttgttgctatggttgttgttgatagatttggaagaagaaagctttttcttgttggaggagttcaaatgattctttctcaagctatggttggagctgttcttgctgctaagtttcaagagcatggaggaatggagaaggagtatgcttatcttgttcttgttattatgtgtgtttttgttgctggatttgcttggtcttggggaccacttacttatcttgttccaactgagatttgtccacttgagattagatctgctggacaatctgttgttattgctgttattttttttgttacttttcttattggacaaacttttcttgctatgctttgtcatcttaagtttggaactttttttctttttggaggatgggtttgtgttatgactctttttgtttatttttttcttccagagactaagcaacttccaatggagcaaatggagcaagtttggagaactcattggttttggaagagaattgttgatgaggatgctgctggagagcaaccaagagaggaggctgctggaactattgctctttcttctacttctactactacttaataagagctcgaatttccc

SEQ ID NO: 67 - DNA, 33 bp, Artificial Sequence
  Description of Artificial Sequence Synthetic consensus oligonucleotide
tttggatatgatgttggagtttctggaggagtt

SEQ ID NO: 68 - DNA, 33 bp, Artificial Sequence
  Description of Artificial Sequence Synthetic consensus oligonucleotide
tttggatatgatattggagtttctggaggagtt

SEQ ID NO: 69 - DNA, 19 bp, Artificial Sequence
  Description of Artificial Sequence Synthetic consensus oligonucleotide
ttttacttcttctctttat

SEQ ID NO: 70 - DNA, 28 bp, Artificial Sequence
  Description of Artificial Sequence Synthetic consensus oligonucleotide
tccactttttctttctgagattgctcca

SEQ ID NO: 71 - DNA, 28 bp, Artificial Sequence
  Description of Artificial Sequence Synthetic consensus oligonucleotide
tccactttatctttctgagatggctcca

SEQ ID NO: 72 - DNA, 12 bp, Artificial Sequence
  Description of Artificial Sequence Synthetic consensus oligonucleotide
agaccacaactt

SEQ ID NO: 73 - DNA, 15 bp, Artificial Sequence
  Description of Artificial Sequence Synthetic consensus oligonucleotide
tcttggggaccactt

SEQ ID NO: 74 - DNA, 21 bp, Artificial Sequence
  Description of Artificial Sequence Synthetic consensus oligonucleotide
ccacttgagactagatctgct

SEQ ID NO: 75 - DNA, 15 bp, Artificial Sequence
  Description of Artificial Sequence Synthetic consensus oligonucleotide
ttcttccagagacta

SEQ ID NO: 76 - DNA, 1569 bp, Artificial Sequence
  Description of Artificial Sequence Synthetic polynucleotide
atggctggaggaggatttactacttctggaaacggaggaactcattttgaggctaagattactccaattgttattatttcttgtattatggctgctactggaggacttatgtttggatatgatgttggagtttctggaggagttacttctatggatccatttcttaagaagttttttccaactgtttataagagaactaaggagccaggacttgattctaactattgtaagtatgataaccaaggacttcaactttttacttcttctctttatcttgctggacttactgctactttttttgcttcttatactactagaaagcttggaagaagacttactatgcttattgctggatgtttttttattattggagttgttcttaacgctgctgctcaagatcttgctatgcttattattggaagaattcttcttggatgtggagttggatttgctaaccaagctgttccactttttctttctgagattgctccaactagaattagaggaggacttaacattctttttcaacttaacgttactattggaattctttttgctaaccttgttaactatggaactgctaagatttctggaggatggggatggagactttctcttggacttgctggatttccagctgttcttcttactcttggagcactttttgttgttgagactccaaactctcttattgagagaggatatcttgaggagggaaaggaggttcttagaaagattagaggaactgataacattgagccagagtttcttgagcttgttgaggcttctagagttgctaagcaagttaagcatccatttagaaaccttcttcaaagaaagaacagaccacaacttattatttctgttgctcttcaaatttttcaacaatttactggaattaacgctattatgttttatgctccagttcttttttctactcttggatttggaaactctgctgctctttattctgctgttattactggagctgttaacgttctttctactgttgtttctgtttattctgttgataagcttggaagaagagttcttcttcttgaggctggagttcaaatgcttctttctcaaattattattgctattattcttggaattaaggttactgatcattctgataacctttctcatggatggggaatttttgttgttgttcttatttgtacttatgtttctgcttttgcttggagttggggaccacttggatggcttattccatctgagacttttccacttgagactagatctgctggacaatctgttactgtttgtgttaaccttctttttacttttgttatggctcaagcttttctttctatgctttgtcattttaagtatggaatttttctttttttttctggatggatttttgttatgtctctttttgttttttttctacttccagagactaagaacgttccaattgaggagatgactgagagagtttggaagcaacattggctttggaagagatttatggttgatgaggatgatgttgatatgattaagaagaacggacatgctaacggatatgatccaacttctagactt

SEQ ID NO: 77 - DNA, 1578 bp, Artificial Sequence
  Description of Artificial Sequence Synthetic polynucleotide
atggaggttggagatggatcttttgctccagttggagtttctaagcaaagagctgatcaatataagggaagacttactacttatgttgttgttgcttgtcttgttgctgctgttggaggagctatttttggatatgatgttggagtttctggaggagttacttctatggatacttttcttgagaagttttttcatactgtttatcttaagaagagaagagctgaggaggatcattattgtaagtataacgatcaaggacttgctgcttttacttcttctctttatcttgctggacttgttgcttctattgttgcttctccaattactagaaagtatggaagaagagcttctattgtttgtggaggaatttcttttcttattggagctgctcttaacgctgctgctgttaaccttgctatgcttctttctggaagaattatgcttggaattggaattggatttggagatcaagctgttccactttttctttctgagattgctccagctcatcttagaggagctcttaacatgatgtttcaacttgctactactactggaatttttactgctaacatgattaactatggaactgctaagcttccatcttggggatggagactttctcttggacttgctgctcttccagctattcttatgactgttggaggactttttcttccagagactccaaactctcttattgagagaggatctagagagaagggaagaagagttcttgagagaattagaggaactaacgaggttgatgctgagtttgaggatattgttgatgcttctgagcttgctaactctattaagcatccatttagaaacattcttgagagaagaaacagaccacaacttgttatggctatttgtatgccagcttttcaaattcttaacggaattaactctattcttttttatgctccagttctttttcaaactatgggatttggaaacgctactctttattcttctgctcttactggagctgttcttgttctttctactgttgtttctattggacttgttgatagacttggaagaagagttcttcttatttctggaggaattcaaatggttctttgtcaagttactgttgctattattcttggagttaagtttggatctaacgatggactttctaagggatattctgttcttgttgttattgttatttgtctttttgttattgcttttggatggagttggggaccacttggatggactgttccatctgagatttttccacttgagactagatctgctggacaatctattactgttgttgttaaccttctttttacttttattattgctcaatgttttctttctatgctttgttcttttaagcatggaatttttcttttttttgctggatggattgttattatgactctttttgtttattttttacttccagagactaagggagttccaattgaggagatgatttttgtttggaagaagcattggttttggaagagaatggttccaggaactccagatgttgatgatattgatggacttggatctcattctatggagtctggaggaaagactaagcttggatct

SEQ ID NO: 78 - DNA, 1533 bp, Artificial Sequence
  Description of Artificial Sequence Synthetic polynucleotide
atggctggaggaggacttactaacggaggaccaggaaagagagcacatctttatgagcataagtttactgcttattttgcttttacttgtgttgttggagcacttggaggatctctttttggatatgatgttggagtttctggaggagttccatctatggatgattttcttaaggagttttttccaaaggtttatagaagaaagcaaatgcatcttcatgagactgattattgtaagtatgatgatcaagttcttactctttttacttcttctctttatttttctgctcttgttatgactttttttgcttcttttcttactagaaagaagggaagaaaggctattattattgttggagcactttcttttcttgctggagctattcttaacgctgctgctaagaacattgctatgcttattattggaagagttcttcttggaggaggaattggatttggaaaccaagctgttccactttttctttctgagattgctccagctaagaacagaggagctgttaaccaactttttcaatttactacttgtgctggaattcttattgctaaccttgttaactattttactgagaagattcatccatatggatggagaatttctcttggacttgctggacttccagcttttgctatgcttgttggaggaatttgttgtgctgagactccaaactctcttgttgagcaaggaagacttgataaggctaagcaagttcttcaaagaattagaggaactgagaacgttgaggctgagtttgaggatcttaaggaggcttctgaggaggctcaagctgttaagtctccatttagaactcttcttaagagaaagtatagaccacaacttattattggagcacttggaattccagcttttcaacaacttactggaaacaactctattcttttttatgctccagttatttttcaatctcttggatttggagctaacgcttctcttttttcttcttttattactaacggagcacttcttgttgctactgttatttctatgtttcttgttgataagtatggaagaagaaagttttttcttgaggctggatttgagatgatttgttgtatgattattactggagctgttcttgctgttaactttggacatggaaaggagattggaaagggagtttctgcttttcttgttgttgttatttttctttttgttcttgcttatggaagaagttggggaccacttggatggcttgttccatctgagctttttccacttgagactagatctgctgctcaatctattgttgtttgtgttaacatgatttttactgctcttgttgctcaactttttcttatgtctctttgtcatcttaagtttggaatttttcttctttttgcttctcttattatttttatgtctttttttgttttttttctacttccagagactaagaaggttccaattgaggagatttatcttctttttgagaaccattggttttggagaagatttgttactgatcaagatccagagacttctaagggaactgct

SEQ ID NO: 79 - DNA, 1536 bp, Artificial Sequence
  Description of Artificial Sequence Synthetic polynucleotide
atggctgctggatctgttgttggagtttctgagtctaacgatggaggaggaggaggaagagttactatgtttgttgttctttcttgtattactgctggaatgggaggagctatttttggatatgatgttggagtttctggaggagttctttctatggagccatttcttagaaagttttttccagatgtttatagaagaatgaagggagattctcatgtttctaactattgtaagtttgattctcaacttcttactgcttttacttcttctctttatgttgctggacttcttactacttttcttgcttctggagttactgctagaagaggaagaagaccatctatgcttcttggaggagctgcttttcttgctggagctgctgttggaggagcttctcttaacgtttatatggctattcttggaagagttcttcttggagttggacttggatttgctaaccaagctgttccactttttctttctgagattgctccaccaagacatagaggagctttttctaacggatttcaattttctgttggagttggagcacttgctgctaacgttattaactttggaactgagaagattaagggaggatggggatggagagtttctctttctcttgctgctgttccagctggacttcttcttgttggagctgtttttcttccagagactccaaactctcttgttcaacaaggaaaggatagaagagaggttgctgttcttcttagaaagattagaggaactgatgatgttgatagagagcttgatggaattgttgctgctgctgattctggagctgttgctggatcttctggacttagaatgcttcttactcaaagaagatatagaccacaacttgttatggctgttgctattccattttttcaacaagttactggaattaacgctattgctttttatgctccagttcttcttagaactattggaatgggagagtctgcttctcttctttctgctgttgttactggagttgttggagctgcttctactcttctttctatgtttcttgttgatagatttggaagaagaactctttttcttgctggaggagcacaaatgcttgcttctcaacttcttattggagctattatggctgctaagcttggagatgatggaggagtttctaagacttgggctgctgctcttattcttcttattgctgtttatgttgctggatttggatggagttggggaccacttggatggcttgttccatctgagatttttccacttgagactagatctgctggacaaggagttactgttgctacttcttttgtttttactgtttttgttgctcaaacttttcttgctatgctttgtagaatgagagctggaattttttttttttttgctgcttggcttgctgctatgactgtttttgtttatcttctacttccagagactagaggagttccaattgagcaagttgatagagtttggagagagcattggttttggagaagagttgttggatctgaggaggctccagcttctggaaagctt

SEQ ID NO: 80 - DNA, 1575 bp, Artificial Sequence
  Description of Artificial Sequence Synthetic polynucleotide
atggctattggaggatttgttgaggctccagctggagctgattatggaggaagagttacttcttttgttgttctttcttgtattgttgctggatctggaggaattctttttggatatgatgttggagtttctggaggagttacttctatggagtcttttcttagaaagttttttccagatgtttatcatcaaatgaagggagataaggatgtttctaactattgtagatttgattctgagcttcttactgtttttacttcttctctttatattgctggacttgttgctactctttttgcttcttctgttactagaagatttggaagaagaacttctattcttattggaggaactgtttttgttattggatctgtttttggaggagctgctgttaacgtttatatgcttcttcttaacagaattcttcttggagttggacttggatttactaaccaagctgttccactttttctttctgagattgctccaccacaatatagaggagctattaacaacggatttgagctttgtatttctattggaattcttattgctaaccttattaactatggagttgagaagattgctggaggatggggatggagaatttctctttctcttgctgctgttccagctgcttttcttactgttggagctatttatcttccagagactccatcttttattattcaaagaagaggaggatctaacaacgttgatgaggctagacttcttcttcaaagacttagaggaactactagagttcaaaaggagcttgatgatcttgtttctgctactagaactactactactggaagaccatttagaactattcttagaagaaagtatagaccacaacttgttattgctcttcttgttccattttttaaccaagttactggaattaacgttattaacttttatgctccagttatgtttagaactattggacttaaggagtctgcttctcttatgtctgctgttgttactagagtttgtgctactgctgctaacgttgttgctatggttgttgttgatagatttggaagaagaaagctttttcttgttggaggagttcaaatgattctttctcaagctatggttggagctgttcttgctgctaagtttcaagagcatggaggaatggagaaggagtatgcttatcttgttcttgttattatgtgtgtttttgttgctggatttgcttggagttggggaccacttacttatcttgttccaactgagatttgtccacttgagactagatctgctggacaatctgttgttattgctgttattttttttgttacttttcttattggacaaacttttcttgctatgctttgtcatcttaagtttggaactttttttctttttggaggatgggtttgtgttatgactctttttgtttattttttacttccagagactaagcaacttccaatggagcaaatggagcaagtttggagaactcattggttttggaagagaattgttgatgaggatgctgctggagagcaaccaagagaggaggctgctggaactattgctctttcttctacttctactactact

SEQ ID NO: 81 - DNA, 27 bp, Artificial Sequence
  Description of Artificial Sequence Synthetic primer
cacgggggactctagaggatccccggg

SEQ ID NO: 82 - DNA, 21 bp, Artificial Sequence
  Description of Artificial Sequence Synthetic primer
gggaaattcgagctcttatta

SEQ ID NO: 83 - DNA, 28 bp, Artificial Sequence
  Description of Combined DNA/RNA Molecule Synthetic primer
atatgatgttggagtttctggaggagtu

SEQ ID NO: 84 - DNA, 28 bp, Artificial Sequence
  Description of Combined DNA/RNA Molecule Synthetic primer
aactcctccagaaactccaatatcatau

SEQ ID NO: 85 - DNA, 12 bp, Artificial Sequence
  Description of Combined DNA/RNA Molecule Synthetic primer
agaccacaactu

SEQ ID NO: 86 - DNA, 12 bp, Artificial Sequence
  Description of Combined DNA/RNA Molecule Synthetic primer
aagttgtggtcu

SEQ ID NO: 87 - protein, 11 aa, Artificial Sequence
  Description of Artificial Sequence Synthetic peptide
QAVPLLSEIAP

SEQ ID NO: 88 - protein, 11 aa, Artificial Sequence
  Description of Artificial Sequence Synthetic peptide
QAVPLYSEMAP

SEQ ID NO: 89 - DNA, 33 bp, Artificial Sequence
  Description of Artificial Sequence Synthetic consensus oligonucleotide
caagctgttccacttctttctgagattgctcca

SEQ ID NO: 90 - DNA, 33 bp, Artificial Sequence
  Description of Artificial Sequence Synthetic consensus oligonucleotide
caagctgttccactttactctgagatggctcca

SEQ ID NO: 91 - DNA, 32 bp, Artificial Sequence
  Description of Combined DNA/RNA Molecule Synthetic primer
aagctgttccacttctttctgagattgcucca

SEQ ID NO: 92 - DNA, 30 bp, Artificial Sequence
  Description of Combined DNA/RNA Molecule Synthetic primer
agccatctcagagtaaagtggaacagctug

SEQ ID NO: 93 - DNA, 15 bp, Artificial Sequence
  Description of Artificial Sequence Synthetic consensus oligonucleotide
agttggggaccactt

SEQ ID NO: 94 - DNA, 15 bp, Artificial Sequence
  Description of Combined DNA/RNA Molecule Synthetic primer
agttggggaccactu

SEQ ID NO: 95 - DNA, 15 bp, Artificial Sequence
  Description of Combined DNA/RNA Molecule Synthetic primer
aagtggtccccaacu

SEQ ID NO: 96 - DNA, 19 bp, Artificial Sequence
  Description of Combined DNA/RNA Molecule Synthetic primer
acttgagactagatctgcu

SEQ ID NO: 97 - DNA, 19 bp, Artificial Sequence
  Description of Combined DNA/RNA Molecule Synthetic primer
agcagatctagtctcaagu

SEQ ID NO: 98 - DNA, 15 bp, Artificial Sequence
  Description of Artificial Sequence Synthetic consensus oligonucleotide
tacttccagagacta

SEQ ID NO: 99 - DNA, 14 bp, Artificial Sequence
  Description of Combined DNA/RNA Molecule Synthetic primer
acttccagagacua

SEQ ID NO: 100 - DNA, 14 bp, Artificial Sequence
  Description of Combined DNA/RNA Molecule Synthetic primer
agtctctggaagua

SEQ ID NO: 101 - protein, 757 aa, Homo sapiens
MAGLTAAAPRPGVLLLLLSILHPSRPGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPSVGGVPGVGGVPGVGISPEAQAAAAAKAAKYGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 102 - protein, 697 aa, Equus caballus
MAGLTATALRPGVLLLLLSIVHPSQPGGVPGAVPGGVPGGVFFPGAGLGGLGVGALGPGGKPAKAGVGGLAGVAPGAGLGAFPAGAFPGALVPGGVAGAAAAYKAAKAGAGLGGVAGVSGVGGLGVSAGAVVPQPGAGVGVGAGAVGKPGKVPGVGLPGVYPGGVLPGARFPGVGVLPGVPTGAGVKPKVPGMRWLGWGVHGVGPFGVQQPGVPLGYPIKAPKLPGGYGLPYSTGKLPFGYGPGGVAGAAGKAGYPTGTGVGPAAAAAAAKAAKFGAAGAGVLPGVGVGGAGIPGVPGAIPGIGGIAGVGAPAAAAKAAAKAAKYGAAGVGVPGVGVPGVGVPGVGVPGVGVPGVGVPGVGVPGVGVPGVGVPGVGVPGAVSPAAAAKAAAKAAKFGARAGVGVGGIPTFGVPGYGVGVGAGVPGAAISPEAQAAAAAKAAKFGVVTPAAAAAAKAAAKAAQFAPLTLTGLAPGVGVAPGVVPGIGLGPGGVAGVGVPAAAKTPAQAAAKAQFWAGAGLPAGVPGLGVGAAVPGLGVGVGVPGLGAGAGVPFSLVPGPLAAAKAAKYAPAGVGALGDAGALAGVGVPGGLAGAGPAAAKAAAKAAQFGLGGAAGLGVPDLGVAGLGAGVVPGVAGLGGVSPAAAAKAAKYGAAGLGGVLGVTRPFPGAGVAARPGFGLSPIFPGGACLGKACGRKRK

SEQ ID NO: 103 - protein, 747 aa, Bos taurus
MRSLTAAARRPEVLLLLLCILQPSQPGGVPGAVPGGVPGGVFFPGAGLGGLGVGGLGPGVKPAKPGVGGLVGPGLGAEGSALPGAFPGGFFGAGGGAAGAAAAYKAAAKAGAAGLGVGGIGGVGGLGVSTGAVVPQLGAGVGAGVKPGKVPGVGLPGVYPGGVLPGAGARFPGIGVLPGVPTGAGVKPKAQVGAGAFAGIPGVGPFGGQQPGLPLGYPIKAPKLPAGYGLPYKTGKLPYGFGPGGVAGSAGKAGYPTGTGVGPQAAAAAAKAAAKLGAGGAGVLPGVGVGGPGIPGAPGAIPGIGGIAGVGAPDAAAAAAAAAKAAKFGAAGGLPGVGVPGVGVPGVGVPGVGVPGVGVPGVGVPGVGVPGVGVPGVGVPGVGVPGVGVPGALSPAATAKAAAKAAKFGARGAVGIGGIPTFGLGPGGFPGIGDAAAAPAAAAAKAAKIGAGGVGALGGVVPGAPGAIPGLPGVGGVPGVGIPAAAAAKAAAKAAQFGLGPGVGVAPGVGVVPGVGVVPGVGVAPGIGLGPGGVIGAGVPAAAKSAAKAAAKAQFRAAAGLPAGVPGLGVGAGVPGLGVGAGVPGLGVGAGVPGPGAVPGTLAAAKAAKFGPGGVGALGGVGDLGGAGIPGGVAGVVPAAAAAAKAAAKAAQFGLGGVGGLGVGGLGAVPGAVGLGGVSPAAAAKAAKFGAAGLGGVLGAGQPFPIGGGAGGLGVGGKPPKPFGGALGALGFPGGACLGKSCGRKRK

SEQ ID NO: 104 - protein, 860 aa, Mus musculus
MAGLTAVVPQPGVLLILLLNLLHPAQPGGVPGAVPGGLPGGVPGGVYYPGAGIGGLGGGGGALGPGGKPPKPGAGLLGTFGAGPGGLGGAGPGAGLGAFPAGTFPGAGALVPGGAAGAAAAYKAAAKAGAGLGGVGGVPGGVGVGGVPGGVGVGGVPGGVGVGGVPGGVGGIGGIGGLGVSTGAVVPQVGAGIGAGGKPGKVPGVGLPGVYPGGVLPGTGARFPGVGVLPGVPTGTGVKAKAPGGGGAFAGIPGVGPFGGQQPGVPLGYPIKAPKLPGGYGLPYTNGKLPYGVAGAGGKAGYPTGTGVGSQAAAAAAKAAKYGAGGAGVLPGVGGGGIPGGAGAIPGIGGIAGAGTPAAAAAAKAAAKAAKYGAAGGLVPGGPGVRLPGAGIPGVGGIPGVGGIPGVGGPGIGGPGIVGGPGAVSPAAAAKAAAKAAKYGARGGVGIPTYGVGAGGFPGYGVGAGAGLGGASPAAAAAAAKAAKYGAGGAGALGGLVPGAVPGALPGAVPAVPGAGGVPGAGTPAAAAAAAAAKAAAKAGLGPGVGGVPGGVGVGGIPGGVGVGGVPGGVGPGGVTGIGAGPGGLGGAGSPAAAKSAAKAAAKAQYRAAAGLGAGVPGFGAGAGVPGFGAGAGVPGFGAGAGVPGFGAGAGVPGFGAGAVPGSLAASKAAKYGAAGGLGGPGGLGGPGGLGGPGGLGGAGVPGRVAGAAPPAAAAAAAKAAAKAAQYGLGGAGGLGAGGLGAGGLGAGGLGAGGLGAGGLGAGGLGAGGLGAGGGVSPAAAAKAAKYGAAGLGGVLGARPFPGGGVAARPGFGLSPIYPGGGAGGLGVGGKPPKPYGGALGALGYQGGGCFGKSCGRKRK

SEQ ID NO: 105 - protein, 875 aa, Rattus norvegicus
MAGLTAAVPQPGVLLILLLNLLHPAQPGGVPGAVPGGVPGGLPGGVPGGVYYPGAGIGGGLGGGALGPGGKPPKPGAGLLGAFGAGPGGLGGAGPGAGLSYASRPGGVLVPGGGAGAAAAYKAAAKAGAGLGGIGGVPGGVGVGGVPGAVGVGGVPGAVGGIGGIGGLGVSTGAVVPQLGAGVGAGGKPGKVPGVGLPGVYPGGVLPGTGARFPGVGVLPGVPTGTGVKAKVPGGGGGAFSGIPGVGPFGGQQPGVPLGYPIKAPKLPGGYGLPYTNGKLPYGVAGAGGKAGYPTGTGVGSQAAVAAAKAAKYGAGGGGVLPGVGGGGIPGGAGAIPGIGGITGAGTPAAAAAAKAAAKAAKYGAAGGLVPGGPGVRVPGAGIPGVGIPGVGGIPGVGGIPGVGGIPGVGGPGIGGPGIVGGPGAVSPAAAAKAAAKAAKYGARGGVGIPTYGVGAGGFPGYGVGAGAGLGGASQAAAAAAAAKAAKYGAGGAGTLGGLVPGAVPGALPGAVPGALPGAVPGALPGAVPGVPGTGGVPGAGTPAAAAAAAAAKAAAKAGQYGLGPGVGGVPGGVGVGGLPGGVGPGGVTGIGTGPGTGLVPGDLGGAGTPAAAKSAAKAAAKAQYRAAAGLGAGVPGLGVGAGVPGFGAGAGGFGAGAGVPGFGAGAVPGSLAASKAAKYGAAGGLGGPGGLGGPGGLGGPGGLGGPGGLGGPGGLGGVPGGVAGGAPAAAAAAKAAAKAAQYGLGGAGGLGAGGLGAGGLGAGGLGAGGLGAGGLGAGGVIPGAVGLGGVSPAAAAKAAKYGAAGLGGVLGARPFPGGGVAARPGFGLSPIYPGGGAGGLGVGGKPPKPYGGALGALGYQGGGCFGKSCGRKRK

SEQ ID NO: 106 - protein, 7 aa, Artificial Sequence
  Description of Artificial Sequence Synthetic consensus peptide
PGGVPGA

SEQ ID NO: 107 - protein, 20 aa, Artificial Sequence
  Description of Artificial Sequence Synthetic consensus peptide
KPGKVPGVGLPGVYPGGVLP

SEQ ID NO: 108 - protein, 12 aa, Artificial Sequence
  Description of Artificial Sequence Synthetic consensus peptide
GKAGYPTGTGVG

SEQ ID NO: 109 - protein, 9 aa, Artificial Sequence
  Description of Artificial Sequence Synthetic consensus peptide
AKAAAKAAK

SEQ ID NO: 110 - protein, 5 aa, Artificial Sequence
  Description of Artificial Sequence Synthetic consensus peptide
GAGVP

SEQ ID NO: 111 - protein, 11 aa, Artificial Sequence
  Description of Artificial Sequence Synthetic consensus peptide
AAAKAAAKAAQ

SEQ ID NO: 112 - protein, 259 aa, Bacillus thuringiensis
MYTKNFSNSRMEVKGNNGCSAPIIRKPFKHIVLTVPSSDLDNFNTVFYVQPQYINQALHLANAFQGAIDPLNLNFNFEKALQIANGIPNSAIVKTLNQSVIQQTVEISVMVEQLKKIIQEVLGLVINSTSFWNSVEATIKGTFTNLDTQIDEAWIFWHSLSAHNTSYYYNILFSIQNEDTGAVMAVLPLAFEVSVDVEKQKVLFFTIKDSARYEVKMKALTLVQALHSSDAPIVDIFNVNNYNLYHSNHKIIQNLNLSN

SEQ ID NO: 113 - protein, 263 aa, Bacillus thuringiensis
MYTKNLNSLEINEDYQYSRPIIKKPFRHITLTVPSSDIASFNEIFYLEPQYVAQALRLTNTFQAAIDPLTLNFDFEKALQIANGLPNAGITGTLNQSVIQQTIEISVMISQIKEIIRNVLGLVINSTNFWNSVLAAITNTFTNLEPQVDENWIVWRNLSATHTSYYYKILFSIQNEDTGAFMAVLPIAFEITVDVQKQQLLFITIRDSARYEVKMKALTVVQLLDSYNAPIIDVFNVHNYGLYQSNHPNHHILQNLNLNKIKG

SEQ ID NO: 114 - protein, 263 aa, Bacillus thuringiensis
MHLNNLNNFNNLENNGEYHCSGPIIKKPFRHIALTVPSSDITNFNEIFYVEPQYIAQAIRLTNTFQGAIDPLTLNFNFEKALQIANGLPNAGVTGTINQSVIHQTIEVSVMISQIKEIIRSVLGLVINSANFWNSVVSAITNTFTNLEPQVDENWIVWRNLSATQTSYFYKILFSIQNEDTGRFMAILPIAFEITVDVQKQQLLFITIKDSARYEVKMKALTVVQALDSYNAPIIDVFNVRNYSLHRPNHNILQNLNVNPIKS

SEQ ID NO: 115 - protein, 260 aa, Bacillus thuringiensis
MYINNFDFPEKNNDYQCSGPIIKKPFRHIALTVPSSDITNFNEIFYVEPQYIAQALRLTNTFQGAIDPLTLNFNFEKALQIANGLPNAGVTGTLNQSVIHQTIEISVMISQIKEIIRSVLGLVINSANFWNNVVSAITNTFTNLEPQVDENWIVWRNLSANQTSYYYKILFSIQNEDTGRFMAVLPIAFEINVDVHKQQLLFITIKDSARYEVKMKALTVVQALDSYNAPIIDVFNIHNYSLHRPNYHILQNLNVNPIKS

SEQ ID NO: 116 - protein, 231 aa, Bacillus thuringiensis
MFFNRVITLTVPSSDVVNYSEIYQVAPQYVNQALTLAKYFQGAIDGSTLRFDFEKALQIANDIPQAAVVNTLNQTVQQGTVQVSVMIDKIVDIMKNVLSIVIDNKKFWDQVTAAITNTFTNLNSQESERWIFYYKEDAHKTSYYYNILFAIQDEETGGVMATLPIAFDISVDIEKEKVLFVTIKDTENYAVTVKAINVVQALQSSRDSKVVDAFKSPRHLPRKRHKICSNS

SEQ ID NO: 117 - protein, 7 aa, Artificial Sequence
  Description of Artificial Sequence Synthetic consensus peptide
LTVPSSD

SEQ ID NO: 118 - protein, 9 aa, Artificial Sequence
  Description of Artificial Sequence Synthetic consensus peptide
FEKALQIAN

SEQ ID NO: 119 - protein, 6 aa, Artificial Sequence
  Description of Artificial Sequence Synthetic consensus peptide
NTFTNL

SEQ ID NO: 120 - protein, 6 aa, Artificial Sequence
  Description of Artificial Sequence Synthetic consensus peptide
ILFSIQ

SEQ ID NO: 121 - protein, 7 aa, Artificial Sequence
  Description of Artificial Sequence Synthetic consensus peptide
KALTVVQ

SEQ ID NO: 122 - protein, 296 aa, Triticum aestivum
MKTFLILALLAIVATTATTAVRVPVPQPQPQNPSQPQPQRQVPLVQQQQFPGQQQQFPPQQPYPQPQPFPSQQPYLQLQPFPQPQPFPPQLPYPQPPPFSPQQPYPQPQPQYPQPQQPISQQQAQQQQQQQQQQQQQQQQQQILPQILQQQLIPCRDVVLQQHNIAHARSQVLQQSTYQPLQQLCCQQLWQIPEQSRCQAIHNVVHAIILHQQQQQQQPSSQVSLQQPQQQYPSGQGFFQPSQQNPQAQGSVQPQQLPQFEEIRNLALQTLPRMCNVYIPPYCSTTTAPFGIFGTN

SEQ ID NO: 123 - protein, 298 aa, Artificial Sequence
  Description of Artificial Sequence Synthetic Thinopyrum ponticum x Triticum aestivum
MKTFLVFALLAVVATSAIAQMETSCIPGLERPWQQQPLQQKETFPQQPPSSQQQQPFPQQPPFLQQQPSFSQQPLFSQKQQPVLPQQPAFSQQQQTVLPQQPAFSQQQHQQLLQQQIPIVHPSILQQLNPCKVFLQQQCSPAAMPQHLARSQMWQQSSCNVMQQQCCQQLPRIPEQSRYEAIRAIIFSIILQEQQQGFVQPQQQQPQQSVQGVYQPQQQSQQQLGQCSFQQPQQQLGQQPQQQQVQKGTFLQPHQIARLEVMTSIALRTLPTMCSVNVPLYSSITSAPLGVGSRVGAY

SEQ ID NO: 124 - protein, 289 aa, Dasypyrum breviaristatum
MKTFLILSLLAIVATTATTAARVPVPQLQPQIPFQQQPQEQVPLMQQQEFPGQQQPIPPQQPYPQPQSFPSQQPYPQPQPFPPQQLFPQPQPFLPQLPYPQPQPFPPQQSYPQPQQQYPQQRQPILQQQEQQILQQLLQQRLNPCRDVVLQQHNIAHGNSQVLQQSSYQVLQQLCCQQLWQIPKQSRCQAVHSVVHAIILHQQQQQQQQQQLLSQGSFQQPQQQYPSGQGSFQPSQQNPQGQSFVQPQQLPQFEEIRRLALQTLPTMCNVYVPTYCSTTIVPFGSISIN

SEQ ID NO: 125 - protein, 5 aa, Artificial Sequence
  Description of Artificial Sequence Synthetic consensus peptide
QPYPQ

SEQ ID NO: 126 - protein, 7 aa, Artificial Sequence
  Description of Artificial Sequence Synthetic consensus peptide
QQLCCQQ

SEQ ID NO: 127 - protein, 8 aa, Artificial Sequence
  Description of Artificial Sequence Synthetic consensus peptide
IILHQQQQ

SEQ ID NO: 128 - protein, 5 aa, Artificial Sequence
  Description of Artificial Sequence Synthetic consensus peptide
QPQQQ

SEQ ID NO: 129 - protein, 6 aa, Artificial Sequence
  Description of Artificial Sequence Synthetic consensus peptide
ALQTLP

SEQ ID NO: 130 - protein, 217 aa, Homo sapiens
MATGSRTSLLLAFGLLCLPWLQEGSAFPTIPLSRLFDNAMLRAHRLHQLAFDTYQEFEEAYIPKEQKYSFLQNPQTSLCFSESIPTPSNREETQQKSNLELLRISLLLIQSWLEPVQFLRSVFANSLVYGASDSNVYDLLKDLEEGIQTLMGRLEDGSPRTGQIFKQTYSKFDTNSHNDDALLKNYGLLYCFRKDMDKVETFLRIVQCRSVEGSCGF

SEQ ID NO: 131 - protein, 216 aa, Pithecia pithecia
MAAVSRASLLLTFTLLCLPWLREAGAFPAIPLTSLYDYAMIRAYRLNQLAFDIYQKFEEARSLKERMDFFRHKARNSLCFSGSIPTPTNRKETLQKSNLELLRSSLLLIQMWLKPVEFLSSESANSQLHSVSNSFIYEYLKDLDEVIRTLMGRLEGGSTRTEEIRQTYSRFDTSLHNDEALLKNYGLLFCFRRDMDKVATFLRIVKCRSAEANCGF

SEQ ID NO: 132 - protein, 167 aa, Rattus norvegicus
MAADSQTPWLLTFSLLCLLWPQEAGAFPAMPLSSLFANAVLRAQQRTDMELLRFSLLLIQSWLGPVQFLSRIFTNSLMFGTSDRVYEKLKDLEEGIQALMQELEDGSPRIGQILKQTYDKFDANMRSDDALLKNYGLLSCFKKDLHKAETYLRVMKCRRFAESSCAF

SEQ ID NO: 133 - protein, 150 aa, Atractosteus spatula
AQHLHQLAADIYKDFERTYVPEEQRQSSKSSPSAICYSESIPAPTGKDEAQQRSDVELLRFSLALIQSWISPLQTLSRVFSNSLVFGTSDRIFEKLQDLERGIVTLTREIDEGSPRIAAFLTLTYEKFDTNLRNDDVLMKNYGLLACFKK

SEQ ID NO: 134 - protein, 171 aa, Acipenser baerii
LHQLAADIYKGFERTYVPDEQRHSSKNSPSAFCYSETIPAPTGKDEAQQRSDVELLQFSLALIQSWISPLQSLSRVFTNSLVFSTSDRVFEKLKDLEEGIVALMRDLGEGGFGSSTLLKLTYDMFDVNLRNNDAVFKNYGLLSCFKKDMHKVETYLKVMKCRRFVESNCTL

SEQ ID NO: 135 - protein, 6 aa, Artificial Sequence
  Description of Artificial Sequence Synthetic consensus peptide
LLCLLW

SEQ ID NO: 136 - protein, 7 aa, Artificial Sequence
  Description of Artificial Sequence Synthetic consensus peptide
FERTYVP

SEQ ID NO: 137 - protein, 6 aa, Artificial Sequence
  Description of Artificial Sequence Synthetic consensus peptide
SLLLIQ

SEQ ID NO: 138 - protein, 6 aa, Artificial Sequence
  Description of Artificial Sequence Synthetic consensus peptide
SLALIQ

SEQ ID NO: 139 - protein, 6 aa, Artificial Sequence
  Description of Artificial Sequence Synthetic consensus peptide
LKDLEE

SEQ ID NO: 140 - protein, 6 aa, Artificial Sequence
  Description of Artificial Sequence Synthetic consensus peptide
TYSKFD

SEQ ID NO: 141 - protein, 6 aa, Artificial Sequence
  Description of Artificial Sequence Synthetic consensus peptide
KNYGLL

(19) United States
(12) Patent Application Publication
(10) Pub. No.: US 2010/0069264 A1
(43) Pub. Date: Mar. 18, 2010

(54) Libraries of recombinant chimeric proteins

(76) Inventors: Gil Sharon, Mevaseret Zion (IL); Abraham Laban, Jerusalem (IL)

Correspondence Address: Rashida A. Karmali, 10th Floor, 99 Wall Street, New York, NY, 10005, US

(21) Appl. No.: 12/590,266

(22) Filed: Nov. 5, 2009

Related U.S. Application Data
(63) Continuation-in-part of application No. 10/926,542, filed on Aug. 26, 2004.
(60) Provisional application No. 60/497,924, filed on Aug. 27, 2003.

(51) Int. Cl. C40B 50/06

(52) U.S. Cl. 506/26

(57) ABSTRACT

The provides methods for generating divergent libraries of recombinant chimeric proteins, comprising identifying a plurality of conserved amino acid sequences, selecting a plurality of consensus amino acid sequences as a backbone corresponding to said conserved amino acid sequences to serve as sites of recombination and as a backbone for recombinant chimeric proteins created, generating overlapping polynucleotides, inducing recombination between said polynucleotides to produce divergent libraries of chimeric polynucleotides wherein the recombinations intentionally take place between the sequences that correspond to the full length consensus amino acids. The advantage is that shuffling between variable regions, while maintaining the consensus backbone, increases the production of active proteins with high diversity, and better properties.

### CROSS REFERENCE TO OTHER APPLICATIONS

This is a continuation-in-part of U.S. application Ser. No. 10/926,542 entitled “Libraries of Recombinant Chimeric Proteins”, filed Aug. 26, 2004, which was a continuation-in-part of U.S. Application Ser. No. 60/497,924 entitled “Libraries of Recombinant Chimeric Proteins”, filed Aug. 27, 2003, both of which are incorporated herein by reference in their entirety.

### FIELD OF THE INVENTION

The present invention relates to methods for generating divergent libraries of recombinant chimeric proteins, said method comprising (a) identifying a plurality of conserved amino acid sequences in a plurality of related proteins; (b) selecting a plurality of consensus amino acid sequences of 3 to 30 amino acids in length as a backbone corresponding to said conserved amino acid sequences to serve as sites of recombination and as a backbone for recombinant chimeric proteins created and selecting a plurality of variable regions corresponding to non-conserved amino acid sequences in said plurality of related proteins; (c) generating a plurality of partially overlapping polynucleotides comprising a nucleic acid sequence encoding the consensus amino acid sequences of (b), wherein each polynucleotide comprises: (i) at least one terminal oligonucleotide sequence complementary to a terminal oligonucleotide sequence of at least one other polynucleotide, and wherein at least one terminal sequence at the terminus of each polynucleotide encodes an intact consensus amino acid sequence of (b); and (ii) a polynucleotide sequence encoding a variable, non-conserved amino acid sequence selected from any of the plurality of said related proteins of (b); (d) inducing recombination between the plurality of said partially overlapping polynucleotides of (c) to produce divergent libraries of chimeric polynucleotides wherein the recombinations intentionally take place between the sequences that correspond to the full length consensus amino acids; (e) transfecting a plurality of host cells with the chimeric polynucleotides of (d) to produce divergent libraries of cloned cell lines expressing one of the recombinant chimeric proteins; (f) and recovering recombinant chimeric proteins from the cloned cell lines of (e).

The present invention relates to a variety of libraries recombinant chimeric proteins, each protein derived by identifying a plurality of distinct conserved amino acid sequences in specific functional and/or structural proteins of interest, matching consensus amino acid sequences to said corresponding conserved amino acid sequences, synthesizing a plurality of partially overlapping polynucleotides corresponding to a structure or an amino acid sequence that are conserved in a plurality of functionally and/or structurally related proteins. The present invention further relates to methods for preparing the recombinant chimeric proteins and uses thereof that are less expensive, less work-intensive and more efficient than procedures used in current available methods. The advantage of the present invention is that shuffling between variable regions that are not necessarily predetermined, while maintaining the consensus backbone, increases the production of active proteins while keeping high diversity, thereby, more favorable and important protein variants are generated.

### BACKGROUND OF THE INVENTION

For certain industrial and pharmacological needs, it is required to modify and further to improve the characteristics of native proteins. Improvement can be achieved by introducing single or multiple mutations into the genes encoding the desired proteins, in a process that is commonly termed ‘directed evolution’. This process involves repeated cycles of random mutagenesis following product selection until the desired result is achieved.

Single point mutations have relatively low improvement potential, and thus strategies for screening products carrying preferably multiple mutations, such as, error-prone polymerase chain reaction and cassette mutagenesis where the specific region to be optimized is replaced with a synthetically mutagenized oligonucleotide. The latter approach is preferred for the construction of protein libraries. Error-prone PCR uses low-fidelity polymerization conditions to introduce a considerable level of point mutations randomly over a long sequence. Some computer simulations have suggested that point mutagenesis alone may often be too gradual to allow the large-scale block changes that are required for continued and dramatic sequence evolution. In addition, repeated cycles of error-prone PCR can lead to an accumulation of neutral mutations with undesired results, such as affecting a protein's immunogenicity but not its binding affinity. Above all, a serious limitation of error-prone PCR is that the rate of negative mutations grows with the sensitivity of the mutated regions to random mutagenesis. This sensitivity is also referred as ‘information density’.

Information density is the information content per unit length of a sequence, wherein ‘information content’ or IC, is defined as the resistance of the active protein to the amino acid sequence variation. IC is calculated from the minimum number of invariable amino acids required to describe a family of functionally-related sequences. This parameter is used to classify the complexity of an active sequence of a biological macromolecule (e.g., polynucleotide or polypeptide). Thus, regions in proteins that are relatively sensitive to random mutagenesis are considered as having a high information density and are often found conserved throughout evolution.

In cassette mutagenesis, a sequence block in a single template is replaced by a sequence that was fully, or partially, randomized. Accordingly, the number of random sequences applied limits the maximum IC that may be obtained, further eliminating potential sequences from being included in the libraries. This procedure also requires sequencing of individual clones after each selection round, which is tedious and impractical for many rounds of mutagenesis. Error-prone PCR and cassette mutagenesis are therefore widely used for fine-tuning of comparatively low IC.

Evolution of most organisms occurs by natural selection and sexual reproduction, which ensures the mixing and combining of the genes in the offspring of the selected individuals. During meiosis, homologous chromosomes from the parents line up with one another and by crossing-over parts along their sequences, namely via recombination, are randomly swapping genetic material. In many events, since the introduced sequences had a proven utility prior to recombination, they maintain a substantial IC in the new environment.

DNA shuffling is a process directed at accelerating the improvement potential of directed evolution by generating extensive recombinations in vitro and in vivo between mutants possessing improved traits. The outlines of this process include: induction of random or cassette mutagenesis, selection, cleaving mutant genes of choice into segments by a variety of methods and inducing recombination between the various segments by a variety of methods.

U.S. Pat. No. 6,573,098 (“the '098 patent”) discloses compositions comprising a library of nucleic acids comprising a composition of a plurality of overlapping nucleic acids, which are segments of the same gene from different species, are capable of hybridizing to a portion of a selected target nucleic acid or set of related sequence target nucleic acids, comprise one or more region of non-complementarity with the selected target nucleic acid, are capable of priming nucleotide extension upon hybridization to the selected target nucleic acid, and wherein the selected target nucleic acid is one of the genes used to provide the plurality of overlapping nucleic acids. In a preferred embodiment of U.S. Pat. No. 6,573,098 the plurality of overlapping nucleic acids used for DNA shuffling comprise regions of at least 50 consecutive nucleotides which have at least 70 percent sequence identity, preferably at least 90 percent sequence identity. However, the '098 patent does not describe recombinations within regions of homology using pre-defined polynucleotides with consensus sequences.

U.S. Pat. No. 6,489,145 (“the '145 patent”) discloses a method for producing hybrid polynucleotides comprising: creating mutations in samples of nucleic acid sequences; optionally screening for desired characteristics within the mutagenized samples; and transforming a plurality of host cells with nucleic acid sequences having said desired characteristics, wherein said one or more nucleic acid sequences include at least a first polynucleotide that shares at least one region of partial sequence homology with a second polynucleotide in the host cell; wherein said partial sequence homology promotes reassortment processes which result in sequence reorganization; thereby producing said hybrid polynucleotides. This method is conducted in vivo, utilizing cellular processes to form the hybrid polynucleotides. However, the '145 patent does not describe recombinations within regions of homology using pre-defined polynucleotides with consensus sequences.

DNA family shuffling is a modified DNA shuffling process, which introduces evolutionary changes that are more significant than point mutations while maintaining sequence coherency. This process involves usage of a parental DNA as a template for the same gene from different organisms.

U.S. Pat. No. 6,479,652 (“the '652 patent”) discloses compositions and methods for family shuffling procedure. In these methods, sets of overlapping family gene shuffling oligonucleotides are hybridized and elongated, providing a population of recombined nucleic acids, which can be selected for a desired trait or property. Typically, the set of overlapping family shuffling gene oligonucleotides include a plurality of oligonucleotide member types derived from a plurality of homologous target nucleic acids. However, the '652 patent does not describe recombinations within regions of homology using pre-defined polynucleotides with consensus sequences.

In order to obtain meaningful products using DNA shuffling, particularly products that are different from the parental molecules, shuffling has to be performed between DNA molecules that share at least 70% homology. This limitation restricts the number of genes that may serve as templates as well as the range of diversity between the various templates and hence the resulting libraries posses a limited protein diversity and a limited range of improvement. Moreover, a comparison between DNA molecules of closely related genes from various organisms reveals that although at the amino acid level the peptides are quite similar, at the DNA level there is a very low sequence identity. Indeed, in evolution DNA tends to change much more rapidly than peptides by accumulation of silent and neutral mutations. Thus, the full potential of DNA shuffling as means to improve proteins can never be reached.

The significant contribution of template diversity to the diversity of the resulting library using DNA shuffling was demonstrated by Crameri et al. (Nature 391:288-291, 1998). Crameri et al. showed that using related genes from divergent natural sources as templates for DNA shuffling produces products with improved parameters that are 50 times better than the products obtained by the same method using templates from a single source that was manipulated in-vitro, since the range of diversity between the natural templates is in fact much wider than the range that may possibly be reached by the limited in vitro manipulation. U.S. Pat. No. 6,319,714, issued to Crameri et al, Nov. 20, 2001, also describes family shuffling methods for generating chimeric proteins comprising identifying conserved and variable regions in a plurality of related proteins, selecting domains that can be from about 30, 60, 90 nucleotides in length (i.e. 3-130 amino acids in length) which can be utilized as backbones and selecting variable regions, generating a plurality of partially overlapping oligos wherein the conserved regions overlap (i.e. comprising terminal sequences complementary to other oligos) and variable regions, inducing recombination to produce chimeric polynucleotides wherein a full-length polynucleotide is produced, transfecting cells to express chimeric proteins. Crameri et al teach 30% homology or non-homologous recombination; in vitro recombination; DNA sources of plasmids, DNA, prokaryotes, plants, virus, animals, etc.; vectors and plasmids; uracil glycosylase; ligase; and varius ratios including equimolar and nonequimolar. However, Crameri et al also describes recombinations within regions of diversity with crossover oligonucleotides containing overlapping sequences of divergent DNA families as the means of creating recombination between them. However, Crameri et al do not describe recombinations within regions of homology or pre-defined polynucleotides with consensus sequences. The utilization of crossover oligonucleotides in Crameri et al., is limiting because only two divergent DNA families can possibly be involved in such a recombination. Furthermore, most of the products of Crameri et al teachings are recombinants between very closely related parental genes. Only seldom may recombination between distantly related polynucleotides occur, and the frequencies of double or triple such recombinants are extremely low.

U.S. Pat. No. 6,605,430, issued to Affholter et al., 23 Apr. 1999, describes methods for generating chimeric proteins comprising identifying conserved and variable regions in a plurality of related proteins, selecting domains that can be about 50 or about 100 nucleotides in length, 5 bp, 10 bp, 100 bp, etc (i.e. 3-30 amino acids in length) which can be utilized as backbones and selecting variable regions, generating a plurality of partially overlapping oligos wherein the conserved regions overlap (i.e. comprising terminal sequences complementary to other oligos) and variable regions, inducing recombinations to produce chimeric polynucleotides wherein a full length polynucleotide is produced, transfecting cells to express chimeric proteins. The '430 patent describes gene-shuffling and methods by which monooxygenase genes are improved using crossover oligonucleotides. However, it does not describe recombinations within regions of homology using pre-defined polynucleotides with consensus sequences. Therefore, like Crameri et al., this method is limiting because only two divergent DNA families can possibly be involved in such a recombination. Furthermore, like Crameri et al., most of the products of Affholter et al., teachings are recombinants between very closely related parental genes. Only seldom may recombination between distantly related polynucleotides occur, and the frequencies of double or triple such recombinants are extremely low.

U.S. Pat. No. 6,117,679 issued to Stemmer et al on Sep. 12, 2000 describes a method of DNA reassembly after random fragmentation and its application to mutagenesis of nucleic acid sequences by in vitro and in vivo recombination. The DNA shuffling approaches known used depend on random recombination between randomly fragmented polynucleotides. As these processes rely on cross hybridization between contiguous nucleotides and since the hybridization depends on homology, fragmented polynucleotides derived from a given relatively long parental polynucleotide tend to hybridize to polynucleotide fragments that are highly complementary (homologous) rather than to hybridize with fragments that are not highly complementary. Thus, short regions of homology shared between the various fragmented polynucleotides do not generate new extension products and the final hybridization products are primarily similar or identical to the parental polynucleotide. However, Stemmer et al does not describe screening procedures that are less labor-intensive and more cost-effective than procedures currently in use or shuffling between variable regions while keeping the conserved regions unaffected.

U.S. Pat. No. 6,613,514 issued to Patten et al April 2000 also described DNA shuffling but does not teach recombinations intentionally take place between the sequences that correspond to the consensus amino acids.

U.S. Pat. No. 6,605,449 issued to Short et al Jun. 14, 2000, describes DNA shuffling but does not teach recombinations intentionally between the sequences that correspond to the consensus amino acids. Therefore, in both cases, the frequency of recombination corresponds to the similarity of the DNA sequences between the recombining sites. Consequently, as in the methods of Crameri et al. and Affholter et al., the higher the similarity between sites, the higher the likelihood of recombination. Furthermore, in these methods, recombination between distantly related proteins is very likely to cause breakage of inter-domain interactions that lead to non-functional products.

Therefore, there remain considerable problems encountered with DNA shuffling as are known in the art, including the requirement for homology between the DNA templates, bias of the DNA shuffled products towards the parental DNA template (particularly those shuffled from divergent templates), and restricted diversity of the DNA shuffled products and to provide a simple system which enables extensive recombination between peptides in regions of peptide structure or amino acid similarity without constrains of DNA homology. Furthermore, when shuffling between distantly related proteins, there is a need to protect inter domain interactions in order to maintain protein function. Unlike prior art recombination—the method of the present invention minimizes the breakage of internal interactions between various protein domains-increasing the affectivity of the library as a whole as well as each of its products.

There is an unmet need for a system that would enable the utilization of parental templates that cannot be used by current technologies, smaller but more divergent libraries will be produced, requiring fewer screening procedures, and the outcome would be products having greater improved qualities. The present application and co-pending application Ser. No. 10/926,542, describe recombinations within regions of homology using polynucleotides with pre-defined consensus sequences.

### SUMMARY OF THE INVENTION

The present invention relates to methods for generating divergent libraries of recombinant chimeric proteins, said method comprising (a) identifying a plurality of conserved amino acid sequences in a plurality of related proteins; (b) selecting a plurality of consensus amino acid sequences of 3 to 30 amino acids in length as a backbone corresponding to said conserved amino acid sequences to serve as sites of recombination and as a backbone for recombinant chimeric proteins created and selecting a plurality of variable regions corresponding to non-conserved amino acid sequences in said plurality of related proteins; (c) generating a plurality of partially overlapping polynucleotides comprising a nucleic acid sequence encoding the consensus amino acid sequences of (b), wherein each polynucleotide comprises: (i) at least one terminal oligonucleotide sequence complementary to a terminal oligonucleotide sequence of at least one other polynucleotide, and wherein at least one terminal sequence at the terminus of each polynucleotide encodes an intact consensus amino acid sequence of (b); and (ii) a polynucleotide sequence encoding a variable, non-conserved amino acid sequence selected from any of the plurality of said related proteins of (b); (d) inducing recombination between the plurality of said partially overlapping polynucleotides of (c) to produce divergent libraries of chimeric polynucleotides wherein the recombinations intentionally take place between the sequences that correspond to the full length consensus amino acids; (e) transfecting a plurality of host cells with the chimeric polynucleotides of (d) to produce divergent libraries of cloned cell lines expressing one of the recombinant chimeric proteins; (f) and recovering recombinant chimeric proteins from the cloned cell lines of (e).

It is an object of the present invention to provide recombinant chimeric proteins comprising a plurality of consensus amino acid regions corresponding to amino acid sequences or structures that are conserved in a plurality of related proteins. The recombinant chimeric proteins further comprise a plurality of variable regions corresponding to various amino acid sequences that are not necessarily conserved in said related proteins. The present invention further relates to methods for preparing the recombinant chimeric proteins and uses thereof that are less expensive, less work-intensive and more efficient than procedures used in current available methods. The advantage of the present invention is that shuffling between variable regions while maintaining the consensus backbone, increases the production of active proteins while keeping high diversity, thereby, more favorable and important protein variants are generated. The related proteins may be derived from different organisms or from the same organism. The recombinant chimeric proteins may possess desired or advantageous characteristics such as lack of an unwanted activity and/or maintenance and even improvement of a desired property over the same property in the parental protein. The recombinant chimeric proteins can be selected by a suitable selection or screening method, wherein high throughput assays for detecting a new product is not essential, since typically the resulting recombinant chimeric proteins that show the desired activity or other required traits are significantly different from their parental templates derived from the related protein.

It is another object of the present invention to provide methods for generating designed libraries of recombinant chimeric proteins. In order to achieve the desired library the methods of the present invention comprise selection of a plurality of consensus regions which are conserved in a plurality of related proteins derived from different organisms and/or different proteins of the same organism. The methods further involve generation of a plurality of polynucleotides comprising, at their 5′ and 3′-termini, uniform oligonucleotides capable of encoding the consensus regions and further comprising nucleotides capable of encoding variable regions corresponding to various amino acid sequences, which are not necessarily conserved in the related proteins. The methods further involve intentional recombination between the various uniform regions of the plurality of polynucleotides in order to form a plurality of chimeric polynucleotides. The present invention further relates to methods for preparing the recombinant chimeric proteins and uses thereof that are less expensive, less work-intensive and more efficient than procedures used in current available methods. The advantage of the present invention is that shuffling between variable regions that are not necessarily predetermined, while maintaining the consensus backbone, increases the production of active proteins while keeping high diversity, thereby, more favorable and important protein variants are generated.

It is yet another object of the present invention to provide methods of using the recombinant chimeric proteins of the invention comprising formation of libraries of recombinant chimeric proteins or of chimeric polynucleotides, assays for screening libraries of recombinant chimeric proteins for various uses including searching for proteins with improved or preferred functionality, searching for ligands and receptors, among other uses and applications.

The methods of the present invention confer several significant advantages over methods known in the art for forming recombinant chimeric proteins or chimeric polynucleotides and for libraries thereof. One major advantage of the methods of the present invention is that it is explicitly not necessary to have any level of sequence homology other than that of the consensus region, between the polynucleotides used for recombination. Thus, the methods of the present invention are not limited by any natural homology barrier. The present invention enables utilization of screening procedures that are less work-intensive and less expensive to carry out than currently used methods. Due to constraints posed by homology in current methods, the parental proteins have to be very similar to each other. As a result, although active chimeras are generated, these are not significantly different from their parents. Furthermore, screening for the chimeras produced by currently available methods usually require complex, quantitative high throughput assays. This problem is overcome in the present invention by the fact that shuffling is preferably performed between highly diverse parents and most of the products of such procedures are inactive, therefore, allowing easy quantitative screening or selection between inactive and active products even in high throughput systems to generate a second library of active products.

Use of the methods of the present invention is further advantageous as it results in the production of libraries with enhanced product diversity. This advantage is maintained even when the polynucleotides used for recombination confer a low sequence homology. The diverse nature of the active products of the present invention, thus leads to their properties also being diverse, thus making this library superior or better in terms of the potential to find a superior performing protein among its products. Therefore, a second, low-throughput but one that is highly specific screening for desired properties may be carried out in the present invention.

Furthermore, the libraries produced in accordance with the present invention do not exhibit a bias towards any product, and particularly are non-biased towards the parental related proteins. This is a significant advantage with respect to common methods of DNA shuffling. Using common methods of DNA shuffling as known in the art, with templates having significant non-homology between them, results mostly in parental-like polynucleotides since short polynucleotides that originate from the same parental template have a higher tendency to hybridize to each other, re-forming longer parental-like polynucleotides. Moreover, this tendency to produce parental-like products increases as the divergence between the starting polynucleotides increases. Since the resulting libraries contain mostly “noise”, i.e. parental-like products, screening of the products is complicated, as it requires distinguishing between many products that are very similar to the parental templates. Thus, using the methods of the present invention it is possible to generate libraries of high divergence with a non-significant bias towards products that are similar to a parental template. Using the methods of the present invention it is further possible to dictate the prevalence of a given recombination product, or a given set of recombination products, by manipulating the molar ratio between the starting polynucleotides.

Unlike prior art, use of the methods of the present invention protects certain regions—namely the conserved regions, within the protein products that are created. This is advantageous foe the following regions:

(i). These are the regions that are crucial for maintaining the protein function, the “protein backbone sort of speak”. As long as they are kept unharmed the protein may have a fair chance of staying functional even if some non-conserved regions are exchanged between the parental molecules.

(ii). Regions that interact with each other within the protein are less likely to change during evolution because a change in one such region would require a counter change in its counterpart, something that is very unlikely to happen simultaneously. Thus, the experimenter should avoid making exchanges in conserved regions in order not to disrupt internal protein interactions and to maintain protein function.

(iii). In cases where the 3D structure of the parental proteins had not been determined, the conserved regions serve as the only “anchors” that may suggest where exchanges may be made between parentals without making shift errors that would “kill” protein function.

There is an intrinsic contradiction between the need to keep the conserved regions untouched (see (i) and (ii) above) and performing the recombination within those regions (see (iii) above). The method of the current invention circumvents this paradox by changing the conserved regions of all the shuffled proteins into unchanged “consensus” sequences: Either by deciding that the conserved regions of one of the parental proteins would be kept unchanged and converting those of the other parental proteins to match it, or—if there is data that suggests that another amino-acid sequence would be beneficial—by changing the DNA of the consensus regions accordingly.

The conversion of a region that is conserved in all the parental proteins into one consensus sequence at the DNA level and designing the fragments in such a way that these sequences are the ones that are overlapping at the ends of these fragments, ensures that all the “first” fragments of the shuffled genes are given equal opportunity to recombine with all the “second” fragments of the shuffled genes, all the “second” fragments of the shuffled genes are given equal opportunity to recombine with all the “third” fragments of the shuffled genes, and so on. Hence, if 8 genes are shuffled with each—fragmented to 8 fragments (7 consensus sequences utilized), only 8 out of more than 16,000,000 possible recombinants (8⁸) are expected to be parental types.

As mentioned earlier, only a fraction of recombinants are expected to be functional due to the distance between the parental protein and the fact that whole protein-segments are exchanged between them. This is a big advantage of the present invention over prior art. Rather than performing high throughput quantitative assays, one can greatly reduce the search by checking qualitatively which of the recombinants is functional. The ones that are, are greatly diverged from one another as well as from their parental proteins. The variance in their structure and sequence is likely to have an impact in terms of the variance in their properties, increasing the chances of finding among them ones with an improved function of choice.

In addition, the methods and compositions of the present invention enable to obtain chimeric proteins comprising regions that are grossly non-conserved in a family of related as well as moderately related proteins.

Unlike known DNA shuffling methods, the present invention relies on highly induced recombination between short, specific, predefined regions. This approach is less dependent on polynucleotide sequence homology, and hence enables combination of regions of low polynucleotide sequence homology into the chimeric proteins.

According to a first aspect, the present invention provides methods for generating the recombinant chimeric proteins of the invention. An essential element of the methods of the present invention is the identification and selection of defined conserved amino acid regions within a plurality of preselected related proteins.

The term “related proteins” as used herein, refers to a plurality of proteins that are functionally- or structurally-related or to fragments of such proteins. The term as used herein is intended to include proteinaceous complexes, polypeptides and peptides, naturally occurring or artificial, wherein the former may be derived from the same organism or from different organisms.

In one embodiment the present invention relates to methods for generating divergent libraries of recombinant chimeric proteins, said method comprising (a) identifying a plurality of conserved amino acid sequences in a plurality of related proteins; (b) selecting a plurality of consensus amino acid sequences of 3 to 30 amino acids in length as a backbone corresponding to said conserved amino acid sequences to serve as sites of recombination and as a backbone for recombinant chimeric proteins created and selecting a plurality of variable regions corresponding to non-conserved amino acid sequences in said plurality of related proteins; (c) generating a plurality of partially overlapping polynucleotides comprising a nucleic acid sequence encoding the consensus amino acid sequences of (b), wherein each polynucleotide comprises: (i) at least one terminal oligonucleotide sequence complementary to a terminal oligonucleotide sequence of at least one other polynucleotide, and wherein at least one terminal sequence at the terminus of each polynucleotide encodes an intact consensus amino acid sequence of (b); and (ii) a polynucleotide sequence encoding a variable, non-conserved amino acid sequence selected from any of the plurality of said related proteins of (b); (d) inducing recombination between the plurality of said partially overlapping polynucleotides of (c) to produce divergent libraries of chimeric polynucleotides wherein the recombinations intentionally take place between the sequences that correspond to the full length consensus amino acids; (e) transfecting a plurality of host cells with the chimeric polynucleotides of (d) to produce divergent libraries of cloned cell lines expressing one of the recombinant chimeric proteins; (f) and recovering recombinant chimeric proteins from the cloned cell lines of (e).

In another embodiment, the consensus amino acid region is homologous to a segment of 3 to 30 amino acids, preferably 4 to 20 amino acids, more preferably 5 to 10 amino acids, that is conserved in the plurality of related proteins or fragments thereof.

In yet another embodiment, at least one consensus amino acid region is identical to a segment of 3 to 30 amino acids, preferably 4 to 20 amino acids, more preferably 5 to 10 amino acids, derived from at least one of the related parental proteins or fragments thereof.

According to various embodiments, the variable polynucleotide sequences comprised within the plurality of polynucleotides generated by the methods of the present invention, may posses less than 70% sequence homology, less than 50% sequence homology, less than 30% sequence homology and even less than 10% sequence homology.

In yet another embodiment, the variable polynucleotide sequences comprised within the plurality of polynucleotides generated by the methods of the present invention are substantially devoid of sequence homology.

In yet another embodiment, the recombination step is achieved in any suitable recombination system selected from the group consisting of: in vitro homologous recombination, in vitro sequence shuffling via amplification, in vivo homologous recombination and in vivo site-specific recombination.

In a certain embodiment, recombination is achieved by a method for assembling a plurality of DNA fragments comprising (a) providing a plurality of double stranded DNA fragments having at least one terminal single stranded overhang capable of encoding a consensus amino acid sequence, wherein the overhang terminus of each DNA fragment is complementary to the overhang of at least one other DNA fragment; and (b) mixing the DNA fragments under suitable conditions, to obtain recombination. The principles of this method are disclosed in U.S. Pat. No. 6,372,429 assigned to one of the inventors of the present invention.

In yet another embodiment, assembly of the recombined polynucleotides is achieved by a method selected from the group consisting of: ligation independent cloning, PCR, primer extension such as commonly used in DNA shuffling

In a preferred embodiment, the naturally occurring and non-natural polynucleotides from which the polynucleotides participating in the recombination are derived, are typically not related, particularly not by any sequence homology.

In yet another embodiment, the method of the present invention further comprises polynucleotide amplification prior to recombination.

In yet another embodiment, the method of the present invention comprises recombination between plurality of polynucleotides in the presence of a plurality of vector fragments terminated at both ends with oligonucleotides that are complementary to any of the terminal sequences of any of said polynucleotides.

In yet another embodiment, the DNA is ligated into a vector prior to transforming the host cell.

In yet another embodiment, the method of the present invention is applied to develop a library of chemokine receptors with altered N-termini (and are thus activated by alternative chemokines), transmembrane domains (consequently being able to function in different cell types), as well as altered C-termini (which promotes a somewhat different chemotaxis-response.

In yet another embodiment, the method of the present invention is applied to develop a library of chimera of hexose transporters that control the transport of hexose sugars in tomatoes including hexose carrier proteins from a variety of different plant origins.

In yet another embodiment, the method of the present invention is applied to develop a library of elastin from human as well as other mammalian sources in order to construct a library of chimera elastin proteins having properties of flexibility, elasticity, penetration and anti-aging effects.

In yet another embodiment, the method of the present invention is applied to develop a library of a library of proteins having insecticidal properties including Cyt2Aa from B. thuringiensis subsp. israelensis as well as other Bacilli.

In yet another embodiment, the method of the present invention is applied to develop a library of a chimera of gliadin, a storage protein which together with glutinin from gluten from wheat, is implicated in celiac disease, in order to screen specific proteins that will not cause an immune response while retaining the role of gluten in giving bread its unique texture.

In yet another embodiment, the method of the present invention is applied to develop a library of chimera of growth hormone in order to screen for variants with increased healing effect in wounds.

According to a second aspect, the present invention provides compositions comprising a plurality of polynucleotides comprising overlapping termini such that each polynucleotide is capable of hybridizing with another polynucleotide and wherein the overlapping termini are capable of encoding consensus amino acid regions corresponding to conserved amino acid regions derived from related proteins.

In yet another embodiment, the present invention provides a composition comprising a plurality of distinct polynucleotides, wherein each polynucleotide comprises (i) overlapping termini, such that the terminus of each polynucleotide is complementary to a terminus of at least one other polynucleotide within the composition and (ii) a variable region encoding a variable amino acid region of a protein that is not necessarily conserved, preferably not conserved, in a plurality of related proteins; wherein at least one terminus of each polynucleotide is capable of encoding a consensus amino acid region corresponding to a conserved amino acid region derived from the plurality of related proteins.

In yet another embodiment, the related proteins are derived from different microorganisms or from different proteins in the same organism.

According to various embodiments, the variable regions of any two distinct polynucleotides of the composition of the present invention exhibit less than 70% sequence homology, less than 50% sequence homology, less than 30% sequence homology and even less than 10% sequence homology.

In yet another embodiment, the variable regions of any two distinct polynucleotides within the composition are substantially devoid of sequence homology.

In yet another embodiment, the overlapping termini of the polynucleotides are of 9 to 150 nucleotides, preferably 12 to 60 nucleotides, more preferably 15 to 30 nucleotides.

In yet another embodiment, the composition of the present invention further comprises a least one fragment of a vector having terminal sequences, wherein each terminal sequence is complementary to a terminus of at least one polynucleotide of the composition.

In yet another embodiment, the vector further comprises at least one component selected from the group consisting of: at least one restriction enzyme site, at least one selection marker gene, an element capable of regulating production of a detectable protein activity, at least one element necessary for propagation, maintenance and expression of vectors within cells. The vector is selected from the group consisting of: a plasmid, a cosmid, a YAC, a BAC, a virus.

In yet another embodiment, the composition of the present invention includes a library of chemokine receptors with altered N-termini (and are thus activated by alternative chemokines), transmembrane domains (consequently being able to function in different cell types), as well as altered C-termini (which promotes a somewhat different chemotaxis-response.

In yet another embodiment, the composition of the present invention includes a library of chimera of hexose transporters that control the transport of hexose sugars in tomatoes including hexose carrier proteins from a variety of different plant origins.

In yet another embodiment, the composition of the present invention includes a library of elastin from human as well as other mammalian sources in order to construct a library of chimera elastin proteins having properties of flexibility, elasticity, penetration and anti-aging effects.

In yet another embodiment, the composition of the present invention is includes a library of a library of proteins having insecticidal properties including Cyt2Aa from B. thuringiensis subsp. israelensis as well as other Bacilli.

In yet another embodiment, the composition of the present invention includes a library of a chimera of gliadin, a storage protein which together with glutinin from gluten from wheat, is implicated in celiac disease, in order to screen specific proteins that will not cause an immune response while retaining the role of gluten in giving bread its unique texture.

In yet another embodiment, the composition of the present invention includes a library of chimera of growth hormone in order to screen for variants with increased healing effect in wounds.

According to a third aspect, the present invention provides recombinant chimeric proteins comprising a plurality of consensus amino acid regions corresponding to amino acid sequences that are conserved in a plurality of related proteins. The recombinant chimeric proteins further comprise a plurality of variable regions corresponding to various amino acid sequences derived from the related proteins.

In yet another embodiment, the present invention provides a plurality of recombinant chimeric proteins, wherein each chimeric protein comprises a plurality of consensus amino acid sequence, wherein each consensus sequence is conserved in a plurality of related proteins and a plurality of variable amino acid regions derived from any one of the related proteins.

In another embodiment, the consensus amino acid region corresponds to a segment of 3 to 30 amino acids, preferably 4 to 20 amino acids, more preferably 5 to 10 amino acids, that is conserved in the plurality of related proteins or fragments thereof.

In yet another embodiment, at least one consensus amino acid region is identical to a segment of 3 to 30 amino acids, preferably 4 to 20 amino acids, more preferably 5 to 10 amino acids, derived from at least one of the related parental proteins or fragments thereof.

It is a fourth aspect of the present invention to provide methods of using the recombinant chimeric proteins of the invention comprising formation of libraries of chimeric proteins and libraries of chimeric genes, providing assays for screening libraries of recombinant chimeric proteins for various uses including searching for proteins with improved or preferred functionality, searching for vaccines, ligands and receptors, among other uses and applications. These and further embodiments will be apparent from the detailed description and examples that follow.

### BRIEF DESCRIPTION OF THE DRAWINGS

FIG. 1 shows five conserved amino acid regions (gray boxes), the consensus amino acid regions corresponding thereto and the consensus nucleic acid encoding thereof (below gray boxes), selected from a group of prokaryotic lipases by amino acid sequence alignment.

FIG. 2 represent an alignment of related amino acid sequence and identification of conserved regions (C.R.1 and C.R.2) of a similar structure and/or a similar amino acid sequence among non-conserved amino acid regions.

FIG. 3: is a scheme showing PCR amplification of a gene segments containing a “first” and a “second” PCR fragments sharing an overlap (1^{st} C.R; 2^{nd} C.R; 3^{rd} C.R. and last C.R.), with each other.

FIG. 4: is a scheme presenting exemplary combinatorial products (bottom) obtained from recombination between PCR fragments containing overlapping conserved regions (top)

FIG. 5: is a scheme describing a library of chimeric products (C) obtained from hybridization between overlapping regions of PCR fragments of related genes (A) by hybridization between the overlapping regions of the fragments following a single round of 5′ to 3′ extension of the single stranded strands (B).

FIG. 6: is a scheme describing protein alignment using ClustalW2. (*)—identity, (:)—high similarity AA, .(−) lower similarity. Consensus sequences, corresponding to these sequences were designed and are portrayed below the alignments.

FIG. 7(a)-(b): is a scheme describing ClustalW2 DNA Alignment of sequences optimized for K. lactis expression. The gray areas are the consensus sequences after the conserved sequences had been substituted by a uniform consensus. The sequences are designed such that at the beginning of each sequence there are uniform additional sequences containing XhoI and Kex sites. Likewise, at the end of each of the sequences are two tandem stop codons and NotI site. The XhoI and the NotI sites enable the cloning of the sequences into the K. lactic pKLAC1 expression vector (purchased from New England Biolabs). 7a—the sequence alignment of 1^{st} half of the genes. 7b—the sequence alignment of 2^{nd} half.

FIG. 8: is a scheme describing Protein Alignment using ClustalW2. (*)—identity, (:)—high similarity AA, .(−) lower similarity. Consensus sequences, corresponding to these sequences were designed and are portrayed below the alignments. Note: Two alternative consensus sequences—different in one and two amino acids (underlined)—are assigned to the 1^{St} & 3^{d} conserved regions respectively. One alternative corresponds to the tomato sequence and the other to that of grape vine. This is done in order to make sure that both backbones are presented in the resulting library.

FIG. 9(a)-(c): is a scheme describing is a scheme describing ClustalW2 DNA Alignment of sequences, optimized for expression in tomato. The gray areas are the consensus sequences after the conserved sequences had been substituted by a uniform consensus. The sequences are designed such that at the beginning of each sequence there are uniform additional sequences containing a XmaI site. Likewise, at the end of each of the sequences are two tandem stop codons and an SstI site. The XmaI and the SstI sites (white letters in black background) enable the cloning of the sequences into the pBI121 plant binary expression vector (see Clontech catalogue 1996-97). 9a—the sequence alignment of the upstream ⅓ of the genes. 9b—the sequence alignment of the middle ⅓ of the genes. 9c—the sequence alignment of the downstream ⅓ of the genes. Note: the gray areas are the consensus sequences before the conserved sequences had been substituted by a uniform consensus.

### DETAILED DESCRIPTION OF THE INVENTION

### Definitions

As used herein, “polynucleotide”, “oligonucleotide” and “nucleic acid” include reference to both double stranded and single stranded DNA or RNA. The terms also refer to synthetically or recombinantly derived sequences essentially free of non-nucleic acid contamination. A polynucleotide can be a gene sub-sequence or a full length gene (cDNA or genomic). Unless specifically limited, the term encompasses nucleic acids containing known analogues of natural nucleotides, which have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions) and complementary sequences, as well as the sequence explicitly indicated. Specifically, degenerate codon substitutions may be achieved by generating sequences in which the third position of one or more selected (or all) codons is substituted with mixed-base and/or deoxyinosine residues (Batzer et al., Nucleic Acid Res. 19:5081, 1991; Ohtsuka et al., J. Biol. Chem. 260:2605, 1985; Rossolini et al., Mol. Cell. Probes 8:91, 1994). The term nucleic acid is used interchangeably with gene, cDNA, and mRNA encoded by a gene.

The terms “polypeptide”, “peptide” and “protein” are used interchangeably herein to refer to a polymer of amino acid residues. The terms include naturally occurring amino acid polymers and amino acid polymers in which one or more amino acid residue is an artificial chemical analogue of a corresponding naturally occurring amino acid.

The term “naturally-occurring” as used herein as applied to an amino acid or a polynucleotide that can be found in nature. For example, a polypeptide or polynucleotide sequence that is present in an organism that can be isolated from a source in nature and which has not been intentionally modified by man in the laboratory is naturally-occurring. Generally, the term naturally-occurring refers to an object as present in a non-pathological (undiseased) individual, such as would be typical for the species.

The term “conserved amino acid region” as used herein, refers to any amino acid sequence that shows a significant degree of sequence or structure homology in a plurality of related proteins.

A “significant degree of homology” is typically inferred by sequence comparison between two sequences over a significant portion of each of the sequences. In reference to conserved amino acid regions, a significant degree of homology intends to include at least 70% sequence similarity between two contiguous conserved regions within two distinct related proteins. A significant degree of homology further refers to conservative modifications including: individual substitutions, individual deletions or additions to a peptide, polypeptide, or a protein sequence, of a single amino acid or a small percentage of amino acids. Conservative amino acid substitutions refer to the interchange of residues having similar side chains. For example, a group of amino acids having aliphatic side chains is glycine, alanine, valine, leucine, and isoleucine; a group of amino acids having aliphatic-hydroxyl side chains is serine and threonine; a group of amino acids having amide-containing side chains is asparagine and glutamine; a group of amino acids having aromatic side chains is phenylalanine, tyrosine, and tryptophan; a group of amino acids having basic side chains is lysine, arginine, and histidine; and a group of amino acids having sulfur-containing side chains is cysteine and methionine. Preferred conservative amino acids substitution groups are described by the following six groups each contain amino acids that are conservative substitutions for one another:

### 1) Alanine (A), Serine (S), Threonine (T);

2) Aspartic acid (D), Glutamic acid (E);

### 3) Asparagine (N), Glutamine (Q);

### 4) Arginine (R), Lysine (K);

### 5) Isoleucine (I), Leucine (L), Methionine (M), Valine (V); and

6) Phenylalanine (F), Tyrosine (Y), Tryptophan (W). (see, e.g., Creighton, Proteins, 1984).
The term “consensus amino acid” refers to a uniform amino acid sequence corresponding to a distinct set of conserved amino acid regions derived from a plurality of related proteins, wherein the uniform amino acid confers a significant degree of homology to each conserved amino acid region of the set of conserved amino acid regions. It should be noted, however, that in cases where the experimenter is not sure which consensus amino acid the experimenter should use in order to maximize the generation of advantageous products, he may assign more than one consensus amino acid sequence to a distinct set of conserved amino acid region. Such cases are illustrated in examples 2 and 6 of the present invention.

The term “uniform polynucleotide sequences” as used herein, refers to oligonucleotides, typically of 30-150 nucleotides, which are identical in a plurality of overlapping polynucleotides and are located at the termini of said overlapping polynucleotides. According to the present invention, there are two types of uniform polynucleotides, the first type is an oligonucleotide capable of encoding a consensus amino acid. The second type is an oligonucleotide which may encode any amino acid and not necessarily a conserved one. An example of the second type of uniform polynucleotide sequences would be the oligonucleotides at the termini of vector fragments and at the termini of the polynucleotides that are designed to recombine with the vector fragments.

The term “crossover oligonucleotide” as used herein, refers to an oligonucleotide that has at least two different members of a selected set of oligonucleotides and polynucleotides which are optionally homologous or non-homologous.

The term “distinct polynucleotide” as used herein, refers to a polynucleotide that has a uniform polynucleotide sequence at each of its ends, enabling its recombination with other distinct polynucleotides, and a variable region in-between. It should be noted that the variable region may comprise three types: 1) predetermined sequences, 2) sequences that are determined in some regions and undetermined in others-such as sequences produced by error-prone PCR, and 3) sequences that are undetermined or scrambled-such as those produced by degenerate oligonucleotide synthesis.

The term “related proteins” or “a family of related proteins” are interchangeably used to describe a plurality of proteins that are functionally- or structurally-similar, or fragments of such proteins. The term as used herein is intended to include proteinaceous complexes, polypeptides and peptides, naturally occurring or artificial, wherein the former may be derived from the same organism or from different organisms. Functionally related proteins include proteins sharing a similar activity or capable of producing the same desired effect. Functionally related proteins may be naturally occurring proteins or modified proteins (with amino acid substitutions, both conservative and non-conservative) that have the same, similar, somewhat similar, modified activity as a wild-type or unmodified proteins. Structurally related proteins include proteins possessing one or more similar or identical particular structures, wherein each particular structure, irrespective of its amino acid sequence or with respect to its amino acid sequence, facilitates a particular role or activity, including binding specificity and the like.

The term “parental related proteins” or “parental proteins” as used herein, refer to the family or multiple families of related proteins which were utilized in a single recombination reaction.

Suitable “related proteins” of interest can be fragments, analogues, and derivatives of native or naturally occurring proteins. By “fragment” is intended a protein consisting of only a part of the intact protein sequence and structure, and can be a C-terminal deletion or N-terminal deletion of the native protein or both. By “analogue” is intended an analogue of either the native protein or of a fragment thereof, where the analogue comprises a native protein sequence and structure having one or more amino acid substitutions, insertions, deletions, fusions, or truncations. Protein mimics are also encompassed by the term analogue. By “derivative” is intended any suitable modification of the native protein of interest, of a fragment of the native protein, or of their respective analogues, such as glycosylation, phosphorylation, or other addition of foreign moieties, so long as the desired activity of the native protein is retained.

The term “wild-type” means that the amino acid fragment does not comprise any mutations. A “wild-type” protein means that the protein will be active at a level of activity found in nature and typically will comprise the amino acid sequence found in nature. In an aspect, the term “wild type” or “parental sequence” can further indicate a starting or reference sequence prior to a manipulation of the invention.

In the polypeptide notation used herein, the left-hand direction is the amino terminal direction and the right-hand direction is the carboxy-terminal direction, in accordance with standard usage and convention. Similarly, unless specified otherwise, the left-hand end of single-stranded polynucleotide sequences is the 5′ end; the left-hand direction of double-stranded polynucleotide sequences is referred to as the 5′ direction. The direction of 5′ to 3′ addition of nascent RNA transcripts is referred to as the transcription direction; sequence regions on the DNA strand having the same sequence as the RNA and which are 5′ to the 5′ end of the RNA transcript are referred to as “upstream sequences”; sequence regions on the DNA strand having the same sequence as the ADA and which are 3′ to the 3′ end of the coding RNA transcript are referred to as “downstream sequences”.

As used herein “protein library” refers to a set of polynucleotide sequences that encodes a set of proteins, and to the set of proteins encoded by those polynucleotide sequences, as well as the fusion proteins containing those proteins.

### PREFERRED MODES FOR CARRYING OUT THE INVENTION

The present invention provides methods and compositions enabling extensive recombination between polynucleotides encoding peptides and polypeptide fragments derived from proteins having a common function and/or a common structure without constrains of DNA homology.

According to a particular embodiment of the present invention, a method for generating a plurality of recombinant chimeric proteins is provided. The method comprise, as an essential feature, selection of a plurality of consensus amino acid sequences, such that each consensus amino acid sequence corresponds to a distinct amino acid sequence that is conserved in a plurality of related proteins. The conserved amino acid regions may correspond to conserved amino acid sequences or to conserved amino acid structures, such as conserved peptide structures. Certain aspects of the invention integrate both types of conserved regions. In a certain embodiments, the selected conserved amino acid regions are short, and protein function is not abolished upon their exchange with a designed consensus sequence.

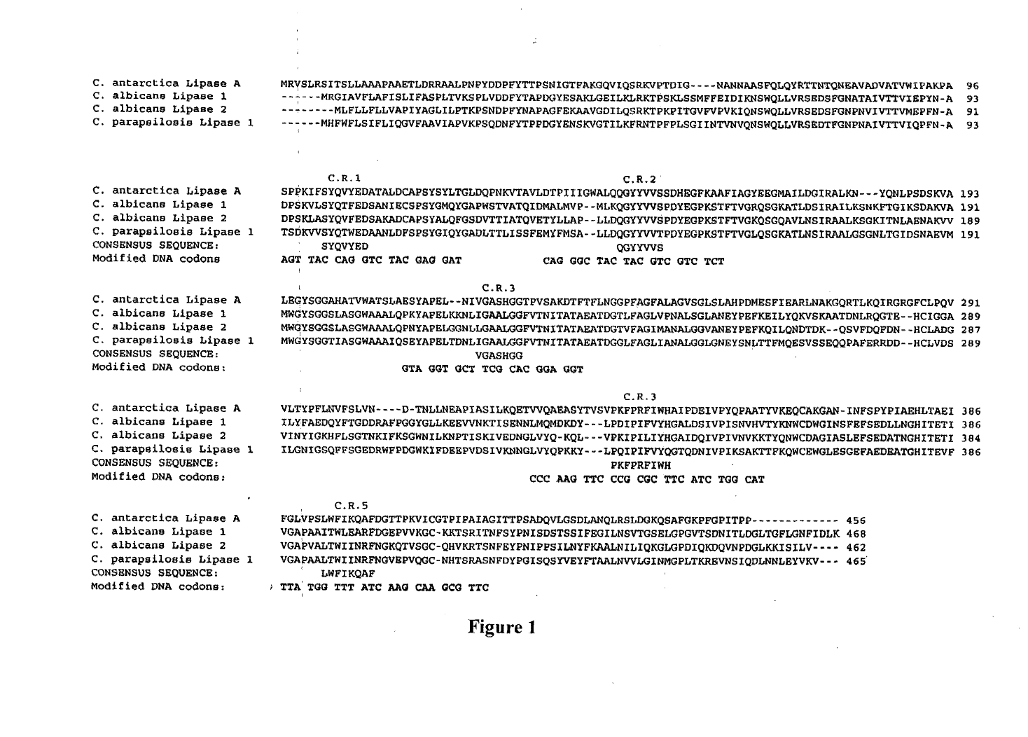

Identification of conserved amino acid regions is typically performed through amino acid sequence alignment of a plurality of proteins (FIG. 1). The plurality of proteins may be randomly selected and following a preliminary amino acid sequence alignment, the randomly selected proteins are divided into groups of related proteins, such that the member proteins in each group posses a particular range of amino acid sequence similarity. Alternatively, the plurality of proteins utilized to identify conserved amino acid regions may be deliberately selected from a group of proteins known to posses a specific activity, a certain structure or both. The proteins or peptides may be derived from different microorganisms or from different proteins and proteinaceous complexes (e.g. the cellulosome) of the same organism.

Amino acid sequence alignment is usually conducted using any protein search tool, which allows to input protein sequences and to compare these against other protein sequences, such as Protein BLAST. The proteins are selected from protein databases, wherein search for related protein is conducted in protein databases, protein structure databases and conserved domains databases among others.

Following identification of a plurality of conserved amino acid regions in a plurality of related proteins, a consensus amino acid sequence is determined for each distinct conserved amino acid region. A distinct conserved amino acid region is generally a set of a plurality of regions, being conserved in the plurality of related proteins. Accordingly, each consensus amino acid region confers a significant similarity to each conserved region of a distinct set of conserved amino acid regions, wherein the consensus sequence is of 3 to 30 amino acids, preferably 4 to 20 amino acids, more preferably 5 to 10 amino acids.

Distinct polynucleotides are produced once a plurality of conserved regions are identified in a plurality of parental proteins, and consensus amino acid regions are determined, wherein the parental proteins are a family of related proteins or multiple families of related proteins. Each consensus amino acid sequence corresponds to a conserved amino acid sequence or a conserved amino acid structure in a group of related proteins. Accordingly, a typical polynucleotide, also termed hereinafter “an overlapping polynucleotide”, comprises a gene encoding any fragment of the related proteins, also termed herein “a variable region”, and is further terminated at least on one side with distinct terminal oligonucleotide sequences capable of encoding a consensus amino acid sequence. Each overlapping polynucleotide may further comprise a terminal uniform oligonucleotide, which does not encode a consensus amino acid sequence but overlaps with at least another distinct polynucleotides within the compositions of the invention. The variable regions of the plurality of polynucleotides generated by the methods of the present invention or comprised within the compositions of the present invention may exhibit a reduced level of sequence homology, less than 70% sequence homology, less than 50% sequence homology, less than 30% sequence homology and even less than 10% sequence homology. The present invention further relates to methods for preparing the recombinant chimeric proteins and uses thereof, that are less expensive, less labor-intensive and more efficient than procedures that are used currently. The advantage of the present invention is that by shuffling between variable regions while maintaining the consensus backbone, the production of active proteins with high diversity, is increased.

It should be noted that the DNA shuffling approaches known in the art mainly depend on random recombination between randomly fragmented polynucleotides. As these processes rely on cross hybridization between contiguous nucleotides, and since the hybridization depends on homology, fragmented polynucleotides derived from a given relatively long parental polynucleotide tend to hybridize to polynucleotide fragments that are highly complementary (homologous) rather than to hybridize with fragments that are not highly complementary. Thus, short regions of homology shared between the various fragmented polynucleotides do not generate new extension products and the final hybridization products are primarily similar or identical to the parental polynucleotide. This is true even in cases where homology between the parental types is quite high and deliberate attempts are made to encourage such recombination (e.g. U.S. Pat. No. 6,479,652). The occurrence of double or triple recombinants in such cases is even rare.

The present invention enables utilization of screening procedures that are less labor-intensive and more cost-effective than procedures currently in use. Due to the constraints posed by homology in current methods, the parental proteins have to be very similar to each other. As a result, active chimeras are generated, but these are not significantly diverse from their parents. Furthermore, screening for the chimera produced by current methods usually requires complex quantitative high throughput assays. This problem is overcome by the present invention by shuffling between variable regions while keeping the conserved regions unaffected. This ensures production of improved and high rates of active products.

Use of the methods of the present invention is further advantageous as it results in the production of libraries with enhanced product diversity. This advantage is maintained even when the polynucleotides used for recombination confer a low sequence homology. Furthermore, since shuffling between variable regions is preferably performed between highly diverse parents, most of the products of such procedures are inactive, and therefore, allow easy quantitative screening or selection between inactive and active products even in high throughput systems to generate a second library of active products. The diverse nature of the active products of the present invention thus leads to more diverse properties and thus a better or superior library in terms of the potential to find better performing proteins among its products. Therefore, a second screen that is a low-throughput but highly specific assay for desired properties may be carried out in the present invention.

Typically, the proteins that are utilized for the present invention comprise the groups of receptor proteins, trans-membrane proteins, transport proteins, protein-pumps, structural proteins, toxins, insecticides, storage proteins or protein-hormones.

Receptor and trans-membrane proteins comprise but are not limited to ion channel-linked receptors, enzyme-linked receptors or G protein-coupled receptors. Examples of ion channels include cys-loop receptors such as GABA A receptor gamma 1, ionotropic glutamate receptors such as glutamate receptor ionotropic kainite 1 (GRIK 1), and ATP gated receptors such as P2X. Examples of enzyme-linked receptors include fibroblast growth factor receptor, bone morphogenic protein and atrial natriuretic factor receptor. G protein-coupled receptors include rhodopsin-like receptors, secretin receptors, metabotropic glutamates, fungal mating pheromone receptors and cyclic AMP receptors. Example 1 below illustrates the utilization of the present invention in order to produce a library of advantageous transport proteins

Transport proteins comprise but are not limited to membrane transport proteins vesicular transport proteins or carrier proteins. Membrane transport proteins include but are not limited to channel proteins such as the potassium channels KcsA and KvAP, potassium large conductance calcium-activated channels, such as the subfamily M, alpha member 1 encoded by the KCNMA1 gene, potassium small conductance calcium-activated channels, such as the K_{Ca}2.1, sodium channels such as the voltage-gated, type IV, alpha subunit Naᵥ1.4, and the like. Examples of vesicular transport proteins include but are not limited to: Archain, ARFs, Clathrin, Caveolin, Dynamin and related proteins, such as the EHD protein family, Rab proteins, SNAREs, Sorting nexins, Synaptotagmin and the like. Carrier proteins include but are not limited to acyl carrier proteins, adaptor proteins, androgen binding proteins, calcium binding proteins, calmodulin binding proteins, fatty acid binding proteins, GTP binding proteins, iron binding proteins, follistatins, follistatin-related proteins. Specific examples of carrier proteins are the human Caveolin 1, Cortactin, or CRK-Associated substrate proteins. Example 2 below illustrates the utilization of the present invention in order to produce a library of advantageous transport proteins.

Protein-pumps comprise but are not limited to proton pumps, MDR pumps, p-glycoproteins, cytochrome c oxidases, ubiquinone and NADH-Q reductases.

Structural proteins comprise but are not limited to actin, amyloid, anchoring fibrils, catenin, claudin, coilin, collagen, Collagen type XVII, alpha 1, elastic fiber, elastin, extensin, fibrillin, lamin, osteolathyrism, ParM, reticular fiber, scleroprotein, sclerotin, spongin, Viral structural proteins, or spider-silk proteins. Example 3 below illustrates the utilization of the present invention in order to produce a library of advantageous structural proteins.

Toxins comprise but are not limited to exotoxins of bacteria, fungi, algae or protozoa, snake venoms or scorpion toxins. Examples of toxins of bacteria are botulinum toxin, corynebacterium diphtheriae toxin and the like. An example of snake venom is Mojave Toxin and examples of scorpion toxins are chlorotoxin and maurotoxin.

Insecticide proteins comprise but are not limited to the well known Bt Protein from Bacillus thuringiensis. Example 4 below illustrates the utilization of the present invention in order to produce a library of another kind of advantageous insecticidal proteins.

Storage proteins comprise but are not limited to Ferritin that stores iron, casein and ovalbumin that store amino acids in animals, or Prolamines, Vicelins and Legumins in plants. Example 5 below illustrates the utilization of the present invention in order to produce a library of advantageous storage proteins.

Protein-hormones comprise but are not limited to thyroglobulin, calcitonin, parothormone, insulin, glucagon, thyrotropin, follicle-stimulating hormone, or luteinizing hormone (LH). Example 5 below illustrates the utilization of the present invention in order to produce a library of advantageous hormones.

Examples 1-6 demonstrate utilizing representatives from each of these groups. However, ones who are familiar with the art would immediately appreciate that these examples are not limiting and can include any proteins from the said groups as well as other groups of proteins.

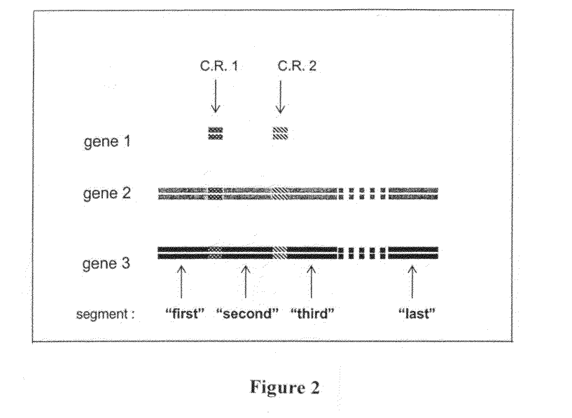

Typically, a first distinct overlapping polynucleotide has a downstream terminal sequence which is identical to the upstream terminal sequence of a second distinct polynucleotide (FIG. 2), the downstream terminal sequence of the second distinct polynucleotide is identical to the upstream terminal sequence of a third distinct polynucleotide, and so on.

According to a preferred embodiment, the distinct polynucleotides of the methods and compositions of the present invention are produced by PCR using appropriate primers, wherein the appropriate primers comprise the following elements: a 5′ portion which is identical to a uniform oligonucleotides encoding a consensus amino acid sequences; at least one dU nucleotide replacing one or more of the dT nucleotides of the uniform sequence, wherein the replaced dT is within the 10 to 30 nucleotides from the 5′ terminus of the primer; a 3′ terminus that is complementary to a gene fraction encoding a fragment of a desired parental protein. The source from which the distinct polynucleotides are isolated or the variable polynucleotides therein may be any suitable source, for example, from plasmids such a pBR322, from cloned DNA or RNA or from natural DNA or RNA from any source including bacteria, yeast, viruses and higher organisms such as protozoa, fungi, plants or animals. DNA or RNA may be extracted from blood or tissue material. The template polynucleotide may be obtained by amplification using the polynucleotide chain reaction (PCR) (U.S. Pat. Nos. 4,683,202 and 4,683,195). The polynucleotide may be present in a vector present in a cell and sufficient nucleic acid may be obtained by transforming the vector into a cell, culturing the cell and extracting the nucleic acid from the cell by methods known in the art.

The plurality of distinct polynucleotides may be amplified prior to recombination to obtain distinct sets of polynucleotides using amplification methods known in the art, commonly using PCR reaction (U.S. Pat. Nos. 4,683,202 and 4,683,195) or other amplification or cloning methods. However, the removal of free primers from the PCR products before hybridization provides a more efficient result. Removal of free primers from the composition may be achieved by numerous methods known in the art including forcing the composition through a membrane of a suitable cutoff by centrifugation.

The plurality of distinct polynucleotides are mixed randomly or mixed using a predetermined prevalence of the plurality of distinct polynucleotides, to form a composition of overlapping polynucleotidesencourage atconsensus/uniform/is encouraged. The composition comprises distinct polynucleotides derived from a single family of related proteins and preferably comprises distinct polynucleotides derived from multiple families of related proteins. The number of distinct polynucleotides in a composition is at least about 25, preferably at least about 50, preferably at least about 100 and more preferably at least about 500.

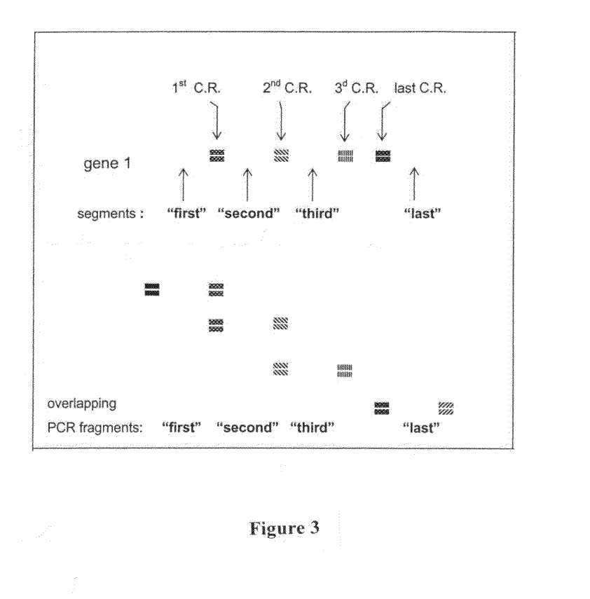

The composition of overlapping polynucleotides may be maintained under conditions which allow hybridization and recombination of the polynucleotides and generation of a library of chimeric polynucleotides (FIG. 3). It is contemplated that multiple families of related proteins may be used to generate a library of chimeric polynucleotides according to the method of the present invention, and in fact were successfully used.

The optimal conditions for hybridization, also termed “stringent conditions” or “stringency”, refer to the conditions for hybridization as defined by the nucleic acid, salt, and temperature and are well known in the art. Numerous equivalent conditions comprising either low or high stringency depend on factors such as the length and nature of the sequence (DNA, RNA, base composition), nature of the target (DNA, RNA, base composition), milieu (in solution or immobilized on a solid substrate), concentration of salts and other components (e.g., formamide, dextran sulfate and/or polyethylene glycol), and temperature of the reactions (within a range from about 5° C. to about 25° C. below the melting temperature of the probe). One or more factors may be varied to generate conditions of either low or high stringency while only those single-stranded overlapping polynucleotides having regions of homology with other single-stranded overlapping polynucleotides will undergo hybridization to form double stranded segments. For example, a slow cooling of the temperature could provide a suitable temperature gradient such that each distinct single stranded overhangs will undergo hybridization at an appropriate temperature within the provided temperature gradient.

Recombination step may be achieved by any suitable recombination system selected from the group consisting of: in vitro homologous recombination, in vitro sequence shuffling via amplification, in vivo homologous recombination and in vivo site-specific recombination.

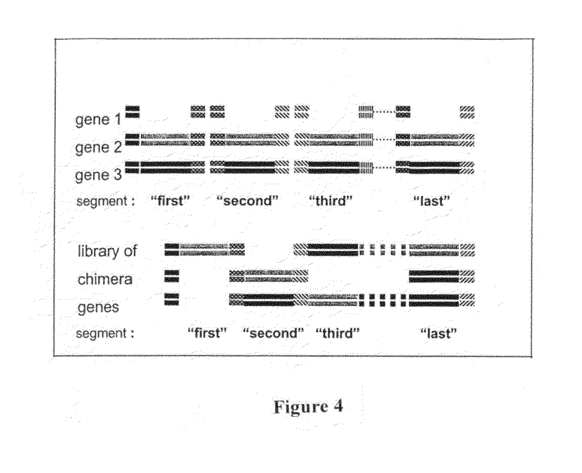

According to another preferred embodiment, hybridization and recombination of the distinct polynucleotides may be performed by a single round of primer extension (FIG. 4). Two distinct polynucleotides hybridize through their overlapping uniform sequences, wherein at least one overlapping uniform sequence of each overlapping polynucleotide may correspond to a consensus amino acid sequence. Following hybridization, extension of the single stranded 5′ and 3′ overhangs, takes place. Filling-in of single stranded locations within the double stranded assembled chimeric polynucleotide is optionally performed in vitro in the presence of DNA polymerase, dNTPs and ligase. This method differs from PCR, in that the number of the polymerase start sites and the number of molecules remains essentially the same wherein in PCR, the number of molecules grows exponentially.

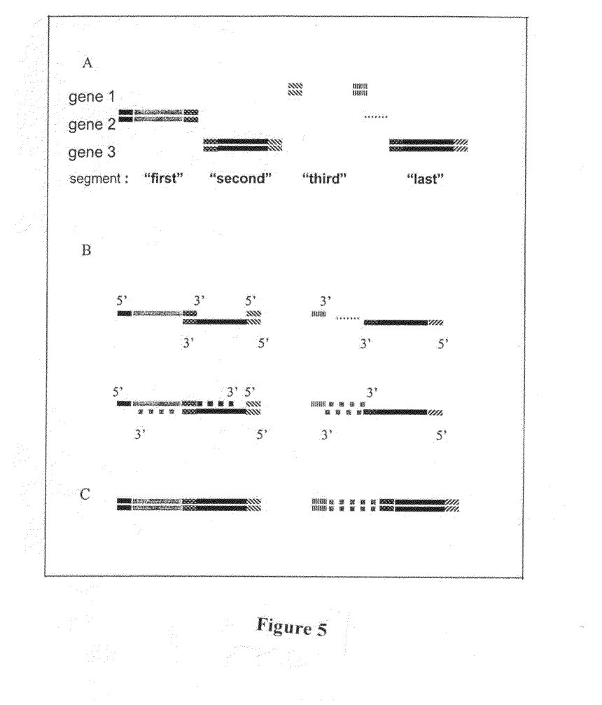

According to an additional preferred embodiment of the invention, following hybridization the overlapping terminals of the double stranded polynucleotides are converted into long single-stranded overhangs. According to this embodiment, the fragments are then connected to each other and cloned by Ligation Independent Cloning (LIC) procedure (FIG. 5).

According to yet another embodiment, hybridization and recombination of the overlapping polynucleotides is performed in-vivo. According to this embodiment, host cells are transfected with the composition of the overlapping polynucleotides and recombination is performed by the endogenous recombination machinery of the host.

According to a further embodiment of the invention, the overlapping polynucleotides of the composition may comprise sequences that are not related to the parental proteins or to the consensus sequences.

The molar ratio of the distinct overlapping polynucleotides in the composition of the present invention may be equimolar between all distinct polynucleotides (1:1:1 . . . :1) or other ratio that is suitable to promote the recombination of a specific library of chimeric polynucleotides.

The length of distinct polynucleotides may vary from overlapping polynucleotide sequences containing more than 20 nucleotides to overlapping polynucleotide sequences containing more than 100 nucleotides, more than 400 nucleotides, more than 1000 nucleotides. Preferably, the length of overlapping polynucleotides is more than 20 nucleotides and not more than 5000 nucleotides, preferably, the length of an overlapping polynucleotides is between about 100 to about 400 nucleotides.

According to one preferred embodiment of the methods and compositions of the present invention, a polynucleotide which is designed to overlap with a vector fragment comprises a common uniform terminal sequence located upstream or downstream of the beginning or termination of the coding region of said overlapping polynucleotide. At the end of recombination in the presence of vector fragments, such polynucleotides will be at the termini of the resulting chimeric genes and will ‘stick’ to the vector fragments.

Recombination may be further achieved by a method for assembling a plurality of overlapping polynucleotides, comprising (a) providing a plurality of double stranded DNA fragments having at least one terminal single stranded overhang capable of encoding a consensus amino acid sequence, wherein the overhang terminus of each DNA fragment is complementary to the overhang of at least one other DNA fragment; and (b) mixing the DNA fragments under suitable conditions, to obtain recombination. The principles of this method are disclosed in U.S. Pat. No. 6,372,429 assigned to one of the inventors of the present invention.

Recombination between a plurality of polynucleotides may be performed in the presence of a plurality of vector fragments terminated at both ends with single stranded overhangs that are complementary to any of the terminal sequences of any of said polynucleotides. Alternatively, the library of chimeric polynucleotides is ligated into a plurality of vectors prior to transfection of a plurality of host cells. For this purpose any vector may be used for cloning provided that it will accept a chimeric polynucleotide of the desired size.

For expression of the chimeric polynucleotide, the cloning vehicle should further comprise transcription and translation signals next to the site of insertion of the DNA fragment to allow expression of the chimeric polynucleotide in the host cell. The vector may comprises at least one additional component selected from the group consisting of: a restriction enzyme site, a selection marker gene, an element capable of regulating production of a detectable protein activity, an element necessary for propagation and maintenance of vectors within cells. The vector is selected from the group consisting of: a plasmid a cosmid, a YAC, a BAC, or a virus. Expression vectors containing all the necessary elements for expression are commercially available and known to those skilled in the art. See, e.g., Sambrook et al., Molecular Cloning: A Laboratory Manual, Second Edition, Cold Spring Harbor Laboratory Press, 1989. Preferred vectors include the pUC plasmid series, the pBR series, the pQE series (Quiagen), the pIRES series (Clontech), pHB6, pVB6, pHM6 and pVM6 (Roche), among others.

A plurality of host cells is transfected with the library of chimeric polynucleotides of the invention, for maintenance and for expression of a corresponding library of chimeric proteins. To permit the expression of the library of chimeric polynucleotides in the host cells the chimeric polynucleotides are placed under operable control of transcriptional elements. Upon transfection, a library of cloned cell lines is obtained. The clones may be cultured utilizing conditions suitable for the recovery of the protein library from the cloned cell lines. At least one of the clones may exhibit a specific enzymatic activity. This mixed clone population may be tested to identify a desired recombinant protein or polynucleotide. The method of selection will depend on the protein or polynucleotide desired. For example, if a protein with increased binding efficiency to a ligand is desired, the clone library or the chimeric polypeptide library reconstructed therefrom may be tested for their ability to bind to the ligand by methods known in the art (i.e. panning, affinity chromatography). If a protein with increased drug resistance is desired, the protein library may be tested for their ability to confer drug resistance to the host organism. One skilled in the art, given knowledge of the desired protein, could readily test the population to identify the clone or the chimeric protein which confer the desired properties.

It is contemplated that one skilled in the art could use a phage display system in which fragments of the recombinant chimeric proteins of the invention are expressed as fusion proteins on the phage surface (Pharmacia, Milwaukee Wis.). The recombinant chimeric polynucleotides are cloned into the phage DNA at a site, which results in the transcription of a fusion protein, a portion of which is encoded by the recombinant chimeric polynucleotide. The phage containing the recombinant nucleic acid molecule undergoes replication and transcription in a host cell. The leader sequence of the fusion protein directs the transport of the fusion protein to the tip of the phage particle. Thus the fusion protein, which is partially encoded by the recombinant chimeric polynucleotides, is displayed on the phage particle for detection and selection by the methods described-above. In this manner, recombinant chimeric proteins with even higher binding affinities or enzymatic activity, than that conferred by the parental proteins or other known wild-type proteins, could be achieved.

According to a third aspect, the present invention provides recombinant chimeric proteins comprising a plurality of consensus amino acid regions corresponding to amino acid sequences that are conserved in a plurality of related proteins. The recombinant chimeric proteins further comprise a plurality of variable regions corresponding to various amino acid sequences derived from the related proteins. Said variable regions may be deliberately selected and included in the chimeric products for the purposes of designing vaccines and synthetic antibodies.

It is a fourth aspect of the present invention to provide methods of using the recombinant chimeric proteins of the invention comprising formation of libraries of chimeric proteins and libraries of chimeric genes, providing assays for screening libraries of recombinant chimeric proteins for various uses including searching for proteins with improved or preferred functionality, searching for ligands and receptors, among other uses and applications.

### EXAMPLES

### Example 1

Chemokine (C—C) receptors are G-protein-coupled trans membrane receptors found in vertebrates. Some chemokine receptors are involved in chemotaxis and the immune response. Different types of chemokines trigger specific immune response mechanisms of novel cell types. The present invention is directed to monitoring the trafficking of cells to desired locations in the body, by building a library of chemokine receptors with altered N-termini (and are thus activated by alternative chemokines), trans membrane domains (consequently being able to function in different cell types), as well as altered C-termini (which promote a somewhat different chemotaxis-response).

### Methods: a) Identifying Conserved Amino Acids in Proteins of Interest

Seven “parental” chemokine receptor proteins of interest were identified: 5 of mammalian origin (2-human, 1 of cat origin and 2 coming for horse), 1 from chicken and one of viral origin. The amino acid sequences of these proteins are depicted below, along with their accession numbers:

NP_{—}001286.1, Human chemokine receptor type 1: See SEQ ID NO 1
NP_{—}001009248.1, Cat chemokine receptor type 1: See SEQ ID NO 2
NP_{—}001116513.2, Human chemokine receptor type 2: SEQ ID NO 3
NP_{—}001039299.1, chicken chemokine receptor type 1: SEQ ID NO 4
NP_{—}001098003.1, Horse chemokine receptor type 5: SEQ ID NO 5
NP_{—}042597.1, Equid herpesvirus chemokine receptor type 2: SEQ ID NO 6
NP_{—}00109075.1, Horse chemokine receptor type 2: SEQ ID NO 7

### b) Selecting Consensus Amino Acid Sequences

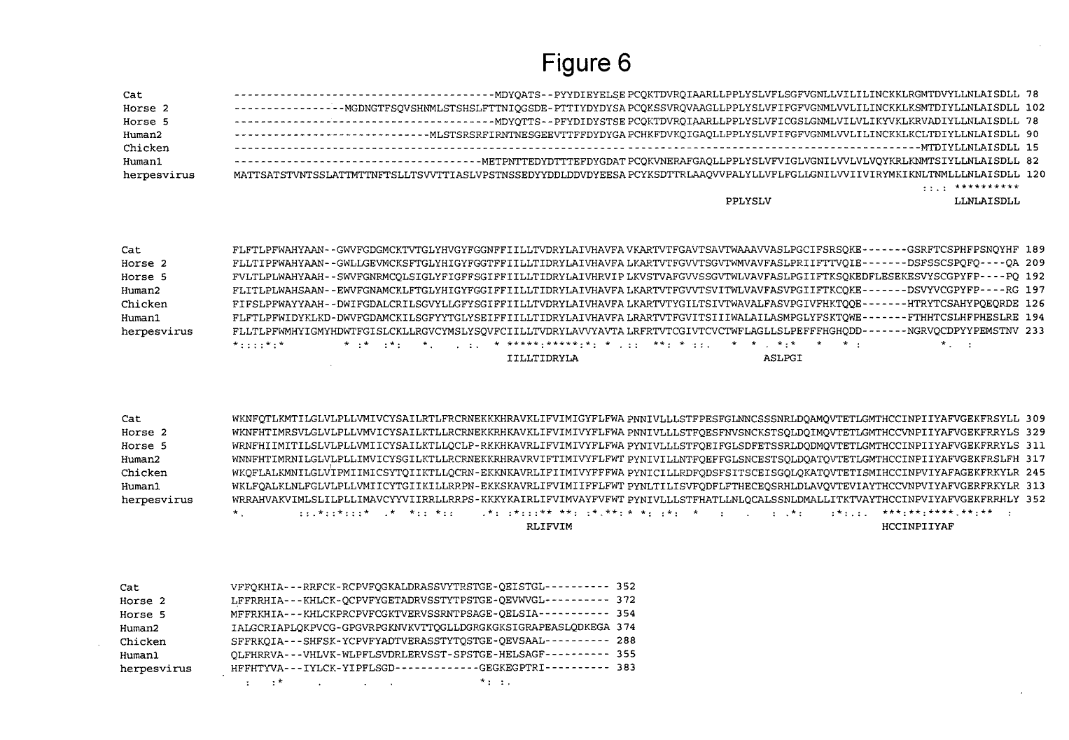

The seven “parental” proteins (SEQ ID NOS 1, 2, 3, 4, 5, and 6, respectively, in order of appearance) are aligned using the web's free multiple sequence alignment program ClustalW2. (Larkin M. A., Blackshields G., Brown N. P., Chema R., McGettigan P. A., McWilliam H., Valentin F., Wallace, I. M., Wilm, A., Lopez R., Thompson J. D., Gibson T. J. and Higgins D. G. (2007) ClustalW and ClustalX version 2. Bioinformatics 2007 23(21): 2947-2948). The results of the alignment are shown in FIG. 6. Conserved sequences are identified- and consensus sequences, corresponding to these sequences are designed (FIG. 6) and portrayed below:

(SEQ ID NO: 8

Synthetic Consensus peptide sequence PPLYSLV:

SEQ ID NO: 9

Synthetic Consensus peptide sequence LLNLAISDLL:

SEQ ID NO: 10

Synthetic Consensus peptide sequence IILLTIDRYLA:

SEQ ID NO: 11

Synthetic Consensus peptide sequence ASLPGI:

SEQ ID NO: 12

Synthetic Consensus peptide sequence RLIFVIM:

SEQ ID NO: 13

Synthetic Consensus peptide sequence HCCINPIIYAF:

The sequence of each of the seven proteins is reverse translated into DNA. In order to enhance protein expression in K. lactis. DNA optimization is carried out using data obtained from the Kazusa web site, see http://www.kazusa.or.jp/codon/index.html. One codon—the most frequently used by K. lactis—was assigned for each amino acid.

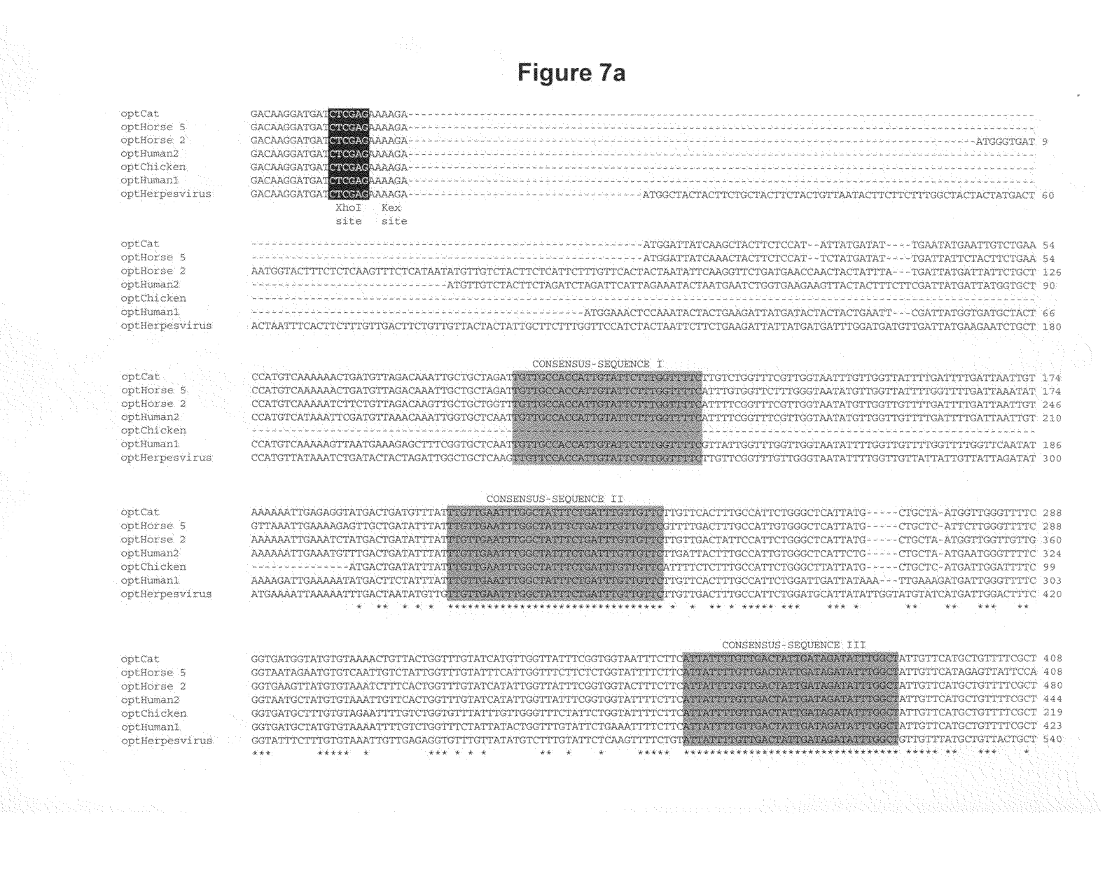

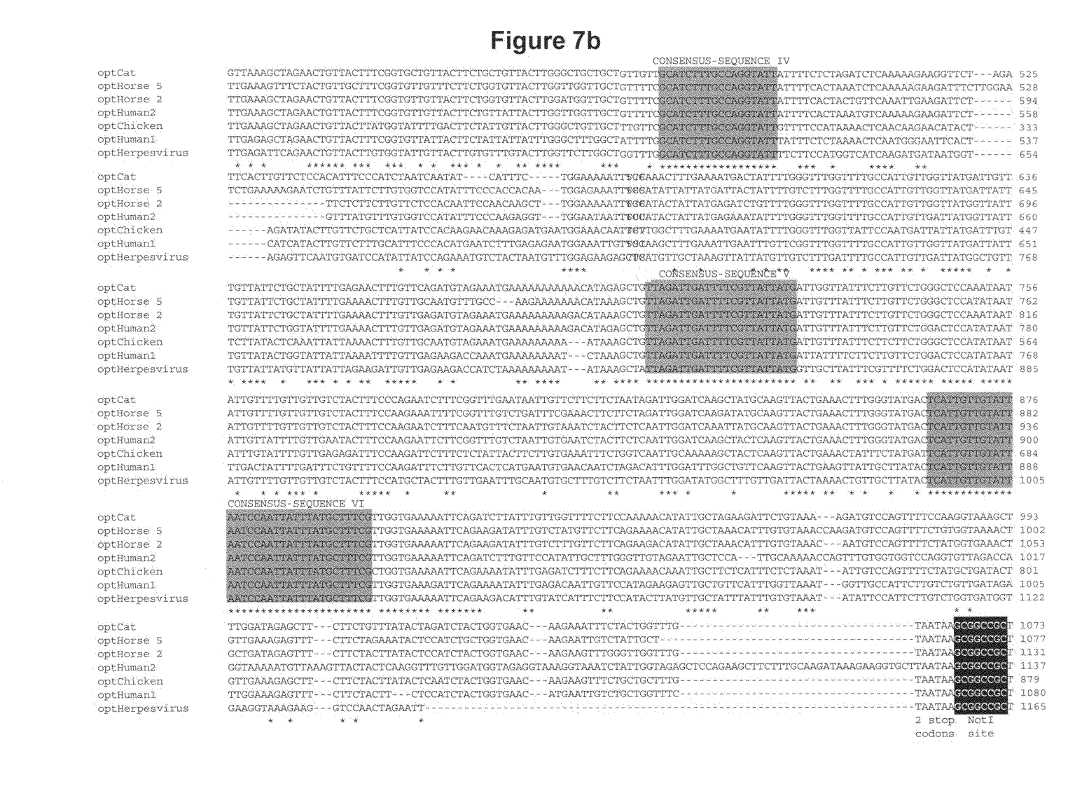

DNA Alignment of optimized sequences (SEQ ID NOS 21-27, respectively, in order of appearance is carried out again utilizing ClustalW2 (FIG. 7).

### Synthetic Polynucleotide: SEQ ID NO: 21

### Synthetic Polynucleotide: SEQ ID NO: 22

### Synthetic Polynucleotide: SEQ ID NO: 23

### Synthetic Polynucleotide: SEQ ID NO: 24

### Synthetic Polynucleotide: SEQ ID NO: 25

### Synthetic Polynucleotide: SEQ ID NO: 26

### Synthetic Polynucleotide: SEQ ID NO: 27

The sequences are designed such that at the beginning of each sequence there are uniform additional sequences containing XhoI and Kex sites. Likewise, at the end of each of the sequences are two tandem stop codons and NotI site. The XhoI and the NotI sites enable the cloning of the sequences into the K. lactis pKLAC1 expression vector (purchased from New England Biolabs)

The various sequences are synthesized by synthetic gene construction. Following the construction, each of the sequences is cloned into pKLAC1 vector and sequencing is performed. For each sequence, a clone that does not contain mutations is isolated. DNA purification of plasmid DNA is carried out using any of a number of well known procedures. PCR (50 ul reaction volume) with upstream forward primer (see below) and downstream reverse primer (see below) is carried out. Seven independent reactions are carried out utilizing each of the isolated plasmids mentioned above as templates. Thermocycling consist of 25 rounds of successive incubations at 95 c for 20 seconds, 42 c for 20 seconds, and 72 c for 1.5 min, then a final incubation at 72 c for 3 minutes. The DNA bands are extracted from 1% agarose gel and purified according to procedures that are well known in the art. One way of doing it is by using a kit from RBC Bioscience (CAT #YDF100). Many other such kits are also available. The following primers are constructed (Note: the consensus amino acid sequence as well as the respective consensus DNA sequences are also shown in order to illustrate how and why each of the primers is designed the way it does.

Upstream forward primer

(SEQ ID NO: 28)

GACAAGGATGATCTCGAGAAAAGA
Downstream reverse primer

(SEQ ID NO: 29)

TTAATTAAGCGGCCGCTTATTA
CONSENSUS AMINO ACID SEQ I

(SEQ ID NO: 8)

P P L Y S L V
Consensus DNA seq.I

(SEQ ID NO: 30)

CCA CCA TTG TAT TCT TTG GTT
Forward primer for consensus seq. I

(SEQ ID NO: 31)

ACCAUTGTATTCUTTGGUT
Reverse primer for consensus seq. I

(SEQ ID NO: 32)

ACCAAAGAAUACAAUGGUGG
Consensus amino acid seq. II

(SEQ ID NO: 9)

L L N L A I S D L L
Consensus DNA seq. II

(SEQ ID NO: 33)

TTG TTG AAT TTG GCT ATT TCT GAT TTG TTG
Forward primer for consensus seq. II

(SEQ ID NO: 34)

AATTTGGCUATTTCUGATTTGTUG
Reverse primer for consensus seq. II

(SEQ ID NO: 35)

AACAAAUCAGAAAUAGCCAAATUCAACAA
Consensus amino acid seq. III

(SEQ ID NO: 10)

I I L L T I D R Y L A
Consensus DNA seq. III

(SEQ ID NO: 36)

ATT ATT TTG TTG ACT ATT GAT AGA TAT TTG GCT
Forward primer for consensus seq. III

(SEQ ID NO: 37)

ATTTTGUTGACTATTGAUAGATATTUGGCT
Reverse primer for consensus seq. III

(SEQ ID NO: 38)

AAATATCUATCAATAGUCAACAAAAUAAT
Consensus amino acid seq. IV

(SEQ ID NO: 11)

A S L P G I
Consensus DNA seq. IV

(SEQ ID NO: 39)

GCA TCT TTG CCA GGT ATT
Forward primer for consensus seq. IV

(SEQ ID NO: 40)

ATCTTUGCCAGGTAUT
Reverse primer for consensus seq. IV

(SEQ ID NO: 41)

ATACCUGGCAAAGAUGC
Consensus amino acid seq. V

(SEQ ID NO: 12)

R L I F V I M
Consensus DNA seq. V

(SEQ ID NO: 42)

AGA TTG ATT TTC GTT ATT ATG
Forward primer for consensus seq. V

(SEQ ID NO: 43)

ATTGAUTTTCGUTATTAUG
Reverse primer for consensus seq.V

(SEQ ID NO: 44)

ATAAUAACGAAAAUCAAUCT
Consensus amino acid seq. VI

(SEQ ID NO: 13)

H C C I N P I I Y A F
Consensus DNA seq. VI

(SEQ ID NO: 45)

CAT TGT TGT ATT AAT CCA ATT ATT TAT GCT TTC
Forward primer for consensus seq. VI

(SEQ ID NO: 46)

ATTGTTGTAUTAATCCAATTAUTTATGCTTUC
Reverse primer for consensus seq. VI

(SEQ ID NO: 47)

AAAGCATAAAUAATTGGATTAAUACAACAAUG

c. Generating a Plurality of Partially Overlapping Polynucleotides

Seven primer mixes are made (2.5 μM of each):

Group 1. upstream forward primer & reverse primer for consensus seq. I
Group 2. forward primer for consensus seq. I & reverse primer for consensus seq. II
Group 3. forward primer for consensus seq. II & reverse primer for consensus seq. III
Group 4. forward primer for consensus seq. III & reverse primer for consensus seq. IV
Group 5. forward primer for consensus seq. IV & reverse primer for consensus seq. V
Group 6. forward primer for consensus seq. V & reverse primer for consensus seq. VI
Group 7. forward primer for consensus seq. VI & downstream reverse primer.

1/10 volume of each primer mix is mixed with 7/10 volume of PCR grade water and 2/10 volume of Red Load Taq Master (CAT #VAR_{—}04 purchased from LAROVA GmbH). Each mixture is divided into seven reactions and one of each of the plasmid templates is added to each of those reactions. Thermocycling consists of 25 rounds of successive incubations at 95 c for 20 seconds, 55 c for 20 seconds, and 72 c for 1.5 min, then a final incubation at 72 c for 3 minutes. The annealing temperature may vary. In cases where non-optimal amounts of the products are obtained—gradient annealing is utilized to find the optimal annealing temperature, and the PCR is repeated using the corrected annealing temperature.

Following the PCR, 1 U of Pyrobest DNA polymerase (purchased from Takara) is added and each reaction is incubated at 70 c for 30 minutes in order to get rid any additional bases that may have been added to the 3′ ends of the segments by the Taq DNA polymerase. The DNA of each reaction is then run on 2% agarose gel and the bands are extracted and purified as mentioned above.

d. Inducing Recombination and Creating a Library

All the purified domains are mixed at equi-molar amounts in a single tube and USER™ enzyme and buffer (supplied by New England Biolabs) are added. The enzyme forms nicks at the 3′ side of the dU residues of what used to be primers, at the ends of the various DNA domains forming unique 5′ protruding ends. Since all the 3′ ends of the PCR products of group 1 are complementary to all the 5′ ends of group 2, and since all the 3′ ends of group 2 are complementary to all the 5′ ends of groups 3, and so on—combinatorial mixes of complete genes are formed. These are readily ligated by Ampligase (Purchased from EPICENTRE Biotechnologies) during 30 rounds of LCR, each round consisting of 2 min at 70 c, 1 min at 69 c, 1 min at 68 c, 1 min at 67 c, and so on until 1 min at 45 c where the temperature is raised to 70 c for 2 min again.

e. Transfecting Host Cells

The DNA is cleaved with XhoI and NotI and ligated to a pKLAC1 cleaved by the same enzymes. Amplification of the plasmid is carried out as follows: E. coli transformation is carried out and approximately 3 million colonies are scraped from plates (the number of expected variants is 7⁷=approximately 825,000). Plasmid DNA is purified from the bacteria using protocols that are well known in the art (one possibility is using iYield Plasmid Mini Kit from RBC Bioscience following the manufacturer instructions).

f. Recovery of Recombinant Proteins

The DNA is cleaved by SacII to form linear DNA that is readily integrated in the genome and expressed following transformation of K. lactis. A detailed description of the K. lactis Protein Expression Kit and the pKLAC1 plasmid may be downloaded from the WEB at: http://www.neb.com/nebecomm/ManualFiles/manualE1000.pdf. Sambrook J., Fritsch E. F., Maniatis T. Molecular Cloning a Laboratory manual, Second Edition, Cold Spring Harbor Laboratory Press, 1989.

### Example 2

Hexose carrier proteins, situated in the chloroplast membrane, are responsible for controlling the flux of carbon, in the form of hexose sugars, across the plant chloroplast's envelop. Hexose carrier proteins may be used to manipulate carbohydrate transport. They may be utilized to alter carbon partitioning in the whole plant or to manipulate carbohydrate distribution between cellular compartments. Such manipulations may have a general impact on the plant or on a specific feature such as the taste of the plant's fruit.

The present invention provides methods to control the transport of hexose sugars in tomatoes by creating a large variety of chimera-hexose transporters and screening plants for better tasting tomatoes, by building a library of hexose carrier proteins coming from five very different origins.

a. Identifying Conserved Amino Acids in Proteins of Interest

Five “parental” hexose carrier proteins of interest were selected, including: one from common wheat, one from an ancestor of the cultivated wheat, one from soybean another from grape vine as well as the one from tomato. The amino acid sequences of these proteins are shown below, along with their accession numbers. Seven conserved regions are shown: CAB52689, hexose transporter of Solanum lycopersicum (tomato): SEQ ID NO: 48. AAX47308 hexose transporter 7 of Vitis vinifera (grape vine): SEQ ID NO: 49. CAD91336, monosaccharide transporter of Glycine max (soybean): SEQ ID NO:50. ACN41353, hexose carrier of Triticum aestivum (common wheat): SEQ ID NO:51. NP_{—}001149551, hexose carrier of Aegilops tauschii (ancestor of common wheat: SEQ ID NO: 52.

b. Selecting Consensus Amino Acid Sequences

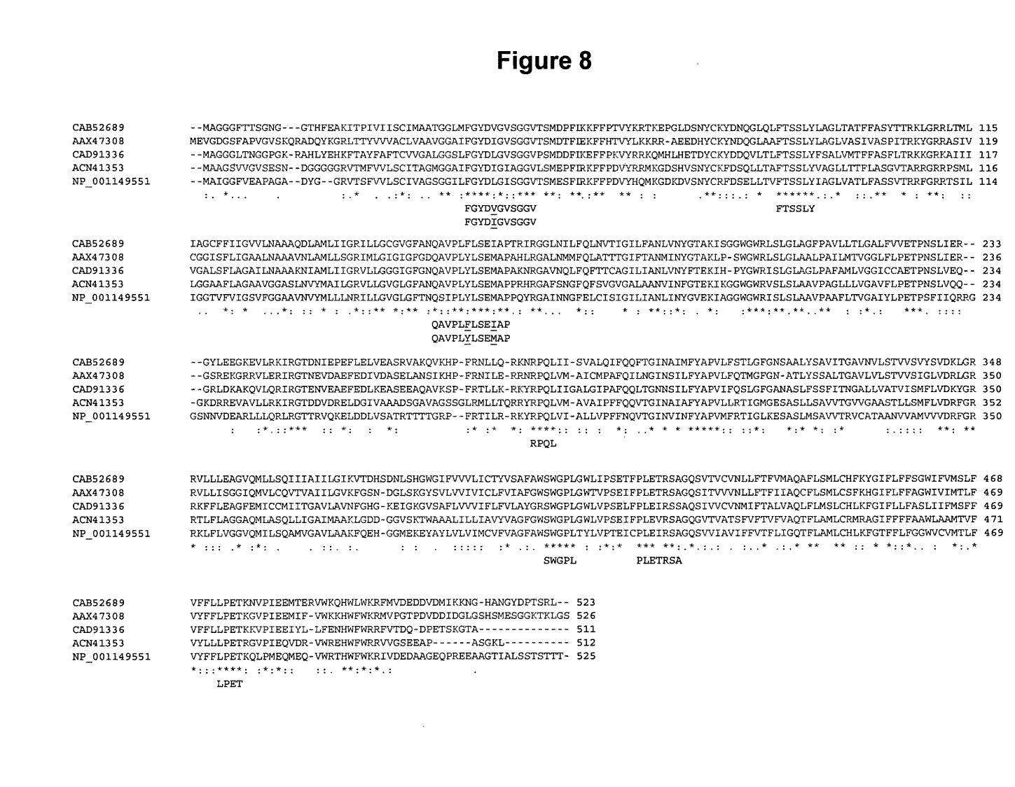

The five “parental” proteins (SEQ ID NOS 48-52, respectively, in order of appearance) are aligned using the web's free multiple sequence alignment program ClustalW2. The results of the alignment are shown in FIG. 8. Consensus sequences, corresponding to these sequences are designed and portrayed below the alignments. Seven conserved regions are shown. Note: Two alternative consensus sequences—different in one and two amino acids—are assigned to the 1^{st} & 3^{d} conserved regions respectively. One alternative corresponds to the tomato sequence and the other to that of grape vine. This is done in order to make sure that both backbones are presented in the resulting library.

The consensus amino acid sequences obtained in the alignment are depicted below:

| | |
|---|---|
| FGYDVGVSGGV | (SEQ ID NO: 53) |
| FGYDIGVSGGV. | (SEQ ID NO: 54) |
| FTSSLY. | (SEQ ID NO: 55) |
| QAVPLFLSEIAP. | (SEQ ID NO: 56) |
| QAVPLYLSEMAP. | (SEQ ID NO: 57) |
| RPQL. | (SEQ ID NO: 58) |
| SWGPL. | (SEQ ID NO: 59) |
| PLETRSA. | (SEQ ID NO: 60) |
| LPET | (SEQ ID NO: 61) |

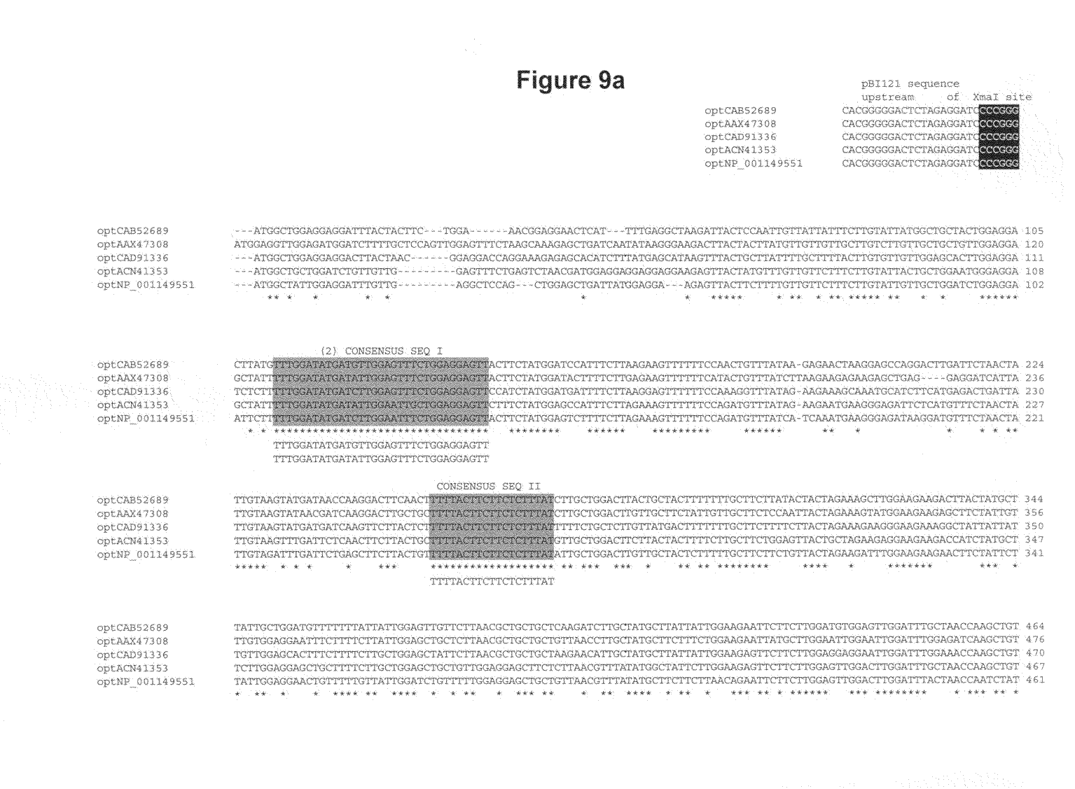

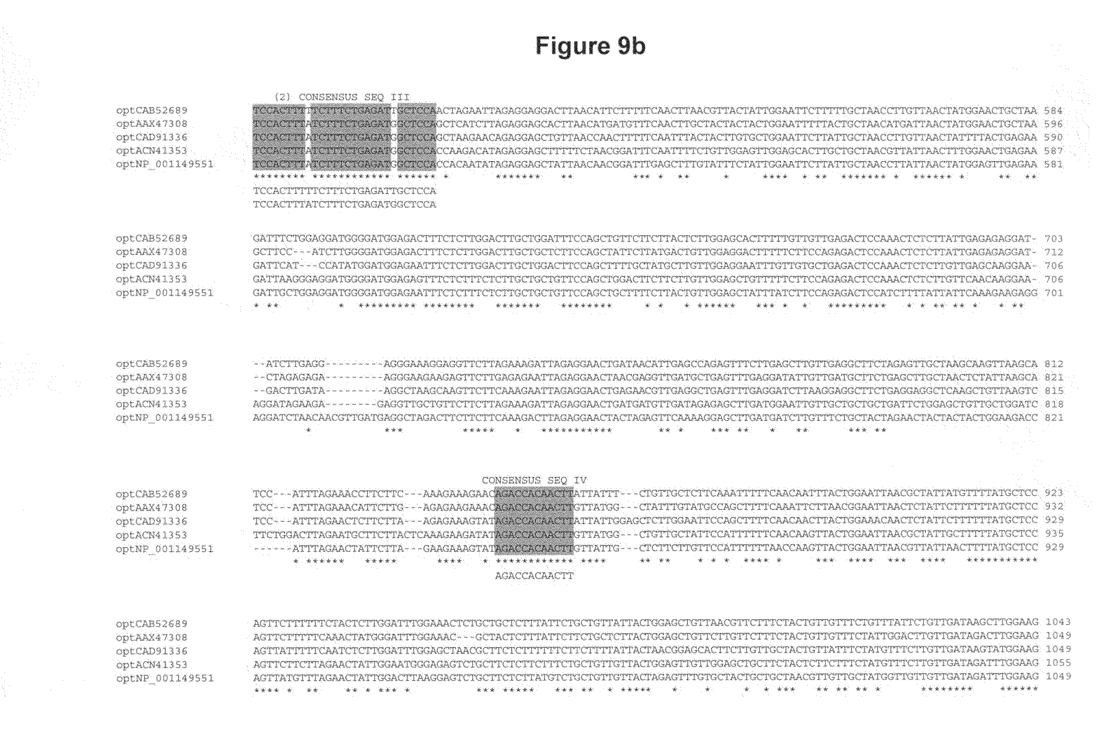

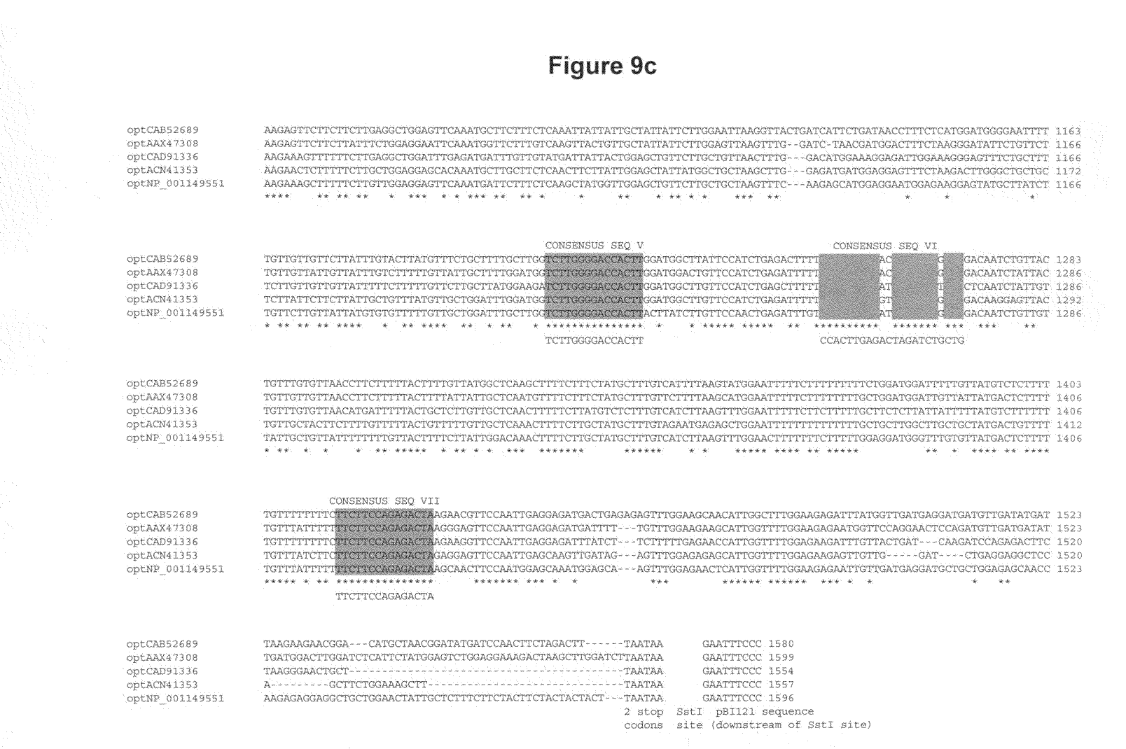

DNA Alignment of optimized DNA sequences (SEQ ID NOS 62-66, respectively, in order of appearance) is carried out utilizing ClustalW2 (FIG. 9).

The sequences are designed such that at the beginning of each sequence there are uniform additional sequences containing a XmaI site. Likewise, at the end of each of the sequences are two tandem stop codons and a SstI site. The XmaI and the SstI sites (white letters in black background) enable the cloning of the sequences into the pBI121 plant binary expression vector (see Clontech catalogue 1996-97).

The consensus DNA sequences are depicted below:

| | |
|---|---|
| TTTGGATATGATGTTGGAGTTTCTGGAGGAGTT. | (SEQ ID NO: 67) |
| TTTGGATATGATATTGGAGTTTCTGGAGGAGTT. | (SEQ ID NO: 68) |
| FGYDVGVSGGV. | (SEQ ID NO: 53) |
| TTTTACTTCTTCTCTTTAT. | (SEQ ID NO: 69) |
| TCCACTTTTTCTTTCTGAGATTGCTCCA. | (SEQ ID NO: 70) |
| TCCACTTTATCTTTCTGAGATGGCTCCA. | (SEQ ID NO: 71) |
| AGACCACAACTT. | (SEQ ID NO: 72) |
| TCTGGGGACCACTT. | (SEQ ID NO: 73) |
| CCACTTTGAGACTAGATCTGCT. | (SEQ ID NO: 74) |
| TTCTTCCAGAGACTA | (SEQ ID NO: 75) |

The optimized sequence of each of the five reverse translated proteins is shown below. The optimization is carried out using data obtained from the Kazusa web site, see http://www.kazusa.or.jp/codon/index.html). One codon the most frequently used by E. lycopersicum—is assigned for each amino acid). The sequences are shown after the conserved sequences (with grey background) are substituted by a uniform consensus. Since XmaI and SstI are the cloning sites into the required vector, XmaI and SstI recognition sites within the optimized sequences must be avoided. XmaI sites are not found, but SstI sites (GAGCTC), corresponding to Gly-Ala, are found in some of the optimized sequences. In order to avoid SstI cleavage, these sites are substituted by the sequence GAGCAC which encodes the same amino acids. The DNA sequences are:

optCAB52689 (SEQ ID NO: 76).
optAAX47308 (SEQ ID NO: 77).
optCAD91336 (SEQ ID NO: 78).
optACN41353 (SEQ ID NO: 79).
optNP_{—}001149551 (SEQ ID NO: 80).

The various sequences are synthesized by synthetic gene construction. Following the construction, each of the sequences is cloned into the pBIN-PLUS/ARS binary vector and sequencing is performed. For each sequence, a clone that does not contain mutations is isolated. DNA purification of plasmid DNA is carried out using any of a number of well known procedures2

PCR (50 ul reaction volume) with upstream forward primer (see below) and downstream reverse primer (see below) is carried out. Seven independent reactions are carried out utilizing each of the isolated plasmids mentioned above as templates. Thermocycling consist of 25 rounds of successive incubations at 95 c for 20 seconds, 42 c for 20 seconds, and 72 c for 2 min, then a final incubation at 72 c for 3 minutes.

The DNA bands are extracted from 1% agarose gel and purified according to procedures that are well known in the art. One way of doing it is by using a kit from RBC Bioscience (CAT #YDF100). Many other such kits are also available.

The following primers are constructed (Note: the consensus amino acid sequence as well as the respective consensus DNA sequences are also shown in order to illustrate how and why each of the primers is designed the way it does.

Upstream forward primer

(SEQ ID NO: 81

CACGGGGGACTCTAGAGGATCCCCGGG
Downstream reverse primer

(SEQ ID NO: 82)

GGGAAATTCGAGCTCTTATTA
CONSENSUS AMINO ACID SEQ I

(SEQ ID NO: 53)

F G Y D V G V S G G V
(tomato backbone alternative)

(SEQ ID NO: 54)

F G Y D I G V S G G V
(grapes backbone alternative)

(SEQ ID NO: 67)

TTT GGA TAT GAT GTT GGA GTT TCT GGA GGA GTT
(tomato backbone alternative)

(SEQ ID NO: 68)

TTT GGA TAT GAT ATT GGA GTT TCT GGA GGA GTT
(grapes backbone alternative).
Forward primer for consensus seq. I
(tomato backbone alternative)

(SEQ ID NO: 83)

ATATGATGTTGGAGTTTCTGGAGGAGTU
Reverse primer for consensus seq. I
(grapes backbone alternative)

(SEQ ID NO: 84)

AACTCCTCCAGAAACTCCAATATCATAU
CONSENSUS AMINO ACID SEQ II

(SEQ ID NO: 85)

F T S S L Y
Consensus DNA seq. II
(optimized for tomato expression)

(SEQ ID NO: 69)

TTT ACT TCT TCT CTT TAC
Forward primer for consensus seq. II

(SEQ ID NO: 85)

ACTTCTTCTCTU
Reverse primer for consensus seq. II

(SEQ ID NO: 86)

AAGAGAAGAAGU
CONSENSUS AMINO ACID SEQ III

(SEQ ID NO: 87)

Q A V P L F L S E I A P
(tomato backbone alternative)

(SEQ ID NO: 88)

Q A V P L Y L S E M A P
(grapes backbone alternative)
Consensus DNA seq. III
(tomato backbone alternative)

(SEQ ID NO: 89)

CAA GCT GTT CCA CTT TTC CTT TCT GAG ATT GCT CCA
Consensus DNA seq. III
(grapes backbone alternative)

(SEQ ID NO: 90)

CAA GCT GTT CCA CTT TAC CTT TCT GAG ATG GCT CCA
Forward primer for consensus seq. III

(SEQ ID NO: 91)

AAGCTGTTCCACTTCTTTCTGAGATTGCUCCA
Reverse primer for consensus seq. III

(SEQ ID NO: 92)

AGCCATCTCAGAGTAAAGTGGAACAGCTUG
CONSENSUS AMINO ACID SEQ IV

(SEQ ID NO: 58)

R P Q L
CONSENSUS DNA SEQ IV
(optimized for tomato expression)

(SEQ ID NO: 72)

AGA CCA CAA CTT
Forward primer for consensus seq. IV

(SEQ ID NO: 85)

AGACCACAACTU
Reverse primer for consensus seq. IV

(SEQ ID NO: 86)

AAGTTGTGGTCU
CONSENSUS AMINO ACID SEQ V

(SEQ ID NO: 59)

S W G P L
CONSENSUS DNA SEQ V
(optimized for tomato expression)

(SEQ ID NO: 93)

AGT TGG GGA CCA CTT
Forward primer for consensus seq. V

(SEQ ID NO: 94)

AGTTTGGGGACCACTU
Reverse primer for consensus seq. V

(SEQ ID NO: 95)

AAGTGGTCCCCAACU
CONSENSUS AMINO ACID SEQ VI

(SEQ ID NO: 60)

P L E T R S A
CONSENSUS DNA SEQ VI
(optimized for tomato expression)

(SEQ ID NO: 74)

CCA CTT GAG ACT AGA TCT GCT
Forward primer for consensus seq. VI

(SEQ ID NO: 96)

ACTTGAGACTAGATCTGCU
Reverse primer for consensus seq. VI

(SEQ ID NO: 97)

AGCAGATCTAGTCTCAAGU
CONSENSUS AMINO ACID SEQ VII

(SEQ ID NO: 61)

L P B T
CONSENSUS DNA SEQ VI
(optimized for tomato expression)

(SEQ ID NO: 98)

TA CTT CCA GAG ACT A
Forward primer for consensus seq. VII

(SEQ ID NO: 99)

ACTTCCAGAGACUA
Reverse primer for consensus seq. VII

(SEQ ID NO: 100)

AGTCTCTGGAAGUA

c. Generating a Plurality of Partially Overlapping Polynucleotides

Eight primer mixes are made (2.5 μM of each):

Group 1. upstream forward primer & reverse primer for consensus seq. I
Group 2. forward primer for consensus seq. I & reverse primer for consensus seq. II
Group 3. forward primer for consensus seq. II & reverse primer for consensus seq. III
Group 4. forward primer for consensus seq. III & reverse primer for consensus seq. IV
Group 5. forward primer for consensus seq. IV & reverse primer for consensus seq. V
Group 6. forward primer for consensus seq. V & reverse primer for consensus seq. VI
Group 7. forward primer for consensus seq. VI & reverse primer for consensus seq. VII
Group 8. forward primer for consensus seq. VII & downstream reverse primer.

1/10 volume of each primer mix is mixed with 7/10 volume of PCR grade water and 2/10 volume of Red Load Taq Master (CAT #VAR_{—}04 purchased from LAROVA GmbH). Each mixture is divided into seven reactions and one of each of the plasmid templates is added to each of those reactions. Thermocycling consists of 25 rounds of successive incubations at 95 c for 20 seconds, 55 c for 20 seconds, and 72 c for 1.5 min, then a final incubation at 72 c for 3 minutes. The annealing temperature may vary. In cases where non-optimal amounts of the products are obtained—gradient annealing is utilized to find the optimal annealing temperature, and the PCR is repeated using the corrected annealing temperature.

Following the PCR, 1 U of Pyrobest DNA polymerase (purchased from Takara) is added and each reaction is incubated at 70 c for 30 minutes in order to get rid any additional bases that may have been added to the 3′ ends of the segments by the Taq DNA polymerase. The DNA of each reaction is then run on 2% agarose gel and the bands are extracted and purified as mentioned above.

d. Inducing Recombination and Creating a Library

All the purified domains are mixed at equi-molar amounts in a single tube and USER™ enzyme and buffer (supplied by New England Biolabs) are added. The enzyme forms nicks at the 3′ side of the dU residues of what used to be primers, at the ends of the various DNA domains. Consequently unique 5′ protruding ends are formed. Since all the 3′ ends of the PCR products of group 1 are complementary to all the 5′ ends of group 2, and since all the 3′ ends of group 2 are complementary to all the 5′ ends of groups 3, and so on—combinatorial mixes of complete genes are formed. These are readily ligated by Ampligase (Purchased from EPICENTRE Biotechnologies) during 30 rounds of LCR, each round consisting of 2 min at 70 c, 1 min at 69 c, 1 min at 68 c, 1 min at 67 c, and so on until 1 min at 45 c where the temperature is raised to 70 c for 2 min again.

e. Transfecting Host Cells

The DNA is cleaved with XmaI and SstI and ligated to a pBI121 plasmid previously cleaved by the same enzymes. Amplification of the library is carried out as follows: E. coli transformation is carried out and approximately 1.5 million colonies are scraped from plates (the number of expected variants is 5⁸=approximately 400,000). Plasmid DNA is purified from the bacteria using protocols that are well known in the art (one possibility is using iYield Plasmid Mini Kit from RBC Bioscience following the manufacturer instructions).

f. Recovery of Recombinant Proteins

The DNA is transformed into Agrobacterium and then into the desired tomato strain according to procedures that are well known in the art. A detailed description of the pBI121 plasmid may be downloaded from the WEB at: http://plant-tc.cfans.umn.edu/listserv/2002/log0202/msg00093.html

The accession number of the pBI121 DNA sequence is: AF485783. Procedures used above are described in detail in: 1. Larkin M. A., Blackshields G., Brown N. P., Chema R., McGettigan P. A., McWilliam H., Valentin F., Wallace I. M., Wilm A., Lopez R., Thompson J. D., Gibson T. J. and Higgins D. G. ClustalW and ClustalX version 2.
Bioinformatics 2007 23(21): 2947-2948; Sambrook J., Fritsch E. F., Maniatis T. Molecular Cloning a Laboratory manual, Second Edition, Cold Spring Harbor Laboratory Press, 1989; and W. Belknap, D. Rockhold, K. McCue. pBINPLUS/ARS: an improved plant transformation vector based on pBINPLUS. BioTechniques, Vol. 44, No. 6. (May 2008), pp. 753-756.

### Example 3

Elastin is a protein found in the skin and tissue of the body. It helps to keep skin flexible but tight, providing a bounce-back reaction if skin is pulled. Enough elastin in the skin means that the skin will return to its normal shape after a pull. It also helps keep skin smooth as it stretches to accommodate normal activities like flexing a muscle or opening and closing the mouth to talk or eat.

Elastin tends to deplete as people age, resulting in wrinkled or stretched out skin. One might note the “pregnancy pouch” many women have many years after having a baby. In part, the leftover skin is a result of inadequate elastin, and also overstretching of the skin covering the abdomen during pregnancy.

Although many cosmetic companies list elastin from cows and birds as an ingredient in “anti-aging” skin care products, this ingredient does not penetrate the skin layer, which is needed in order to make the skin more elastic. In order to produce an effective elastin for the cosmetic industry, it is important to produce hypo-allergenic elastin molecules on one hand with increased skin penetration abilities on the other. The present invention provides the methods and compositions of elastin as described below:

a. Identifying Conserved Amino Acids in Proteins of Interest

Elastin was selected from human as well as other mammalian sources in order to construct a library of chimera of elastin proteins, including protein sequences of human—AAC98395.1, horse—XP_{—}001493829.2, cattle—NP_{—}786966.1 mouse—NP_{—}031951.2, and rat—NP 031951.2, as detailed below.

gi|182021|gb|AAC98395.1| elastin [Homo sapiens] (SEQ ID NO: 101)
gi|194218932|ref|XP_{—}001493829.2| PREDICTED: similar to elastin [Equus caballus] (SEQ ID NO: 102)
gi|28461173|ref|NP_{—}786966.1| elastin [Bos taurus] (SEQ ID NO: 103)
gi|31542606|ref|NP_{—}031951.2| elastin [Mus musculus] (SEQ ID NO: 104)
gi|55715827|gb|AAH85910. Elastin [Rattus norvegicus] (SEQ ID NO: 105)

b. Selecting Consensus Amino Acid Sequences

The five “parental” proteins (SEQ ID NOS 104, 105, 103, 101 and 102, respectively, in order of appearance) are aligned using the web's free multiple sequence alignment program ClustalW2 (in a similar way as illustrated in FIGS. 6-9)

| | |
|---|---|
| consensus seq. I | |
| PGGVPGA | (SEQ ID NO: 106) |
| consensus seq.II | |
| KPGKVPGVGLPGVYPGGVLP | (SEQ ID NO: 107) |
| consensus seq. III | |
| GKAGYPTGTGVG | (SEQ ID NO: 108) |
| consensus seq. IV | |
| AKAAAKAAK | (SEQ ID NO: 109) |
| consensus seq. V | |
| GAGVP | (SEQ ID NO: 110) |
| consensus seq. VI | |
| AAAKAAAKAAQ | (SEQ ID NO: 111) |

As in the case of the previous examples, the various polynucleotides are synthesized by synthetic gene construction. In designing the construction, optimal codons are utilized, depending on the desired (host) organism that is used and uniform DNA sequences are designed to all consensus sequences in all the polynucleotides.

Following the construction, each of the sequences is cloned into a suitable expression vector, depending on the desired expression (host) organism and sequencing is performed. For each sequence, a clone that does not contain mutations is isolated. DNA purification of plasmid DNA is carried out using any of a number of well known procedures2

PCR (50 ul reaction volume) with upstream forward primer (see below) and downstream reverse primer (see below) is carried out. Seven independent reactions are carried out utilising each of the isolated plasmids mentioned above as templates. Thermocycling consist of 25 rounds of successive incubations at 95 c for 20 seconds, 42 c for 20 seconds, and 72 c for 1.5 min, then a final incubation at 72 c for 3 minutes.

The DNA bands are extracted from 1% agarose gel and purified according to procedures that are well known in the art. One way of doing it is by using a kit from RBC Bioscience (CAT #YDF100). Many other such kits are also available.

As in the case of the previous examples, one who is familiar with the art, can easily design appropriate, complementary primers corresponding to the pre-designed consensus DNA sequences (see for example the primers of the previous examples).

c. Generating a Plurality of Partially Overlapping Polynucleotides

Seven primer mixes are made (2.5 μM of each):

Group 1. upstream forward primer & reverse primer for consensus seq. I
Group 2. forward primer for consensus seq. I & reverse primer for consensus seq. II
Group 3. forward primer for consensus seq. II & reverse primer for consensus seq. III
Group 4. forward primer for consensus seq. III & reverse primer for consensus seq. IV
Group 5. forward primer for consensus seq. IV & reverse primer for consensus seq. V
Group 6. forward primer for consensus seq. V & reverse primer for consensus seq. VI
Group 7. forward primer for consensus seq. VI & downstream reverse primer.

1/10 volume of each primer mix is mixed with 7/10 volume of PCR grade water and 2/10 volume of Red Load Taq Master (CAT #VAR_{—}04 purchased from LAROVA GmbH). Each mixture is divided into seven reactions and one of each of the plasmid templates is added to each of those reactions. Thermocycling consists of 25 rounds of successive incubations at 95 c for 20 seconds, 55 c for 20 seconds, and 72 c for 1.5 min, then a final incubation at 72 c for 3 minutes. The annealing temperature may vary. In cases where non-optimal amounts of the products are obtained—gradient annealing is utilized to find the optimal annealing temperature, and the PCR is repeated using the corrected annealing temperature.

Following the PCR, 1 U of Pyrobest DNA polymerase (purchased from Takara) is added and each reaction is incubated at 70 c for 30 minutes in order to get rid of any additional bases that may have been added to the 3′ ends of the segments by the Taq DNA polymerase. The DNA of each reaction is then run on 2% agarose gel and the bands are extracted and purified as mentioned above.

d. Inducing Recombination and Creating a Library

All the purified domains are mixed at equi-molar amounts in a single tube and USER™ enzyme and buffer (supplied by New England Biolabs) are added. The enzyme forms nicks at the 3′ side of the dU residues of what used to be primers, at the ends of the various DNA domains forming unique 3′ protruding ends. Since all the 3′ ends of the PCR products of group 1 are complementary to all the 5′ ends of group 2, and since all the 3′ ends of group 2 are complementary to all the 3′ protruding ends of groups 3, and so on—combinatorial mixes of complete genes are formed. These are readily ligated by Ampligase (Purchased from EPICENTRE Biotechnologies) during 30 rounds of LCR, each round consisting of 2 min at 70 c, 1 min at 69 c, 1 min at 68 c, 1 min at 67 c, and so on until 1 min at 45 c where the temperature is raised to 70 c for 2 min again.

e.-f. Transfecting Host Cells and Recovery of Recombinant Proteins The library of elastin protein is created by cutting the library of polynucleotides that had been created according to the procedures elaborated above by appropriate restriction enzymes and inserted into a suitable expression vector. Such vectors, which express foreign proteins I In a variety of expression systems

### Example 4

During sporulation, Bacillus thuringiensis produces crystalline protein inclusions with insecticidal activity against selected insects. The insecticidal crystal proteins Cyt2Aa, produced by B. thuringiensis subsp. israelensis is toxic to mosquito larvae¹. The protein is present in the crystals as 27 kDa protein but when solubilized can be processed by trypsin to form a protease-resistant core of 22 to 23 kDa with enhanced in vitro activity. Other Bacillus thuringiensis strains, as well as other related Bacillus species, produce similar insecticidal proteins that are toxic to other types of insects². We have designed a library of chimera proteins from which both species-specific as well as insecticides against a wide variety of insects—may be selected.

a. Identifying Conserved Amino Acids in Proteins of Interest

Cyt2Aa from B. thuringiensis subsp. israelensis as well as other Bacilli were chosen in order to construct a library of chimera insecticide proteins for that purpose. The amino acid sequences of these proteins (accession numbers: ACF35049.1, AAB93477.1, AAB63254.1, CAC80987.1, AAK50455.1) are detailed below.

| | |
|---|---|
| ACF35049.1 | (SEQ ID NO: 112) |
| AAB93477.1 | (SEQ ID NO: 113) |
| AAB63254.1 | (SEQ ID NO: 114) |
| CAC80987.1 | (SEQ ID NO: 115) |
| AAK50455.1 | (SEQ ID NO: 116) |

b. Selecting Consensus Amino Acid Sequences

The five “parental” proteins were aligned using the web's free multiple sequence alignment program ClustalW21.

Conserved sequences were identified—and consensus sequences that were designed are portrayed below:

| | | |
|---|---|---|
| Consensus seq.I | LTVPSSD | (SEQ ID NO: 117) |
| Consensus seq.II | FEKALQIAN | (SEQ ID NO: 118) |
| Consensus seq.III | NTFTNL | (SEQ ID NO: 119) |
| Consensus seq.IV | ILFSIQ | (SEQ ID NO: 120) |
| Consensus seq.V | KALTVVQ | (SEQ ID NO: 121) |

c.-f. Are Performed Just as in the Previous Examples as Described.

Chilcott C N, Ellar D J. Comparative toxicity of Bacillus thuringiensis var. israelensis crystal proteins in vivo and in vitro. J Gen Microbiol. 1988; 134:2551-2558. Chilcott C N, et al., Activities of Bacillus thuringiensis Insecticidal Crystal Proteins Cyt1Aa and Cyt2Aa against Three Species of Sheep Blowfly. Appl Environ Microbiol. 1998: 64(10): 4060-4061.

### Example 5

Celiac disease, is a disorder of the small intestine that occurs in genetically predisposed people of all ages from middle infancy on up. Symptoms include chronic diarrhoea, failure to thrive (in children), and fatigue. Celiac disease is caused by an “autoimmune” reaction to gliadin, a storage protein which together with glutenin form gluten in wheat (and similar proteins of the tribe Triticeae, which includes other cultivars such as barley and rye). Upon digestion, the gliadin proteins break down into smaller peptide chains, some of which initiate chain specific harmful immune response in celiac patients. One particular peptide has been shown to be harmful to celiac patients when instilled directly into the small intestine of several patients. This peptide includes 19 amino acids strung together in a specific sequence. Although the likelihood that this particular peptide is harmful is strong, other peptides may be harmful, as well, including some derived from the glutenin fraction. The only known effective treatment for celiac disease today is a lifelong gluten-free diet.

Peptide chains in rye, barley and oat are similar but slightly different than the ones found in wheat. Some of these chains are likely, but others—unlikely to initiate immune response in celiacs. We designed a chimera-gliadin library in order to screen protein that will not cause an immune response while retaining the role of gluten in giving bread its unique texture.

a. Identifying Conserved Amino Acids in Proteins of Interest

We have chosen gliadin and gliadin-like protein sequences from wheat (accession number A27319) as well as Tall wheatgrass and mosquito grass (ABV72239.1 and ABW36048.1 respectively). The amino acid sequences of these proteins are depicted below:

| | |
|---|---|
| A27319 | (SEQ ID NO: 122) |
| ABV72239.1 | (SEQ ID NO: 123) |
| ABW36048.1 | (SEQ ID NO: 124) |

b. Selecting Consensus Amino Acid Sequences

The three “parental” proteins (SEQ ID NOS 122, 124 and 123, respectively, in order of appearance) were aligned using the web's free multiple sequence alignment program ClustalW2. The results of the alignment are depicted below.

| | | |
|---|---|---|
| con. seq.I | QPYPQ | (SEQ ID NO: 125) |
| con. seq.II | QQLCCQQ | (SEQ ID NO: 126) |
| con. seq.III | IILHQQQQ | (SEQ ID NO: 127) |
| con. seq.IV | QPQQQ | (SEQ ID NO: 128) |
| con. seq.V | ALQTLP | (SEQ ID NO: 129) |

c.-f. Are Performed Just as in the Previous Examples.

### Example 6

Topically applied Growth Hormone on wound facilitates wound healing¹. It stimulates granulation tissue formation, increases collagen deposition, and facilitates epithelialization. It can also accelerate donor site healing in patients with burns and bone healing. We have designed a chimera growth hormone library in order to screen for variants with increased healing effect.

a. Identifying Conserved Amino Acids in Proteins of Interest

Growth hormone and growth hormone-like protein sequences were chosen from human, white-faced saki, rat and two types of fish: Alligator gar and Siberian surgeon (accession numbers J03071.1, AY744462.1, CH473948.1, AY738587.1 and FJ428829.1 respectively). The amino acid sequences of these proteins are depicted below:

| | |
|---|---|
| J03071.1 | (SEQ ID NO: 130) |
| AY744462.1 | (SEQ ID NO: 131) |
| CH473948.1 | (SEQ ID NO: 132) |
| AY738587.1 | (SEQ ID NO: 133) |
| FJ428829.1 | (SEQ ID NO: 134) |

b. Selecting Consensus Amino Acid Sequences

The five “parental” proteins were aligned using the web's free multiple sequence alignment program ClustalW2 (in a similar way to the one illustrated in FIGS. 6-9. The results of the alignment are depicted below. Conserved sequences were identified—and consensus sequences that were designed to serve as recombination sites are portrayed below the alignments. Note That two alternative consensus sequences I were designed in order to increase the complexity of the library, one corresponding to the first three sequences and one for the last two. Note also that consensus sequence II is composed of two sequences differing in one amino-acid, one corresponding to the first three sequences and one corresponding to the last two.

| | |
|---|---|
| Consensus seq. I | |
| LLCLLW | (SEQ ID NO: 135) |
| Alternative Consensus seq. I | |
| FERTYVP | (SEQ ID NO: 136) |
| Consensus seq. II | |
| SLLLIQ | (SEQ ID NO: 137) |
| SLALIQ | (SEQ ID NO: 138) |
| Consensus seq. III | |
| LKDLEE | (SEQ ID NO: 139) |
| Consensus seq. IV | |
| TYSKFD | (SEQ ID NO: 140) |
| Consensus seq. V | |
| KNYGLL | (SEQ ID NO: 141) |

c.-f. Are Performed Just as in the Previous Examples.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

What is claimed is:

1. A method for generating divergent libraries of recombinant chimeric proteins, said method consisting of:
a. identifying a plurality of conserved amino acid sequences in a plurality of related proteins;
b. selecting a plurality of consensus amino acid sequences of 3 to 30 amino acids in length as a backbone corresponding to said conserved amino acid sequences to serve as sites of recombination and as a backbone for recombinant chimeric proteins created and selecting a plurality of variable regions corresponding to non-conserved amino acid sequences in said plurality of related proteins;
c. generating a plurality of partially overlapping nonrandomly fragmented polynucleotides comprising a nucleic acid sequence encoding the consensus amino acid sequences of (b), wherein each polynucleotide comprises: (i) at least one terminal oligonucleotide sequence complementary to a terminal oligonucleotide sequence of at least one other polynucleotide, and wherein at least one terminal sequence at the terminus of each polynucleotide encodes an intact consensus amino acid sequence of (b); and (ii) a polynucleotide sequence encoding a variable, non-conserved amino acid sequence selected from any of the plurality of said related proteins of (b);
d. inducing nonrandom recombination between the plurality of said partially overlapping polynucleotides of (c) to produce divergent libraries of chimeric polynucleotides wherein the recombinations intentionally take place between the sequences that correspond to the full length consensus amino acids and wherein no crossover oligonucleotides are utilized;
e. transfecting a plurality of host cells with the chimeric polynucleotides of (d) to produce divergent libraries of cloned cell lines expressing one of the recombinant chimeric proteins; and
f. recovering recombinant chimeric proteins from the cloned cell lines of (e).

2. The method of claim 1, wherein the consensus amino acid sequence is a segment of 4 to 20 amino acids, that is conserved in the plurality of related proteins.

3. The method of claim 1, wherein the consensus amino acid sequence is a segment of 5 to 10 amino acids, that is conserved in the plurality of related proteins.

4. The method of claim 1, optionally comprising substituting amino acid residues having similar side chains including aliphatic, aliphatic-hydroxyl, amide, aromatic, basic or sulfur-containing side chains.

5. The method of claim 1, wherein the plurality of overlapping polynucleotides comprise variable sequences having less than 30% sequence homology.

6. The method of claim 1, wherein the plurality of overlapping polynucleotides comprise variable sequences having less than 10% sequence homology.

7. The method of claim 1, wherein the plurality of overlapping polynucleotides comprise variable sequences substantially devoid of sequence homology.

8. The method of claim 1, wherein recombination occurs in vitro.

9. The method of claim 1, wherein the plurality of overlapping polynucleotides is amplified prior to recombination.

10. The method of claim 1, wherein the plurality of overlapping polynucleotides comprise variable sequences derived from DNA sources selected from the group consisting of plasmids, cloned DNA, cloned RNA, genomic DNA, natural RNA, bacteria, yeast, viruses, plants, and animals.

11. The method of claim 1, wherein recombination between the plurality of overlapping polynucleotides takes place in the presence of a plurality of vector fragments, wherein the sequence at each end of a vector fragment is complementary to at least one terminal oligonucleotide sequence of at least one of said overlapping polynucleotides.

12. The method of claim 1, further comprising developing a library of chemokine receptors with altered N-termini, transmembrane domains or altered C-termini.

13. The method of claim 1, further comprising developing a library of chimera of hexose transporters that control the transport of hexose sugars in tomatoes including hexose carrier proteins from a variety of different plant origins.

14. The method of claim 1, further comprising developing a library chimera elastin proteins having properties of flexibility, elasticity, penetration and anti-aging effects.

15. The method of claim 1, further comprising developing a library of proteins having insecticidal properties including Cyt2Aa from B. thuringiensis subsp. israelensis as well as other Bacilli.

16. The method of claim 1, further comprising developing a library of a chimera of gliadin, a storage protein which together with glutinin from gluten from wheat, is implicated in celiac disease.

17. The method of claim 1, further comprising developing a library of chimera of growth hormone in order to screen for variants with increased healing effect in wounds.

18. The method of claim 1, wherein the ratio between distinct polynucleotides at the recombination step is selected from the group consisting of an equimolar ratio, a non-equimolar ratio, and a random ratio.

19. The method of claim 1, wherein the plurality of related proteins include functionally-related proteins, structurally related proteins, and fragments thereof; naturally occurring proteinaceous complexes, polypeptides and peptides from the same organism or different organisms; or artificial proteinaceous complexes, polypeptides and peptides.

20. A method for generating divergent libraries of recombinant chimeric proteins, said method consisting of:
a. identifying a plurality of conserved amino acid sequences in a plurality of related proteins, wherein the DNA encoding the non-conserved variable regions in said related proteins shares less than 70% homology;
b. selecting a plurality of consensus amino acid sequences of 3 to 30 amino acids in length as a backbone, corresponding to said conserved amino acid sequences to serve as sites of recombination and as a backbone the recombinant chimeric proteins created, and selecting a plurality of variable regions having less than 70% homology between them, corresponding to non-conserved amino acid sequences in said plurality of related proteins;
c. generating a plurality of partially overlapping nonrandomly fragmented polynucleotides comprising a nucleic acid sequence encoding the consensus amino acid sequences of (b), wherein each polynucleotide comprises: (i) at least one terminal oligonucleotide sequence complementary to a terminal oligonucleotide sequence of at least one other polynucleotide, and wherein at least one terminal sequence at the terminus of each polynucleotide encodes an intact consensus amino acid sequence of (b); and (ii) a polynucleotide sequence encoding a variable, non-conserved amino acid sequence selected from any of the plurality of said related proteins of (b);
d. inducing nonrandom recombination between the plurality of said partially overlapping polynucleotides of (c) to produce divergent libraries of chimeric polynucleotides wherein the recombinations intentionally take place between the sequences that correspond to the full length consensus amino acids and wherein no crossover oligonucleotides are utilized;
e. transfecting a plurality of host cells with the chimeric polynucleotides of (d) to produce divergent libraries of cloned cell lines expressing one of the recombinant chimeric proteins; and optionally
f. recovering recombinant chimeric proteins from the cloned cell lines of (e).

21. The method of claim 20, wherein the consensus amino acid sequence is a segment of 4 to 20 amino acids, that is conserved in the plurality of related proteins.

22. The method of claim 20, optionally comprising substituting amino acid residues having similar side chains including aliphatic, aliphatic-hydroxyl, amide, aromatic, basic or sulfur-containing side chains.

23. The method of claim 20, wherein the plurality of overlapping polynucleotides comprise variable sequences having less than 30% sequence homology.

24. The method of claim 20, wherein the plurality of overlapping polynucleotides comprise variable sequences having less than 10% sequence homology.

25. The method of claim 20, wherein the plurality of overlapping polynucleotides comprise variable sequences substantially devoid of sequence homology.

26. The method of claim 20, wherein recombination occurs in vitro.

27. The method of claim 20, wherein the plurality of overlapping polynucleotides is amplified prior to recombination.

28. The method of claim 20, wherein the plurality of overlapping polynucleotides comprise variable sequences derived from DNA sources selected from the group consisting of plasmids, cloned DNA, cloned RNA, genomic DNA, natural RNA, bacteria, yeast, viruses, plants, and animals.

29. The method of claim 20, wherein recombination between the plurality of overlapping polynucleotides takes place in the presence of a plurality of vector fragments, wherein the sequence at each end of a vector fragment is complementary to at least one terminal oligonucleotide sequence of at least one of said overlapping polynucleotides.

30. The method of claim 20, further comprising developing a library of chemokine receptors with altered N-termini, transmembrane domains or altered C-termini.

31. The method of claim 20, further comprising developing a library of chimera of hexose transporters that control the transport of hexose sugars in tomatoes including hexose carrier proteins from a variety of different plant origins.

32. The method of claim 20, further comprising developing a library chimera elastin proteins having properties of flexibility, elasticity, penetration and anti-aging effects.

33. The method of claim 20, further comprising developing a library of proteins having insecticidal properties including Cyt2Aa from B. thuringiensis subsp. israelensis as well as other Bacilli.

34. The method of claim 20, further comprising developing a library of a chimera of gliadin, a storage protein which together with glutinin from gluten from wheat, is implicated in celiac disease.

35. The method of claim 20, further comprising developing a library of chimera of growth hormone in order to screen for variants with increased healing effect in wounds.

36. The method of claim 20, wherein the ratio between distinct polynucleotides at the recombination step is selected from the group consisting of an equimolar ratio, a non-equimolar ratio, and a random ratio.

37. The method of claim 20, wherein the plurality of related proteins include functionally-related proteins, structurally related proteins, and fragments thereof; naturally occurring proteinaceous complexes, polypeptides and peptides from the same organism or different organisms; or artificial proteinaceous complexes, polypeptides and peptides.

38. A method for generating divergent libraries of recombinant chimeric proteins said method consisting of:
a. identifying a plurality of conserved amino acid sequences in a plurality of related proteins, wherein the DNA encoding the non-conserved variable regions in said related proteins shares less than 50% homology;
b. selecting a plurality of consensus amino acid sequences of 3 to 30 amino acids in length as a backbone corresponding to said conserved amino acid sequences to serve as sites of recombinations and as a backbone for the recombinant chimeric proteins created, and selecting a plurality of variable regions having less than 50% homology between them, corresponding to non-conserved amino acid sequences in said plurality of related proteins;
c. generating a plurality of partially overlapping nonrandomly fragmented polynucleotides comprising a nucleic acid sequence encoding the consensus amino acid sequences of (b), wherein each polynucleotide comprises: (i) at least one terminal oligonucleotide sequence complementary to a terminal oligonucleotide sequence of at least one other polynucleotide, and wherein at least one terminal sequence at the terminus of each polynucleotide encodes an intact consensus amino acid sequence of (b); and (ii) a polynucleotide sequence encoding a variable, non-conserved amino acid sequence selected from any of the plurality of said related proteins of (b);
d. inducing nonrandom recombination between the plurality of said partially overlapping polynucleotides of (c) to produce divergent libraries of chimeric polynucleotides wherein the recombinations intentionally take place between the sequences that correspond to the full length consensus amino acids and wherein no crossover oligonucleotides are utilized;
e. transfecting a plurality of host cells with the chimeric polynucleotides of (d) to produce divergent libraries of cloned cell lines expressing one of the recombinant chimeric proteins; and optionally
f. recovering recombinant chimeric proteins from the cloned cell lines of (e).

39. The method of claim 38, wherein the consensus amino acid sequence is a segment of 4 to 20 amino acids, that is conserved in the plurality of related proteins.

40. The method of claim 38, wherein the consensus amino acid sequence is a segment of 5 to 10 amino acids, that is conserved in the plurality of related proteins.

41. The method of claim 38, optionally comprising substituting amino acid residues having similar side chains including aliphatic, aliphatic-hydroxyl, amide, aromatic, basic or sulfur-containing side chains

42. The method of claim 38, wherein the plurality of overlapping polynucleotides comprise variable sequences having less than 30% sequence homology.

43. The method of claim 38, wherein the plurality of overlapping polynucleotides comprise variable sequences having less than 10% sequence homology.

44. The method of claim 38, wherein the plurality of overlapping polynucleotides comprise variable sequences substantially devoid of sequence homology.

45. The method of claim 38, wherein recombination occurs in vitro.

46. The method of claim 38, wherein the plurality of overlapping polynucleotides is amplified prior to recombination.

47. The method of claim 38, wherein the plurality of overlapping polynucleotides comprise variable sequences derived from DNA sources selected from the group consisting of plasmids, cloned DNA, cloned RNA, genomic DNA, natural RNA, bacteria, yeast, viruses, plants, and animals.

48. The method of claim 38, wherein recombination between the plurality of overlapping polynucleotides takes place in the presence of a plurality of vector fragments, wherein the sequence at each end of a vector fragment is complementary to at least one terminal oligonucleotide sequence of at least one of said overlapping polynucleotides.

49. The method of claim 38, further comprising developing a library of chemokine receptors with altered N-termini, transmembrane domains or altered C-termini.

50. The method of claim 38, further comprising developing a library of chimera of hexose transporters that control the transport of hexose sugars in tomatoes including hexose carrier proteins from a variety of different plant origins.

51. The method of claim 38, further comprising developing a library chimera elastin proteins having properties of flexibility, elasticity, penetration and anti-aging effects.

52. The method of claim 38, further comprising developing a library of proteins having insecticidal properties including Cyt2Aa from B. thuringiensis subsp. israelensis as well as other Bacilli.

53. The method of claim 38, further comprising developing a library of a chimera of gliadin, a storage protein which together with glutinin from gluten from wheat, is implicated in celiac disease.

54. The method of claim 38, further comprising developing a library of chimera of growth hormone in order to screen for variants with increased healing effect in wounds.

55. The method of claim 38, wherein the ratio between distinct polynucleotides at the recombination step is selected from the group consisting of an equimolar ratio, a non-equimolar ratio, and a random ratio.

56. The method of claim 38, wherein the plurality of related proteins include functionally-related proteins, structurally related proteins, and fragments thereof; naturally occurring proteinaceous complexes, polypeptides and peptides from the same organism or different organisms; or artificial proteinaceous complexes, polypeptides and peptides.
